(19) United States
(12) Patent Application Publication
(10) Pub. No.: US 2010/0212087 A1
(43) Pub. Date: Aug. 26, 2010

(54) INTEGRATED PATIENT ROOM

(76) Inventors: Roger Leib, Los Angeles, CA (US); Bran Ferren, Beverly Hills, CA (US); Mark Setrakian, Los Angeles, CA (US); Christian Carlberg, San Luis Obispo, CA (US); Lars Jangaard, West Hills, CA (US); Dan Danknick, Santa Ana, CA (US); Russell Howe, Montrose, CA (US); Daniel W. Hillis, Encino, CA (US); Shawn Jasmann, Los Angeles, CA (US); Robert Insalaco, Holland, MI (US); John Mathaii, Holland, MI (US)

Correspondence Address: BRINKS HOFER GILSON & LIONE, P.O. BOX 10395, CHICAGO, IL, 60610, US

(21) Appl. No.: 12/452,911

(22) PCT Filed: Jul. 31, 2008
(86) PCT No.: PCT/US08/71724

§ 371 Date: Mar. 11, 2010

Related U.S. Application Data
(60) Provisional application No. 60/962,695, filed on Jul. 31, 2007.

(51) Int. Cl. A61G 7/14; A47C 1/02; A47C 7/38; A47C 7/40; A47C 7/54; G06F 3/048

(52) U.S. Cl. 5/81.1 R; 297/354.1; 715/771

(57) ABSTRACT

The present embodiments provide an integrated patient room having multiple features designed to enhance the safety, satisfaction and/or outcomes for a patient and/or caregiver. In one embodiment, the integrated patient room comprises at least one bed and at least one chair. The bed and the chair can each assume a wide range of positions, and can be pre-programmed into preferred positions. Further, the bed, chair, and/or other components in the patient room may be automatically synchronized with one another to facilitate transfer of a patient. A touch screen monitor with an intuitive graphical user interface may be employed as a communication portal. The functions of the bed, chair and/or other components in the room may be accessed and/or controlled through the communication portal.

This application claims the benefit of U.S. Provisional Application No. 60/962,695, filed Jul. 31, 2007 and entitled “Integrated Patient Room,” the entire disclosure of which is hereby incorporated herein by reference.

### TECHNICAL FIELD

The present embodiments relate to an integrated patient room having multiple components and features designed to enhance the safety, satisfaction and/or outcomes for a patient and/or caregiver.

### BACKGROUND INFORMATION

In a patient facility, such as an acute care hospital, it is desirable to provide a functional, safe and comfortable setting for a patient and a caregiver. Typically, a hospital patient room includes a hospital bed for a patient and one or more chairs in which a visitor or caregiver may sit. Certain beds may be adjustable, but often the chair has little or no adjustment capability.

A fully functional hospital bed should be capable of a wide range of movement so that it may be raised or lowered to a desired position, such as a supine position. It also may be desirable to move the bed into other positions, for example, upright seated, reclined seated, supine for examination, Trendelenburg, reverse Trendelenburg, and so forth.

Most adjustable beds are not capable of achieving such a range of positions to facilitate patient comfort and/or examination. Moreover, even if the bed may be adjusted into one or more of these positions, the beds typically cannot be further adjusted within these positions, for example, to accommodate patients of specific heights, weights, or other individual characteristics. Furthermore, many beds rely on mechanical mechanisms that require a caregiver to manually engage and move various parts of the bed. In short, such beds generally are not readily automatically movable into the variety of positions described above, and may not be able to accommodate different users at or within any one position.

In addition, the bed is often the main focal point of the patient room, and can not be easily removed or stored. As such, the patient is often unnecessarily confined to the bed because of spatial constraints and the need for proximity to communications, utilities, medical devices, and so forth, which are typically coupled to, oriented towards, or associated with, the bed. This bed confinement, however, can adversely affect the psyche or mental state of the patient, since the concept of being “bed ridden,” especially in a hospital, is typically associated with being sick. Moreover, confinement to the bed can also lead to additional physical problems, such as bed sores, atrophy “deconditioning” and bone loss, compromised breathing, constipation, insulin resistance, etc. The inability to get the patient out of the bed within the confines of the patient room can, in this way, potentially adversely affect the recovery of the patient.

Exacerbating the bed-centric problem, chairs in a patient room typically have little or no functionality and may be manufactured from a static wood, metal or plastic frame. As such, patient room chairs typically are not well suited for accommodating the patient when they are able to leave the bed, and are not suited for facilitating transfer of the patient to and from the bed. As such, the limited functionality of the chair can further confine the patient to the bed. Moreover, patient room chairs are not equipped with communication devices, medical devices, and so forth, and are not capable of assuming a wide range of positions, including one or more of the examination positions listed above. Accordingly, such chairs exacerbate, rather than alleviate, the various problems associated with a bed-centric patient room.

Further, many difficulties may arise when transferring a patient into or out of a patient room, or moving the patient within the room. For example, there often is a need to transfer a patient from the bed to a wheelchair or gurney. Often, however, the limited adjustment capabilities of the bed are not suited for the transfer of patients and/or for access to caregivers of different heights, weights and physical capabilities.

Still further, various components of a patient room typically are actuated from different locations. For example, adjustments to the bed may be performed at the base of the bed, whereas changing the lighting in the room may be actuated by pressing a switch near the entrance of the room, and so forth. As such, these functions are typically not readily accessible to the patient situated in a bed or chair, and are not centrally located for ease of operation by a caregiver.

### SUMMARY

The present embodiments provide an integrated patient room having multiple features designed to enhance the safety, satisfaction and/or outcomes for a patient and/or caregiver. The integrated patient room preferably includes at least one bed and chair, and may further include a communication portal and other devices.

In one embodiment, the bed includes at least one articulating support surface, defined in one embodiment by a plurality of segments defining corresponding planes, adapted to receive a user, such as a patient. The support surface is articulatable and adjustable between a plurality of configurations. A docking station, which may rest on the floor and/or be secured to a wall of the patient room, is configured to releasably and moveably support at to least one end of the bed. The bed is configured to be used in conjunction with the docking station. For example, the docking station is configured to move the bed between at least substantially horizontal and vertical positions. In one embodiment, the bed is stowable substantially proximate to or within the docking station in the vertical position, thereby freeing up space within the patient room when the bed is not being used.

In one embodiment, the docking station includes first and second vertical elements that are spaced apart from one another in a side-to-side, or lateral, direction. A cross-bar is disposed between the first and second vertical elements, and is configured, in one embodiment, to releasably engage a complementary cross-bar coupled to an end portion of the bed.

In use, the cross-bar is raised or lowered on the docking station, with the end portion of the bed being raised or lowered therewith. Various pieces of equipment, medical supplies, and the like may be removably or permanently coupled to the docking station, for example, to one or both of the vertical elements.

In another embodiment, the chair of the patient room includes an articulating support surface adapted to receive a user, wherein the support surface, defined in one embodiment by a plurality of segments defining corresponding planes, is adjustable between a plurality of configurations. The chair may further comprise a cervical support and headrest disposed proximate an upper surface of the chair. The cervical support and headrest may be adapted for adjustability with respect to the upper surface of the chair when the chair is in any of the plurality of configurations.

In accordance with one aspect, the bed and/or the chair are capable of being preprogrammed into multiple positions, including for example and without limitation supine, sitting and egress positions, and further may be adjusted in each of the supine, sitting and egress positions based on information associated with an individual using the chair. For example, the bed and/or the chair may obtain the information associated with a particular individual using a radio frequency identification tag, bar codes, manual input, and so forth. One or more graphical user interfaces may be coupled to the bed and/or the chair to enable preprogrammed positioning of the bed and/or the chair in the various positions and based on individual specific requirements pertaining to both a patient and a caregiver. In addition, the patient or caregiver can manually adjust the bed and/or chair to fine tune the position of each, or to arrive at an independently comfortable position.

In accordance with another aspect, a system for transferring a patient is provided. The system comprises a bed adjustable between a plurality of configurations and a second support structure, such as the chair, that is adjustable between a plurality of configurations. Both the bed and the second support structure are configured to be pre-programmed into at least one of the plurality of configurations. A programmable operating system is configured to automatically synchronize a first configuration of the bed with a first configuration of the second support structure to facilitate lateral and/or upright transfers of a patient between the bed and the chair, and/or between other components of furniture in the patient room.

Further, a patient and/or caregiver may actuate various room functions from one or more communication portals within the patient room. For example, a touch screen monitor with an intuitive graphical user interface may be employed as a communication portal. Portals may be coupled to the bed, chair, a handheld portable device or portals mounted on one or more walls. The various room devices, such as the bed and chair, as well as room controls such as lighting, and communications mediums such as e-mail, may be accessed and/or controlled through the one or more communication portals.

Other systems, methods, features and advantages of the invention will be, or will become, apparent to one with skill in the art upon examination of the following figures and detailed description. It is intended that all such additional systems, methods, features and advantages be within the scope of the invention, and be encompassed by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 is a perspective view of one embodiment of a patient room.

FIG. 2 is a front view of a docking station with a bed engaged therewith.

FIG. 3A is a perspective view of a bed positioned in a partially raised position and engaged with a docking station.

FIG. 3B is a perspective view of a bed positioned in a sitting position and engaged with a docking station.

FIG. 4 is a perspective view of a bed positioned in a vertical position and engaged with a docking station.

FIG. 5A is a perspective view of the docking station cross-bar.

FIG. 5B is a perspective view of a cross-bar coupled to a bed.

FIG. 6A is a partial side view of a bed disengaged from the docking station.

FIG. 6B is a perspective view of a bed disengaged from the docking station.

FIG. 7 is a partial perspective view of bed with a support assembly positioned at the head of the bed.

FIG. 8A is a partial perspective view of a support assembly at the foot of the bed in an upright position.

FIG. 8B is a partial perspective view of the support assembly at the foot of the bed in a folded position.

FIG. 9 is a front view of an equipment support secured to the docking station.

FIG. 10A is a partial perspective view of a monitor and articulated support arm.

FIG. 10B is an enlarged partial perspective view of a joint of the articulated support arm shown in FIG. 10A.

FIG. 10C is a view of a patient accessing a monitor while seated in a chair.

FIG. 10D is an enlarged view of a grippable member secured to the monitor support.

FIG. 11 is a perspective view of the bed in a sitting position and engaged with the docking station.

FIG. 12 is a partial perspective view showing a head end of the bed coupled to the docking station cross-bar.

FIG. 13 is another partial perspective view showing the head end of the bed coupled to the docking station cross-bar.

FIG. 14 is a side view of the connection between first and second bed support segments.

FIG. 15 is a perspective view of the connection shown in FIG. 14.

FIG. 16 is a side view of the connection between the first and second bed support members.

FIG. 17 is an enlarged view of a knee gatch mechanism.

FIG. 18 is a side view of the knee gatch mechanism of FIG. 17 in an upraised position.

FIG. 19 is a side perspective view showing features of a support members of the bed.

FIG. 20 is an enlarged view of the attachment between a bed sheet and a support member.

FIG. 21 is a side perspective view of the bed in a horizontal position.

FIG. 22 is a side view of a side rail support.

FIG. 23 is a perspective view of another embodiment of the bed.

FIG. 24 is a perspective view of a frame structure and various actuators for the bed shown in FIG. 23.

FIG. 25 is a perspective view of the frame structure at a first end of the bed.

FIG. 26 is a bottom view of the frame structure at a second end of the bed with a support assembly secured thereto.

FIG. 27 is a top view of the frame structure at a second end of the bed with a support assembly secured thereto.

FIG. 28 is an interior bottom perspective view of the connection between the first and second end portions of the bed.

FIG. 29 is an exterior top perspective view of the connection between the first and second end portions of the bed.

FIGS. 30A-30F are schematics showing the bed in various positions.

FIG. 31 is a side view of an alternative embodiment of a bed in a first position.

FIG. 32 is side view of the bed shown in FIG. 31 in a “Tall Seated” position.

FIG. 33 is side view of the bed shown in FIG. 31 in a “Tall Standing” position.

FIGS. 34A-34B are, respectively, a top view and a side view of a bed frame of the bed shown in FIG. 31.

FIGS. 35A-35B are, respectively, top and side views of the bed frame of the bed shown in FIG. 31 with a foot support in first and second positions.

FIGS. 36A-36B are, respectively, top and side views of the bed frame of the bed shown in FIG. 31 with a buttock support in an elevated position.

FIGS. 37A-37C are, respectively, top, side and end views of the buttock support of FIGS. 36A-B.

FIG. 38 is a perspective view of a chair in a sitting position.

FIG. 39 is a perspective view of the chair shown in FIG. 38 in a supine position.

FIG. 40 is a schematic view of a body support structure for a chair.

FIG. 41 is a schematic view of a body support structure for a chair.

FIG. 42 is an enlarged view of an upper portion of a chair with a cervical support and headrest applied thereto.

FIG. 43 is a rear perspective view of one embodiment of a chair in a sitting position.

FIG. 44 is a side perspective view of the chair shown in FIG. 43 in a supine position.

FIG. 45 is a partial exploded view of a back assembly.

FIG. 46 is a rear perspective view of one embodiment of the chair shown in FIG. 43 in an upright position.

FIG. 47 is an enlarged view of an upper portion of a backrest of the chair of FIG. 43.

FIG. 48 is an enlarged rear view of a portion of the chair.

FIG. 49 is a view of a leg rest of a chair.

FIG. 50 is a perspective view of an alternative chair in an upright position.

FIG. 51 is a side view of the chair shown in FIG. 50.

FIG. 52 is a side view of the chair of FIG. 50 in a sitting position.

FIG. 53 is a side view of the chair of FIG. 50 in a supine position.

FIG. 54 is a perspective view of the chair of FIG. 50 in a supine position.

FIG. 55 is a perspective view of the chair of FIG. 50 in an upright position.

FIGS. 56A-56F are schematics showing the chair of FIGS. 50-55 in various positions.

FIG. 57 is an enlarged side view of an armrest.

FIG. 58A is a front view of a leg support.

FIG. 58B is a footrest receptacle.

FIG. 59 is a perspective view of a utility center.

FIG. 60 is a view of a communication portal comprising a monitor and a graphical user interface.

FIGS. 61A-61B are schematics of a computer system for use with the patient room.

FIGS. 62-64 are views of a graphical user interface.

FIG. 65 is a view of an exemplary homepage displayed on a graphical user interface.

FIGS. 66-71 are views of exemplary patient information pages displayed on a graphical user interface.

FIGS. 72-80 are views of exemplary entertainment pages displayed on a graphical user interface.

FIGS. 81-84 are views of exemplary communication pages displayed on a graphical user interface.

FIGS. 85-87 are views of a graphical user interface.

FIGS. 88-95 are views of exemplary meal selection pages displayed on a graphical user interface.

FIGS. 96-100 are views of exemplary room control pages displayed on a graphical user interface.

FIGS. 101-104 are views of exemplary bed control pages displayed on a graphical user interface.

FIGS. 105-107 are views of exemplary chair control pages displayed on a graphical user interface.

FIG. 108 is a perspective view of a chair base.

FIG. 109 is cross-sectional perspective view of a chair in a supine position.

FIG. 110 is a cross-sectional side view of the chair shown in FIG. 109.

FIG. 111 is a cross-sectional side view of the chair in an upright seated position.

FIG. 112 is a schematic showing body support segments of the chair moving between a supine position and a standing, egress position.

FIG. 113 is a side view of a bed frame.

FIG. 114 is an end view of the bed frame shown in FIG. 113.

FIG. 115 is a side view of bed frame shown in FIG. 113 with the knee gatch in a raised position.

FIG. 116 is a top view of the bed frame shown in FIG. 113.

FIG. 117 is an end view of the bed frame shown in FIG. 113.

FIG. 118 is a side view of another embodiment of the chair in an erect, egress position, with the armrests in an upright support position.

FIG. 119 is a side view of the chair in an erect, egress position, with the armrests in an stowed position.

FIG. 120 is a side view of the chair in an upright seated position with the armrests in an upright support position.

FIG. 121 is a side view of the chair in an upright seated position with the armrests in a stowed position.

FIG. 122 is a side view of the chair in a supine position.

FIG. 123 is a side view of the chair in an upright seated position.

FIG. 124 is an exploded perspective view of the back frame.

FIG. 125 is an exploded perspective view of the chair.

FIG. 126 is a side view of chair in a supine position.

FIG. 127 is a side view of the chair in an erect, egress position.

FIG. 128 is a rear perspective view of the chair in an erect, egress position.

FIG. 129 is a side view of the chair in a raised, upright seated position.

### DETAILED DESCRIPTION OF THE PREFERRED EMBODIMENTS

The present embodiments relate generally to an integrated patient room having multiple features designed to enhance the safety, satisfaction, and/or outcomes for a patient and/or caregiver. Different sections below are used to describe various features and components of the integrated patient room.

### Integrated Patient Room in General

The integrated patient room may be configured for acute care and recovery of individual patients, and may also comprise various features useful for other occupants, such as a caregiver or family member. Further, the integrated patient room may facilitate tasking and other operations needed for and by nurses, doctors and other employees of the hospital.

In general, the integrated patient room comprises one or more programmable devices, such as a bed assembly or chair that employs actuation mechanisms to facilitate patient movement, mobilization, positioning and transfer. The devices may assume a wide range of positions and may be pre-programmed into preferred positions. In this way, the terms “bed” and “chair” generally refer to body support devices that support a patient in a variety of positions, with the bed being differentiated by way of having a wider platform than the chair more suitable for sleeping. It is contemplated, however, that the room could be configured with only a single device, such as the “chair,” which is configurable in a variety of positions and embodiments, including a position and embodiment suitable for sleeping. In such an embodiment, the patient can sleep, be examined, easily exit, sit upright and move about in a single device.

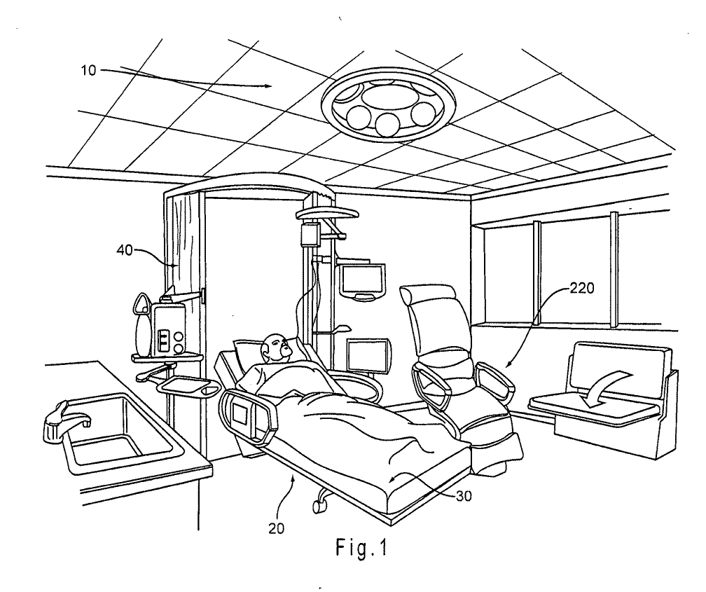

Referring now to FIG. 1, integrated patient room 10 generally comprises at least one bed assembly 20 and at least one chair 220. As will be explained in further detail below, bed 30 of bed assembly 20 is adjustable between a plurality of configurations and may be configured to be pre-programmed into at least one, and preferably all, of the plurality of configurations. Similarly, chair 220 is adjustable between a plurality of configurations and may be configured to be pre-programmed into at least one, and preferably all, of the plurality of configurations. Further configurations can be programmed depending on the patient and/or caregiver, for example, to suit the particular physical characteristics or limitations of the patient and/or caregiver. A programmable operating system is configured to automatically synchronize one or more configurations of bed 30 with one or more configurations of the chair 220 to facilitate transfer of a patient between bed 30 and chair 220. The system can also make the integrated patient room more usable, for example, by automatically moving the bed out of the way when not in use, for example when the patient is in the chair and/or when the system recognizes no one is in the bed. For example, various sensors (occupancy/weight, infrared, etc.) can be incorporated into the bed and/or chair to recognize whether the chair and/or bed is occupied.

Further, integrated patient room 10 employs a user-friendly approach, whereby a patient or caregiver may control most room and device functions from a single location. For example, a touch screen monitor 70 (as shown in FIG. 4) with an intuitive graphical user interface may be employed as a communication portal. Similar portals can be associated with or coupled to the chair, configured as a handheld portable device and/or mounted in or on one or more walls. The various devices, such as bed assembly 20 and chair 220, as well as room controls such as lighting, entertainment and communications media such as e-mail and internet access, preferably are accessed and/or controlled through the one or more communication portals.

### Bed Assembly

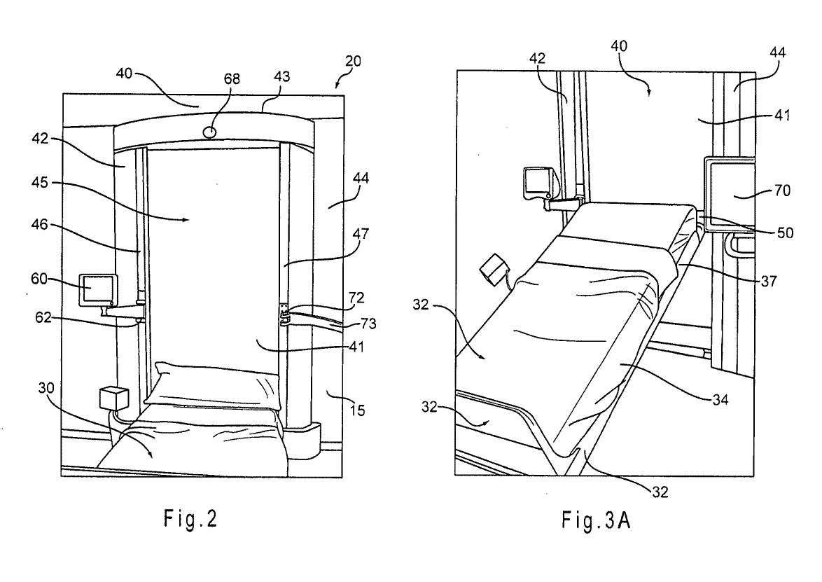

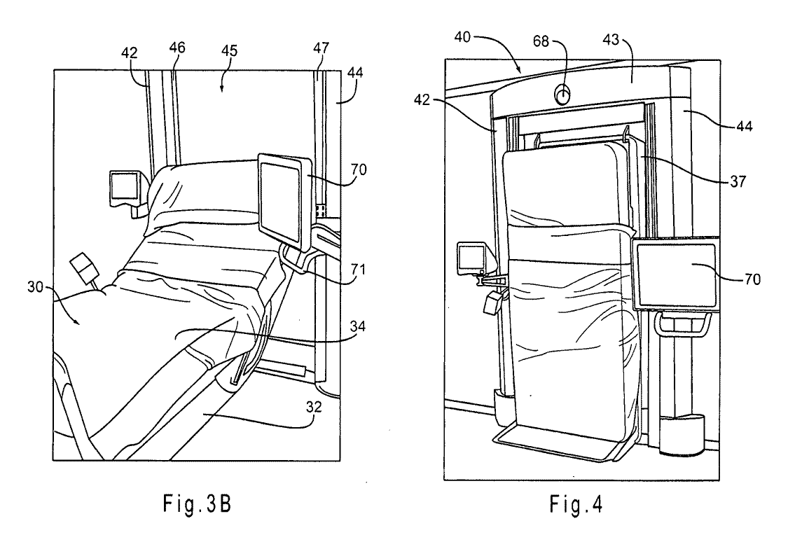

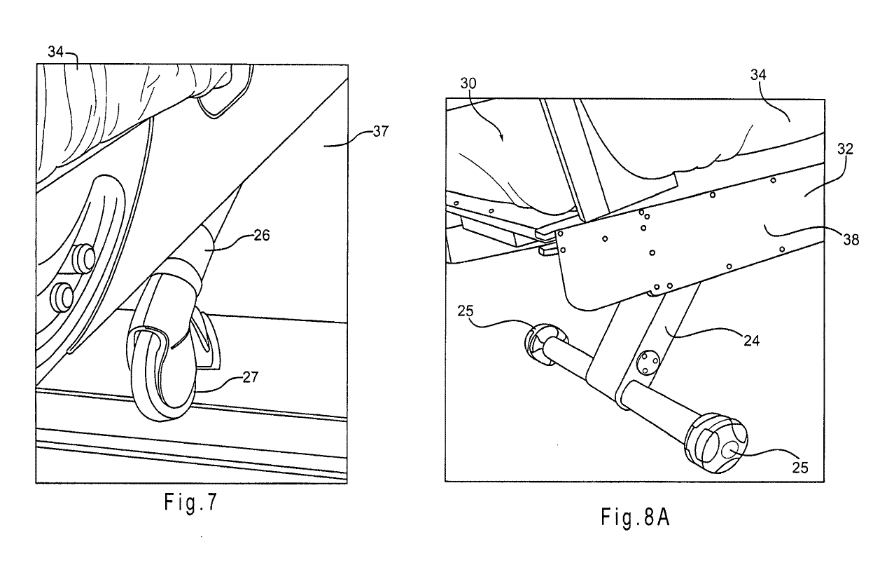

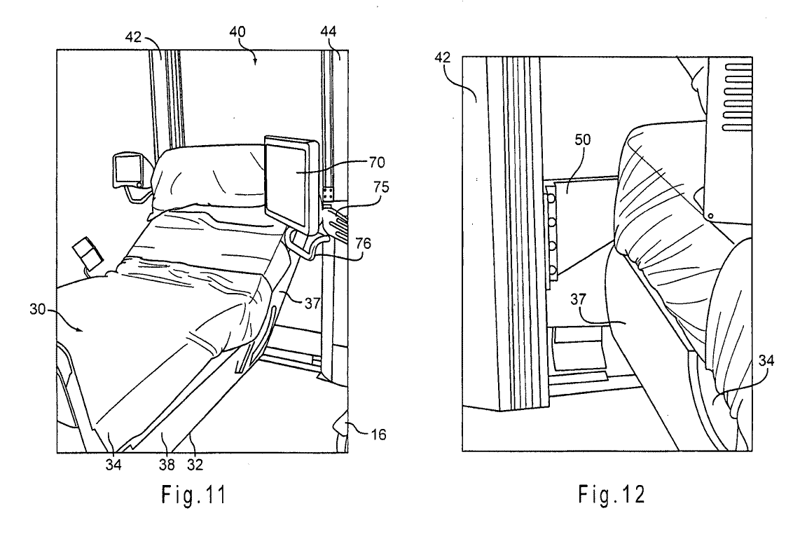

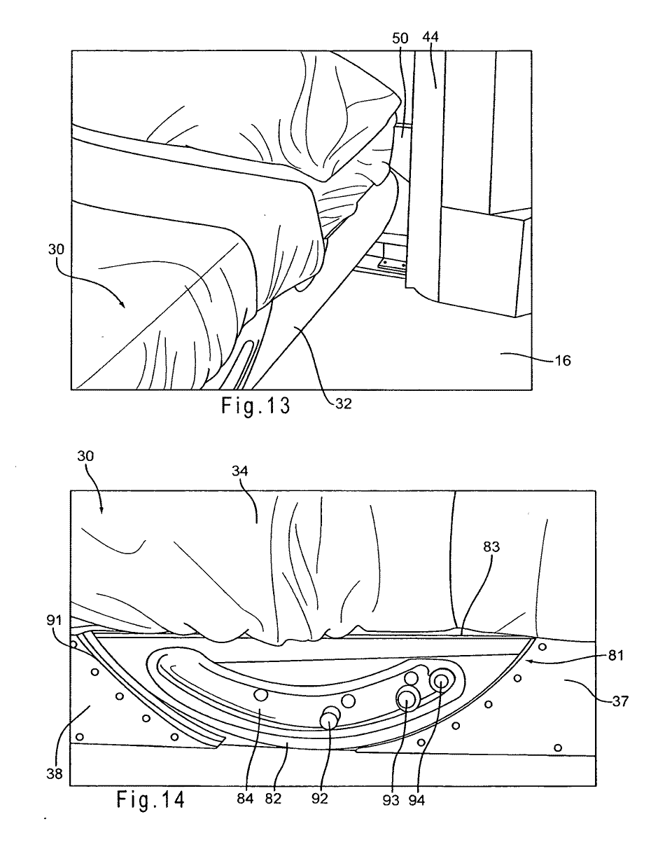

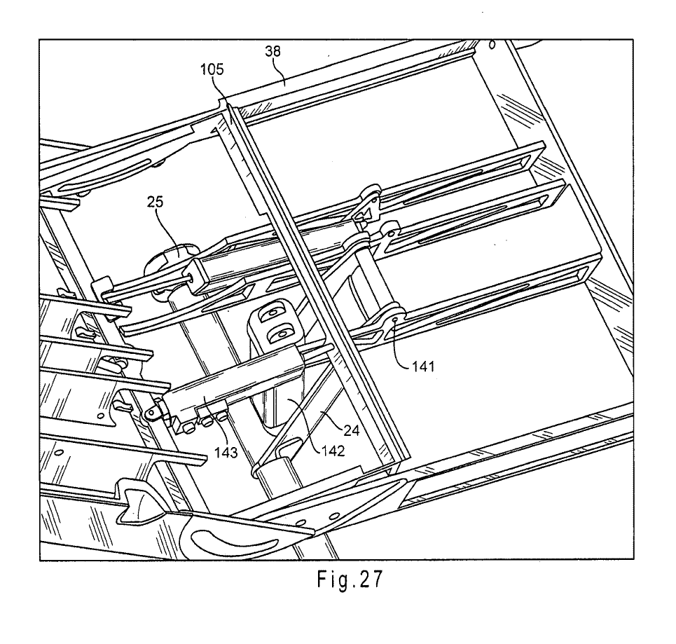

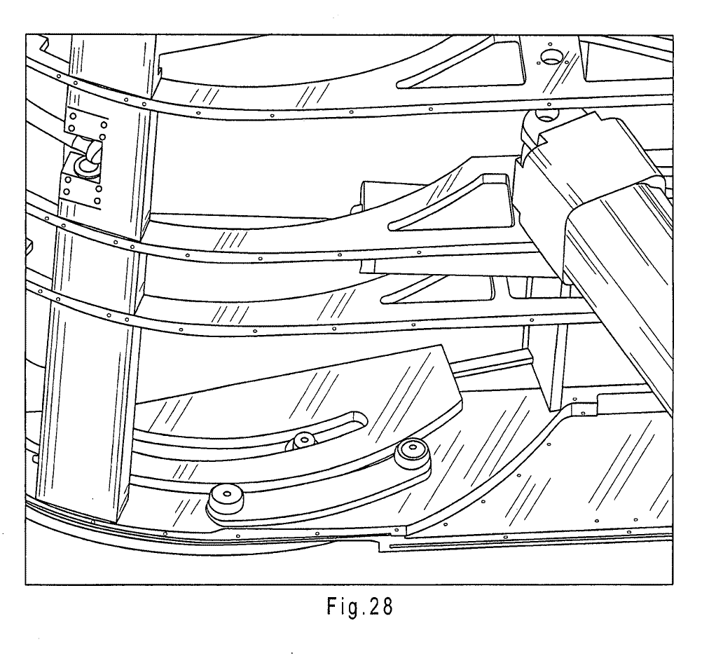

Referring now to FIGS. 2-29, a bed assembly which may be used in integrated patient room 10 is described in further detail. Bed assembly 20 comprises bed 30 having at least one support structure 32 and a body support member 34 having an upper support surface, which is adapted to receive a user such as a patient, as best seen in FIG. 3B. The body support member 34 is preferably resilient and/or compressible, and can be configured as a mattress, pad, or other structure providing a comfortable support for the patient/user. The body support member 34 can be configured with various pneumatic, mechanical and electromechanical mechanisms, as well as various static protuberances or depressions, for altering the contour of the support surface so as to reduce the likelihood of bed sores and other ailments. Likewise, the body support member can be configured with integral massage or vibration mechanisms.

In one embodiment, support structure 32 includes a chassis having a first segment 37, defining the “head” portion of the bed, and a second segment 38, defining the “foot” portion of the bed (see, e.g., FIG. 16 below). Support structure 32 is configured to receive and support the body support member 34. In accordance with one aspect, bed 30 is configured to be programmed into a variety of positions and may be synchronized with at least one other piece of furniture in integrated patient room 10, as explained in further detail below.

Bed assembly 20 further includes docking station 40, which is configured to engage at least the first segment 37 of bed 30 to effect positioning thereof, as depicted in FIG. 4 and explained in further detail below. Of course, it should be understood that the second segment can also be configured for engagement with and by the docking station.

Docking station 40 preferably comprises a frame-like structure that is configured to effect movement of bed 30 between substantially horizontal and vertical positions, as depicted in FIGS. 2 and 4, respectively. In the substantially vertical position, shown in FIG. 4, bed 30 is adapted to be stowed substantially against, or within, docking station 40 to increase floor space in patient room 10, and to help raise a patient to near standing during its travel. In this configuration, the bed is removed as the central focus of the room and provides space for the patient and visitors to gather and interact. Docking station 40 also may effect movement of bed 30 in a variety of positions between horizontal and vertical, as shown in FIGS. 3A-3B and discussed further below.

In one embodiment, docking station 40 includes first and second vertical elements 42 and 44, which are spaced apart from one another in a side-to-side or lateral direction. The vertical elements are connected at their upper ends by cross member 43, as best seen in FIGS. 2 and 4. First and second vertical elements 42 and 44 each extend in a vertical direction, and also in a direction away from rear wall 41 of docking station 40. An interior space 45 is formed between rear wall 41, first and second vertical elements 42 and 44, and cross member element 43, as shown in FIGS. 2-4. Bed 30 may be stowed in the substantially vertical position within interior space 45 and substantially against rear wall 41, as depicted in FIG. 4. In one embodiment, the lateral distance, i.e., the distance from side-to-side, between first and second vertical elements 42 and 44 is slightly greater than a lateral width of bed 30, as depicted in FIGS. 2-4, thereby facilitating stowing of bed 30 within interior space 45.

During use, any portion of docking station 40 may be secured to a wall 15 of integrated patient room 10, thereby ensuring the stability of the docking station. For example, one or more securing devices, such as screws, bolts, or the like, may be employed to couple rear wall 41, first and second vertical elements 42 and 44, and/or cross-member 43 to a portion of wall 15 and/or the ceiling of patient room 10. Therefore, a new patient room 10 may be designed for use with docking station 40, or an existing patient room may be retrofitted to incorporate a bed assembly 20 including docking station 40. In other embodiments, the docking station is free-standing, meaning that it is not secured to the wall or other architectural elements of the room or building.

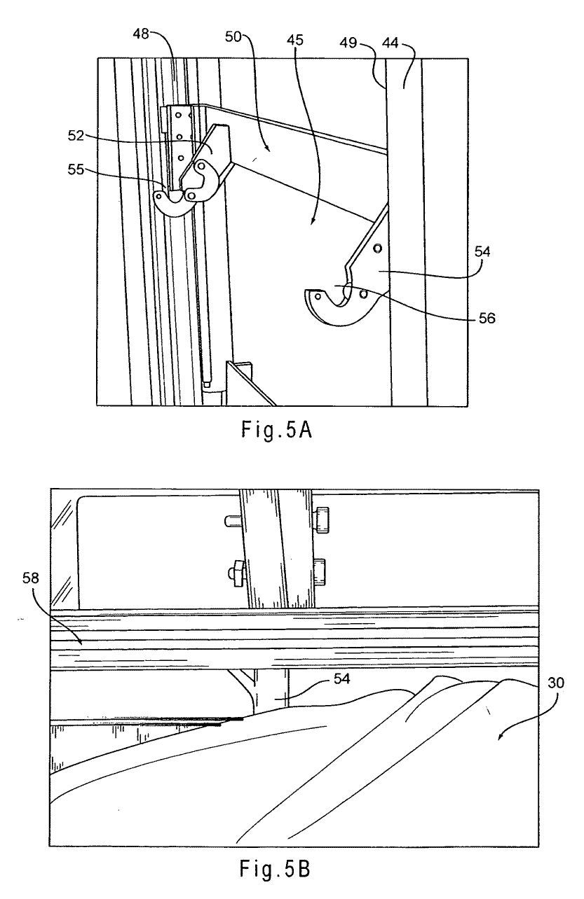

Referring now to FIG. 5A, a cross-bar 50 extends between and is moveably connected to first and second vertical elements 42 and 44. The cross-bar 50 includes a first end slidably coupled to a track along inner surface 48 of first vertical element 42 and a second end slidably coupled to a track along inner surface 49 of second vertical element 44, as shown in FIG. 5A. The cross-bar is preferably made of metal, such as steel, or any other suitably strong material capable of carrying the weight of the bed. First and second pivot brackets 52 and 54 are attached to cross-bar 50 at spaced apart locations, and extend transversely from the cross-bar in a direction towards bed 30, as shown in FIG. 5A. The distal ends of first and second pivoting brackets 52 and 54 are configured with hooked portions 55 and 56, as shown in FIG. 5A.

Hooked portions 55 and 56 are shaped and dimensioned to engage a cross-bar 58 coupled to an end of bed 30 (see FIG. 5B and FIGS. 24-25, below). It should be understood that both ends of the bed could be configured with a cross-bar 58. The cross-bar 58 is preferably cylindrical, although it can be configured with other cross-sectional shapes, including without limitation square, oval, elliptical, diamond, triangular, etc. Preferably, the first “head” end portion of the bed is coupled to the docking station. When cross-bar 58 of bed 30 is disposed within hooked portions 55 and 56 of cross-bar 50, and cross-bar 50 is raised and lowered vertically within docking station 40, the head end of bed 30 may be raised or lowered accordingly.

In one embodiment, the cross-sectional shape of the cross-bar 58 and/or recess of the hook portions 55 and 56 are configured to form an anti-dislodgement mechanism. In particular, as the cross-bar 58 rotates relative to the hook portions as the end of the bed is raised, the shape of the cross-bar and hook portion rotate into a locking configuration such that the cross-bar cannot be removed from the hook. In one embodiment, the cross-bar 58 is non-rotatably secured to the bed, such that the cross-bar rotates as the angle of the bed is changed relative to the ground and the hook portions. In one embodiment, portions of the cross-bar mating with the hook portions have a D-shaped cross section, or a perimeter with a circular portion and a flat portion. The hook portions each have an acceptance channel or opening, the width of which is just greater than the a minimum width of the cross-bar, measured as the distance between the flat portion and a parallel tangent on the opposite side of the cross-bar. In operation, the minimum cross-section of the cross bar is inserted through the acceptance channel. Thereafter, as the cross-bar rotates in the hook portion, the width of the cross-section of the crossbar aligned with the acceptance channel increases, thereby preventing the crossbar from being removed through the acceptance channel. In one embodiment, the shapes and dimensions of the cross-bar and hook portions are configured such that a relative 5 degrees of rotation therebetween is required before the two components are locked together. In other embodiments, the relative rotation is between about 0.5 degrees and 10 degrees.

The cross-bar 50 may be raised and lowered vertically within docking station 40 using a variety of powered actuation devices. In one embodiment, two screw drives extend longitudinally and vertically within each frame element. The ends of the cross-bar 50 are configured with a threaded receptacle that threadably engages the screws. The screws are rotated by independent but coordinated motors. The rotating screws threadably engage and move the cross-bar 50 in the vertical direction. In alternative embodiments, a single motor may be used in conjunction with a belt drive, chain drive, cable drive, gear box and the like to drive the two screws. In other embodiments, the cross-bar 50 can be raised by one or more pneumatic and/or hydraulic devices, located for example in each of the first and second vertical elements 42 and 44. In other embodiments, a motor-driven cable system can be used to lift the cross-bar 50.

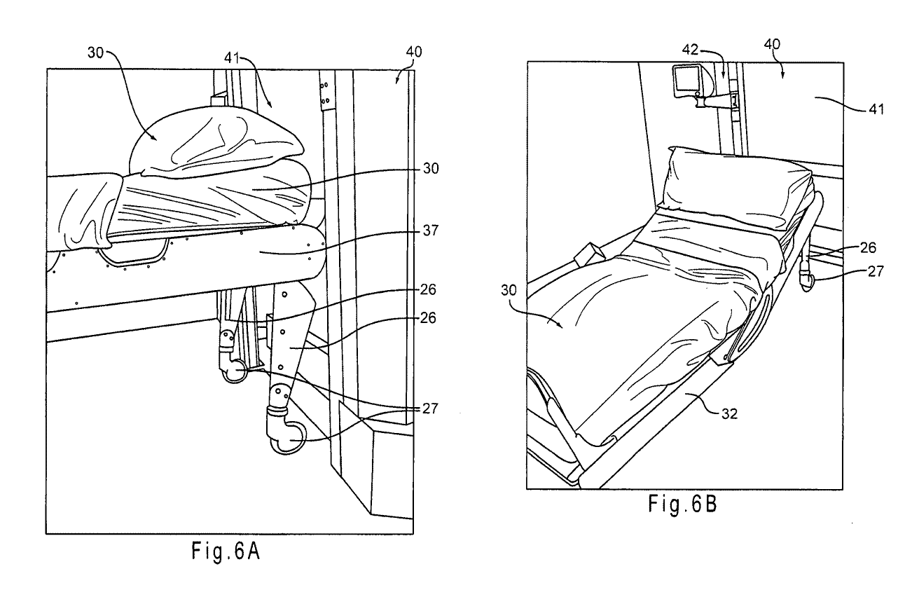

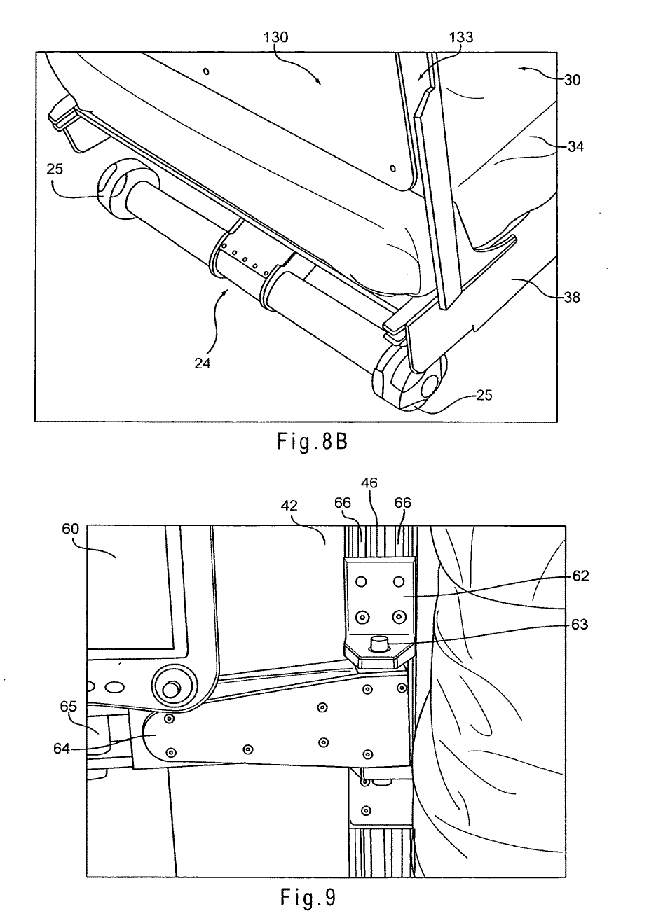

In one embodiment, bed 30 may be used independently from, or in conjunction with, docking station 40. When used alone, as depicted in FIGS. 6A-6B, the cross-bar 58 of bed 30 is disengaged from the hooked portions 55 and 56 of cross-bar 50, thereby allowing bed 30 to be moved around integrated patient room 10. In this embodiment, bed 30 includes a first support assembly 26 having at least one wheel 27, as shown in FIGS. 6A-6B, and a second support assembly 24 having at least one wheel 25, as shown in FIGS. 8A-8B. In one embodiment, the first support assembly 26 includes a pair of legs each having a first end terminating in a wheel or caster. In a preferred embodiment, the legs preferably remain in a vertical configuration substantially orthogonal/perpendicular to the support surface, or floor. An opposite end of each leg is pivotally secured to the first segment 37 of bed 30. When the first segment 37 of bed 30 is coupled to docking station 40, the legs are preferably pivoted clockwise when viewed from the right side of bed 30 underneath the bed within an interior cavity of the first segment. In this way, bed 30 can be lowered all of the way to the floor without the first support assembly 26 interfering with the movement.

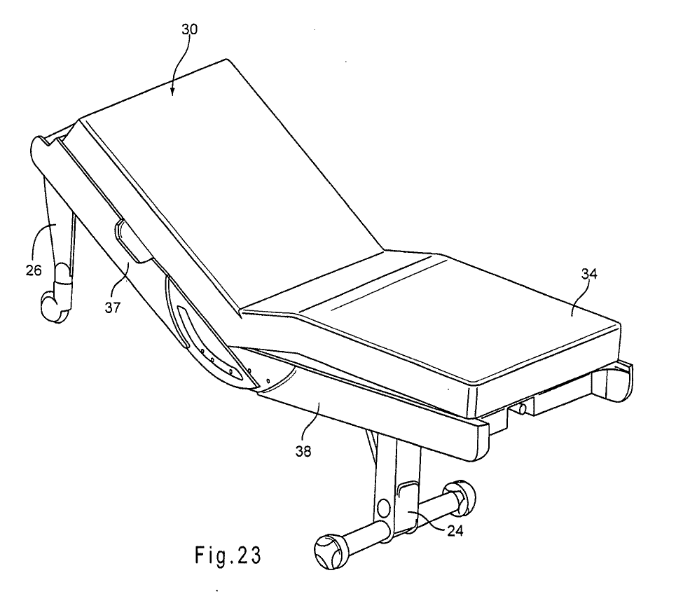

In one embodiment, explained in greater detail below with respect to FIGS. 23-29 below, the ends of the legs of first support assembly 26 are connected to an axle or pivot rod defining a horizontal and laterally extending pivot axis. A linear actuator, for example as a pneumatic, hydraulic or screw drive, is coupled to first support assembly 26. As the actuator extends or retracts, the support assembly is pivoted about the pivot axis between the stored position and the support position. It should be understood that other actuators, such as rotational actuators, can be coupled to the pivot rod directly so as to effect pivoting of the support assembly. Further details regarding the actuation of first support assembly 26 are provided below with respect to FIGS. 23-29.

In an alternative embodiment, described in FIGS. 31-37 below, the first support assembly may be omitted, such that the head region of the alternative bed assembly 150 is always supported and coupled to docking station 40 via cross-bar 50. In yet another embodiment, the bed is configured to be adjustable to a plurality of positions only when coupled to the docking station, but is provided with a wheeled support assembly that holds the bed in a horizontal position for transport of the bed alone, or of the bed and patient.

As shown in FIGS. 8A and 8B, the second support assembly 24 is preferably T-shaped, with a centrally located post or arm and a horizontal and laterally extending foot. Each end of the foot is configured with a wheeled device 25, such as caster or other multi-directional rotational support. The wheeled device 25 is configured to allow movement of the bed in both a longitudinal and lateral direction. The term “longitudinal” as used herein means lengthwise, such as from the head to the foot of the bed, or from the floor to ceiling direction with respect to docking station 40. An upper end of the post is pivotally secured to second segment 38 of support structure 32 about a horizontal and laterally extending pivot axis. A linear actuator may be used to actuate second support assembly 24, the actuator having a first end connected to second segment 38 and an opposite end pivotally connected to second support assembly 24, for example at a location adjacent the junction between the post and the foot. Further details regarding the actuation of second support assembly 24 are provided below with respect to FIGS. 23-29. It should be noted that the linear actuator can be configured as an electric or electromechanical device, such as a screw drive, or a pneumatic device, hydraulic device, or combinations thereof. As the actuator is retracted or extended, the support assembly is pivoted about the pivot axis to the desired angular position relative to the floor. It should be understood that other actuators, including for example rotational actuators, can be directly coupled to the upper end of second support assembly 24 at the pivot axis.

The second support assembly 24 can be pivoted over a wide range of angular positions between a position substantially orthogonal/perpendicular to second segment 38 of support structure 32, as shown in FIG. 8A, to a position substantially parallel to second segment 38, as shown in FIG. 8B, or over a range of approximately 90 degrees.

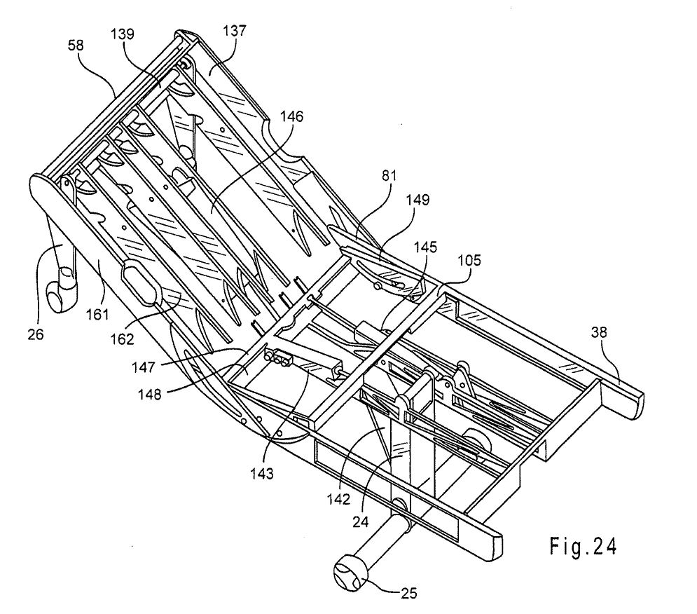

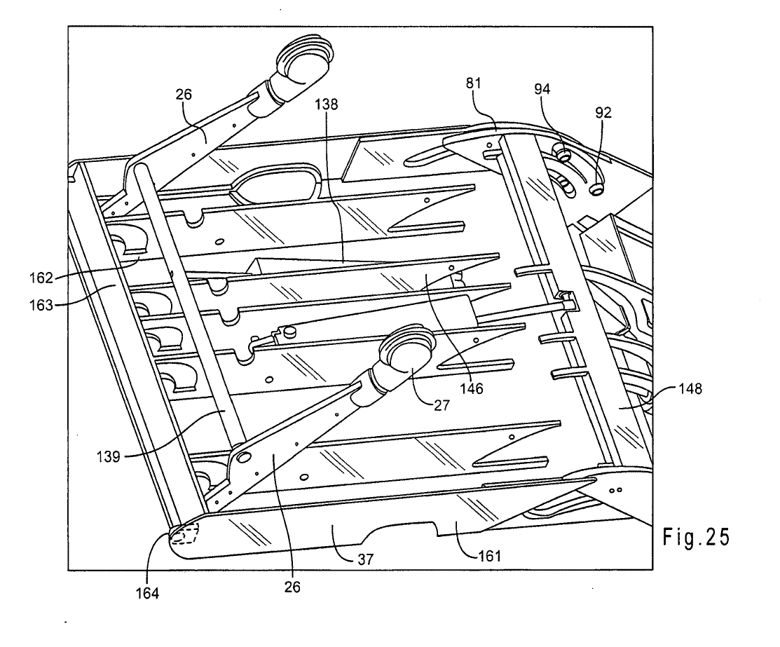

First and second segments 37 and 38 of support structure 32 are moveably coupled, as shown and explained in FIGS. 23-29 below. In this embodiment, the first and second segments provide sufficient structural integrity, such that there is no need for a rigid or fixed frame to extend from the head to the foot of the bed, as is required by some conventional hospital beds. As such, the space beneath the bed is opened up as the bed moves between different positions. The first segment 37 includes a pair of side walls 161 and a plurality of interior frame elements 162 all extending in the longitudinal direction, as shown in FIG. 24. An end wall 163 extends between and is connected to side walls 161 and the frame elements 162, as shown in FIG. 25. The cross-bar 58 extends between and is connected to a pair of flanges 164 extending from the ends of the side walls 161, as shown in FIG. 25. The various wall and frame elements can be secured with mechanical fasteners, or by welding, lock tabs, and other know devices. In addition, a skin is connected to the bottom side of the second segment 38, and in particular spans between the outer walls and is connected thereto and to the interior frame elements. The skin provides rotational rigidity and protection against racking. A similar skin can be configured for the first segment if desired or necessary.

Referring now to FIGS. 14-16, a pivot joint connects first segment 37 and second segment 38 of support structure 32. The pivot joint is configured such that the segments 37, 38 pivot relative to each other about a virtual pivot axis corresponding to the patient's hip joint. The sidewalls of first segment 37 terminate in a crescent shaped end portion 81 having a bottom curved surface. A curved slot 84 is formed in the end portion. A mating end portion of second segment 38 defines a crescent-shaped recess 91 shaped to rotationally receive the end portion of the first segment 37. A plurality of rollers 92-94 are rotatably secured to second segment 38 and are engaged in the curved slot 84 of first segment 37. The rollers 92-94 help maintain alignment of substantially crescent-shaped member 81 within crescent-shaped recess 91 throughout the pivoting motion of first segment 37 relative to second segment 38. For example, when first segment 37 is elevated, e.g., using cross-bar 50 of docking station 40 while second segment 38 remains horizontal, then the end portion rotates within the recess 91, as shown in FIG. 16. Throughout the range of movement, rollers 92-94 help maintain alignment between substantially crescent-shaped end portion 81 and crescent-shaped recess 91. In one embodiment, there are two sets of rollers. The primary set of rollers 92-94 are preferably V-grooved, and bear both radial and axial loads. The three primary rollers provide three non-colinear points of contact, thereby providing resistance to racking of the second support segment. A secondary set of rollers has studs with variable eccentricity. By adjusting the eccentricity, the primary rollers can be pre-loaded against the V-shaped track along which they ride.

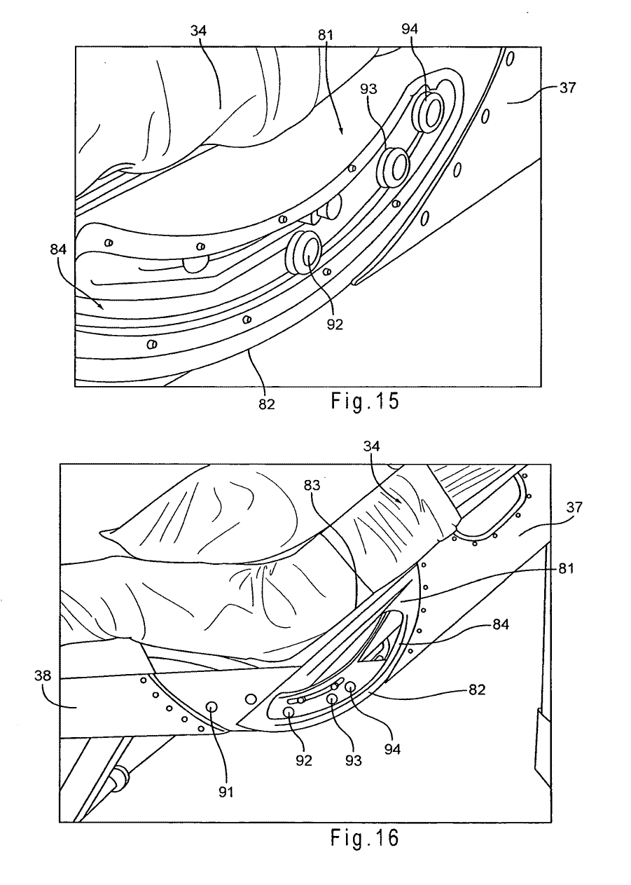

When bed 30 is in a supine position, rollers 92-94 are disposed near a first end of curved slot 84 closer to the head of the bed, as shown in FIGS. 14-15. By contrast, when first segment 37 of bed 30 is angled with respect to second segment 38, rollers 92-94 are disposed near a second end of curved slot 84, as shown in FIG. 16. Importantly, the pivoting action provided by substantially crescent-shaped member 81 and crescent-shaped recess 91 provides for rotation about the axis of the patient's hips so as to reduce the shear forces applied to the skin of the patient as the patient transitions between the supine and sitting positions, thus reducing the consequent possibility of acquiring bed sores. Further details regarding the actuation of first member 37 with respect to second member 38 are provided below with respect to FIGS. 23-29.

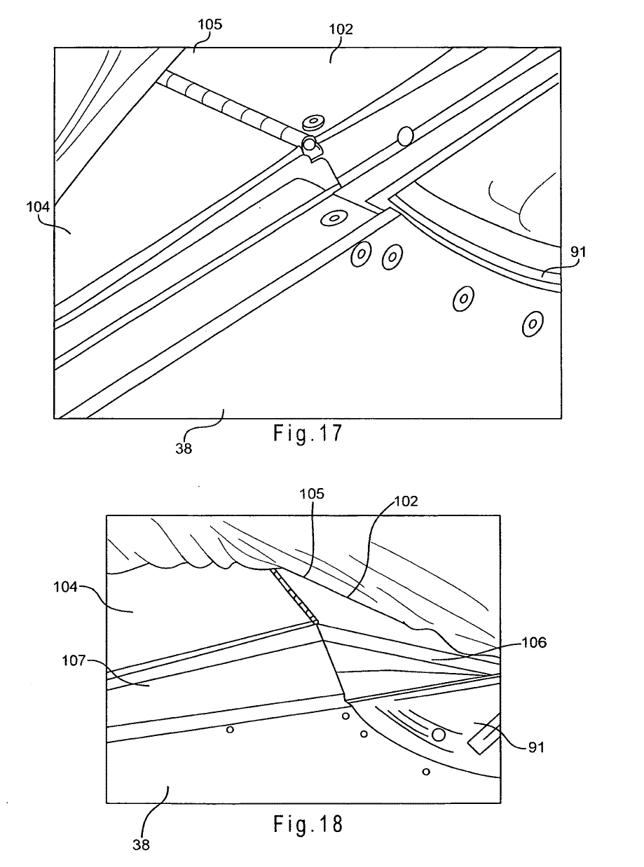

Referring now to FIGS. 17-18, an adjustable knee gatch for use with bed 30 is described. The adjustable knee gatch comprises a first support member 102, a second support member 104, and hinge 105 disposed therebetween and defining a horizontal, lateral pivot axis, as shown in FIG. 17. Hinge 105 preferably is positioned at a location substantially beneath a patient's knees, for example about two feet from the foot end, or foot board, of the bed in a supine position. The hinge is positioned to approximate the distance between the hip and the knee of the patient. In a supine position, first and second members 102 and 104 are substantially parallel to each other and to the floor of the patient room, as depicted in FIG. 17. The body support structure member 34, such as a mattress, is disposed to lie substantially flat over first and second members 102 and 104 in this configuration, thereby comfortably supporting a user in the supine position.

If it becomes desirable to provide an upraised surface beneath the patient's knees, e.g., to support the patient's knees in a flexed position, then the ends of first and second members 102 and 104 that are coupled to hinge 105 are vertically raised with respect to the floor of the patient room, as shown in FIG. 18, or raised relative to the plane defined by the second segment. As explained further below, for example, in FIG. 24, an actuator 145 is secured to a cross member supporting hinge 105 to permit adjustment of first and second support members 102 and 104 with respect to each other, while another actuator 143 is provided to vary the longitudinal positioning of hinge 105 relative to the hip pivot axis to accommodate users of different heights. Further details regarding actuators 145 and 143, which are used to raise the knee gatch and vary its longitudinal position, are provided below with respect to FIGS. 23-29.

Referring now to FIGS. 23-29, various exemplary actuation mechanisms associated with bed 30 are described. There may be at least five bed actuators, for example, linear actuators, that effect movement of bed 30 in the various positions described herein. As noted above, the linear actuator can be configured as a electrical or electromechanical devices, such as a screw drive, pneumatic device and/or hydraulic device, or combinations thereof. It should be understood that other types of actuators, including rotational actuators, cables, pulleys etc, can be used in place of the linear actuators referred to here and throughout.

A first actuator 138 is coupled to first support assembly 26, as shown in FIG. 25. First support assembly 26 has a first end coupled to a pivot point in the vicinity of flanges 164, and further has a second end coupled to wheels 27, as shown in FIG. 25. A supporting cross-bar 139 may be disposed between the two legs of support assembly 26. Actuator 138 may comprise a linear actuator, and when extended or retracted, causes first support assembly 26 to pivot around the pivot point, as seen in FIG. 25. This causes first support assembly 26 to rotate over a range of motion of approximately 90 degrees.

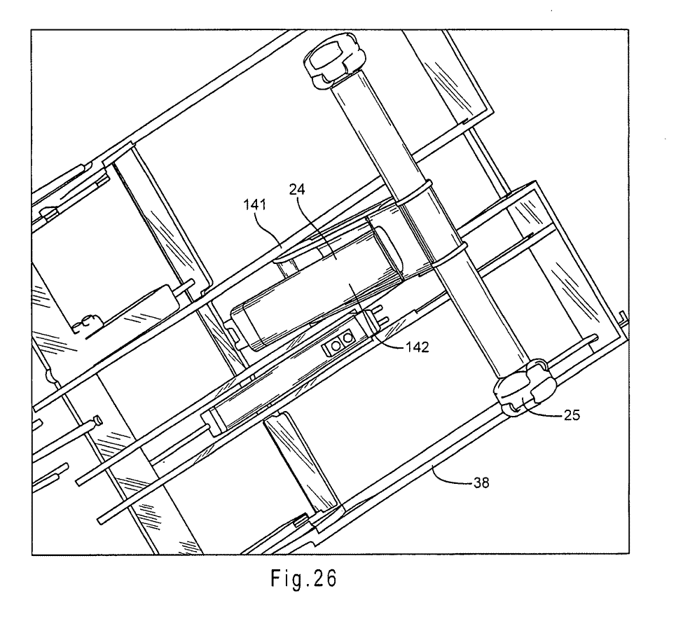

Similarly, a second actuator 142 is coupled to second support assembly 24, as shown in FIGS. 24 and 26. Second support assembly 24 has a first end coupled to the support structure at pivot point 141, and a second end coupled to wheels 25, as shown in FIG. 26. Actuator 142 may comprise a linear actuator, and when advanced or retracted, causes second support assembly 24 to pivot around pivot point 141, as seen in FIG. 26. This causes second support assembly 24 to rotate over a range of motion of approximately 90 degrees.

A third actuator 146, as best seen in FIGS. 24 and 25, may be used to effect rotation of first segment 37 relative to second segment 38. As noted in FIGS. 14-16 above, one or more rollers 92-94 help maintain alignment of substantially crescent-shaped member 81 within crescent-shaped recess 91 throughout the pivoting motion of first segment 37 relative to second segment 38. As shown in FIG. 25, actuator 146 is operably coupled to cross member 148, which in turn is coupled to crescent-shaped member 81 of first segment 37. Actuator 146 preferably comprises a linear actuator. As actuator 146 is linearly advanced/extended or retracted, cross member 148 is advanced or retracted, and crescent-shaped member 81 is advanced or retracted accordingly. Since movement of crescent-shaped member 81 is guided by rollers 92-94, the rollers maintain alignment of crescent-shaped member 81 within crescent-shaped recess 91, thereby allowing pivoting motion of first segment 37 relative to second segment 38.

Still further, fourth and fifth actuators 143 and 145 are provided to actuate the knee gatch of bed 30, as explained in FIGS. 17-18 above. First, actuator 145 is operably coupled to cross member 147, which in turn is further supported at opposite ends thereof by a pivot member 149 supported by a p′air of rollers connected to the interior of second segment 38, as shown in FIG. 24. Cross member 147 connects opposing pivot members 149, which are rotatable relative to second segment 38. As actuator 145 is extended and retracted, cross member 148 and pivot members 149 rotate so as to raise the ends of the first support member 102 and the second support member 104 adjoining hinge 105 along therewith, as shown in FIG. 18 above.

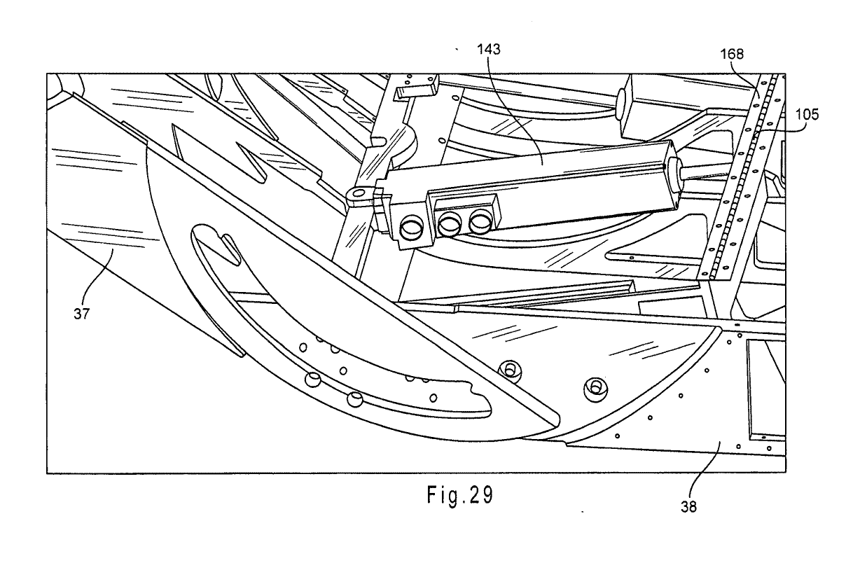

In addition, if it is desired to change the longitudinal position of the axis of hinge 105, another actuator 143 can be extended and retracted. As best seen in FIGS. 24 and 29, actuator 143 is coupled to a cross member 168 coupled to hinge 105. As actuator 143 is extended and retracted, cross member 168 also is extended and retracted to vary the longitudinal positioning of hinge 105. In this manner, the longitudinal positioning of hinge 105 relative to the hip pivot axis may be adjusted to accommodate users/patients having different femur lengths. For example, if a relatively small user is resting on bed 30, then hinge 105 may be positioned longitudinally closer to the virtual hip pivot to accommodate a correspondingly relative short length between the patient's knees and hips. By contrast, if a relatively long-legged patient is resting on bed 30, then hinge 105 may be positioned longitudinally further from the virtual hip pivot to accommodate the increased length between the patient's hip and knees. Movement of the actuators 143, 145 is coordinated such that the cross-member 168 is moved to the desired position. The first and second members 102 and 104 are dimensioned to underlie the body support member 34 throughout the adjustable range of motion to ensure that a user resting on body support member 34 is always supported, as shown in FIGS. 17 and 18.

### Operation of Bed

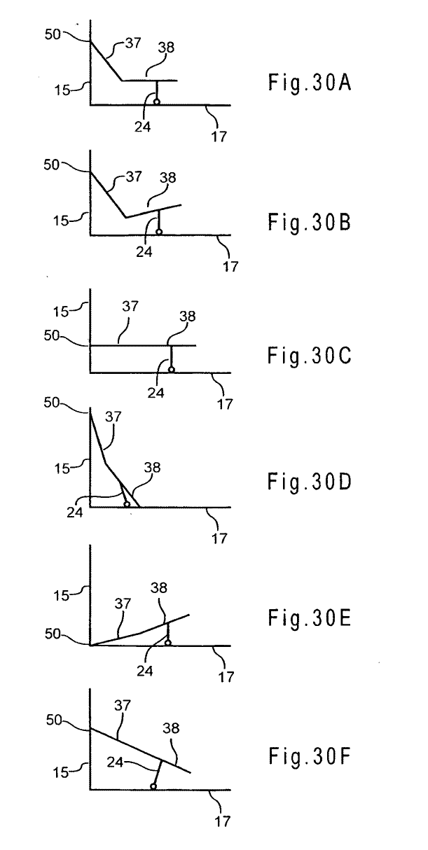

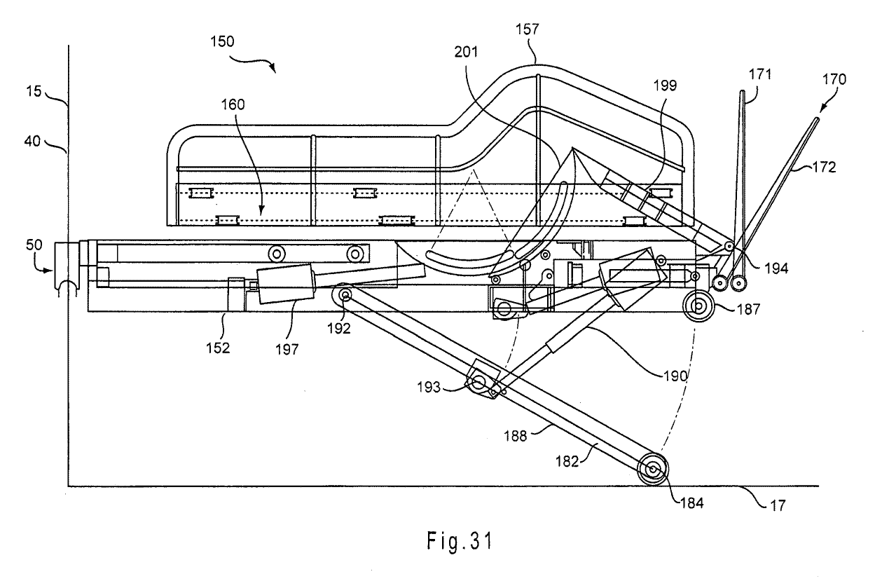

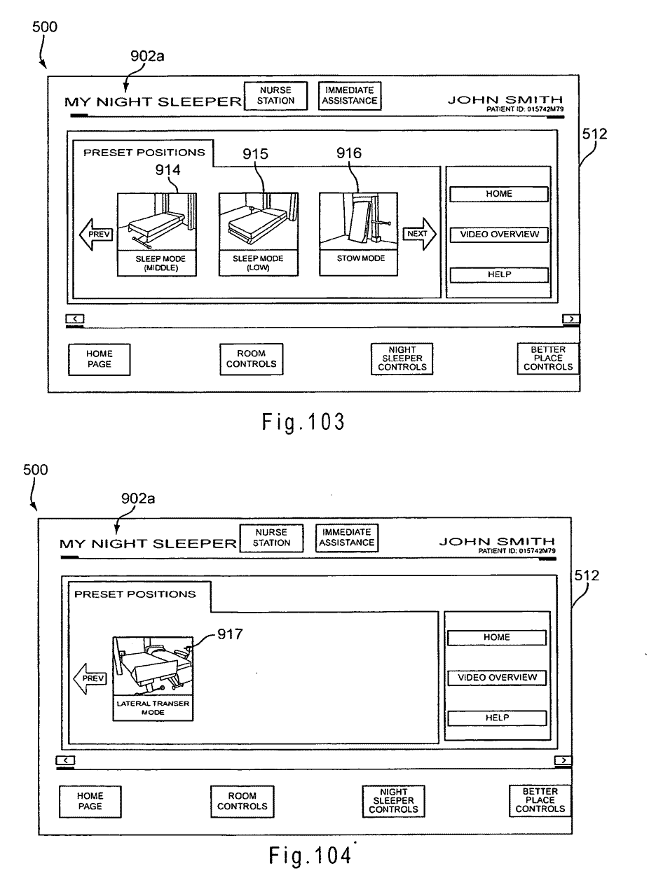

Referring now to FIGS. 30A-30F, schematics illustrating bed assembly 20 in various positions are shown. Using the actuators coupled to bed 30, as described above in FIGS. 23-29 above, in conjunction with use of docking station 40, bed 30 may be placed in various positions. For example, such positions include upright seated, reclined seated, supine for examination, erect egress, Trendelenburg, and reverse Trendelenburg positions, as depicted in FIGS. 30A-30F, respectively. In each of the positions, first segment 37 is shown coupled to second segment 38. First segment 37 is operably coupled to cross-bar 50, which is movable vertically within docking station 40, as explained above. Schematically, FIGS. 30A-30F illustrate various positions that may be achieved by varying the angle of first and second segments 37 and 38 with respect to one another, by raising or lowering cross-bar 50 with respect to wall 15 via docking station 40, and/or by varying the angular position of support assembly 24 with respect to second segment 38 and floor 17, as explained above. Various other positions may be achieved. By way of example, in FIGS. 102-103 below, additional positions such as “Stow mode” and “Lateral Transfer mode” may be achieved by actuating the various components with respect to one another.

When bed 30 is used in conjunction with docking station 40, as noted above, the cross-bar 58 of bed 30 is engaged with hooked portions 55 and 56 of cross-bar 50. If it is desired to place bed 30 in a supine position, with first and second segments 37 and 38 being aligned or parallel as shown in FIG. 30C, then cross-bar 50 is lowered and raised simultaneously with a pivoting of the support assembly, such that the bed can be maintained in the supine position over a wide range of vertical heights. In one embodiment, the sleep surface, or upper surface of the mattress, can be adjusted from 12 to 36 inches relative to the floor in the supine positions.

In a second sequence of operation shown for example in FIGS. 3A and 30F, first and second segments 37 and 38 remain parallel to one another, but can be angled relative to the floor 17 over a range of −30 degrees (head-down) to 90 degrees (fully vertical as docked). For a “head-down” position, the cross-bar 50 is lowered within docking station 40 while the support assembly remains at an elevated position. In a “head-up” position, the cross-bar 50 is raised, with the support assembly either remaining in a raised position, or being pivoted toward a stored position.

In yet another sequence, the rotation of bed 30 in a “head-up” position can be continued until the bed is vertical, with the support assembly being retracted under the bed and positioned substantially perpendicular/orthogonal to the floor. In this position, the bed can be stored. In addition, the bed can be moved toward this position to help facilitate the egress of the patient to a standing position. As a subset of this operation, the knee-gatch can be raised to provide a buttock shelf support, defined by a portion of the support member 102 (e.g., about six (6) inches) adjacent the hip pivot axis, as shown in FIG. 18 above.

In yet another sequence, the angle of the first and second segments 37 and 38 can be adjusted from the 0 degrees parallel position to a maximum angular position of 45 degrees. The angular position can be maintained or adjusted in combination with the first and second segments 37 and 38 being raised or lowered relative to the floor 17.

In yet another sequence, the bed 30 is disengaged from the docking station 40, with the first support assembly 26 supporting the first segment 37. The second support assembly 24 supporting the second segment 38 can then be pivoted to provide angular positions of the first and second segments 37 and 38. At the same time, the knee gatch can be adjusted, both in height and longitudinal position, as explained above. In another embodiment, the support assembly 24 supporting the first segment 37 can also be rotated to different positions to achieve different overall heights and angular positions of the bed.

To redock the bed, the connecting cross-bar 58 of bed 30 is positioned under the cross bar 50, and cross bar 50 is raised to cause hooked portions 55 and 56 to engage cross-bar 58 of bed 30. The support assembly is then further vertically raised to engage and support the first segment. Preferably, no tools are required to couple bed 30 to docking station 40. Moreover, as mentioned above, the cross-bar 58 and hook portions can be configured to lock the bed to the cross bar 50, for example after 5 degrees of rotation.

As noted above, bed 30 is adapted to assume a wide range of positions. The range of positions may be achieved for patient comfort, ease of use for a caregiver, functional purposes, e.g., to facilitate examination, allow for transfers to an alternate support device (e.g., chair) and so forth. In accordance with one aspect, bed 30 may be pre-programmed into any number of positions, for example, through the use of a communication portal, such as touch-screen monitor 70, or a remote user interface. Bed 30 may be preprogrammed based on standard or changing protocols, or information pertaining to a patient, caregiver, or other user. Without limitation, the programmable positions may include the afore-described upright seated, reclined seated, supine for examination, erect egress, Trendelenburg, and reverse Trendelenburg positions. In accordance with another aspect, as described above, bed 30 is adjustable in at least one of the supine, sitting and upright positions based on information associated with an individual using the bed. For example, in the supine position, the height of the bed 30 may be adjustable with respect to floor 16 of patient room 10. Bed 30 may be vertically adjustable with an upper support surface having a supine height of between about 12 inches to about 36 inches with respect to floor 16. The change in height may be achieved by raising or lowering cross-bar 50 of docking station 40 and pivoting support assembly 24, as explained in FIGS. 5A-5B above.

In one preferred bed position, as shown in FIG. 13 above, cross-bar 50 of docking station 40 is positioned substantially proximate to floor 16, and therefore, support structure 32 and support surface 34 also are disposed in close proximity to floor 16. In one configuration, the support assembly 24 is entirely retracted, i.e., in a substantially parallel position adjacent to second segment 38 of support structure 32. In this lowered supine state, safer conditions may be achieved. Further, the need for side railings may be reduced or eliminated when bed 30 is in the lowermost position shown.

### Alternative Bed Configuration

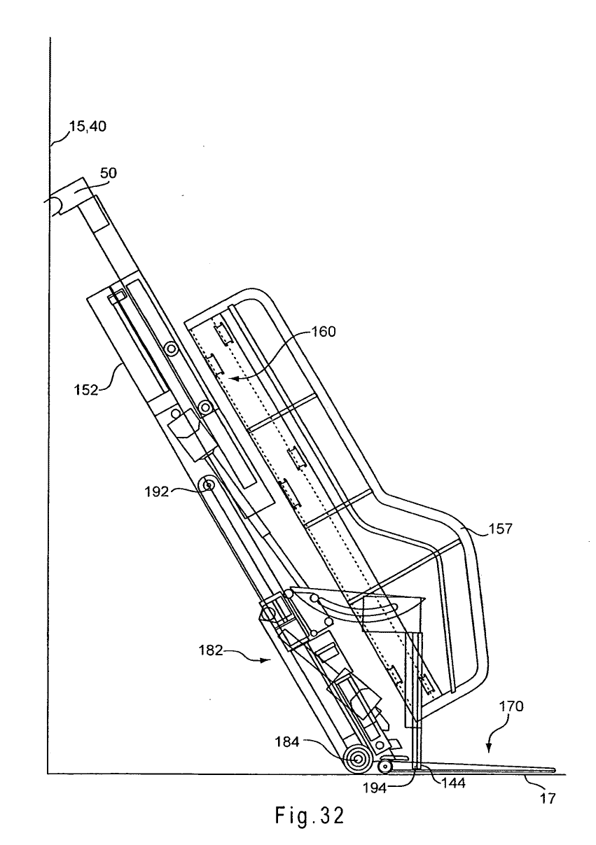

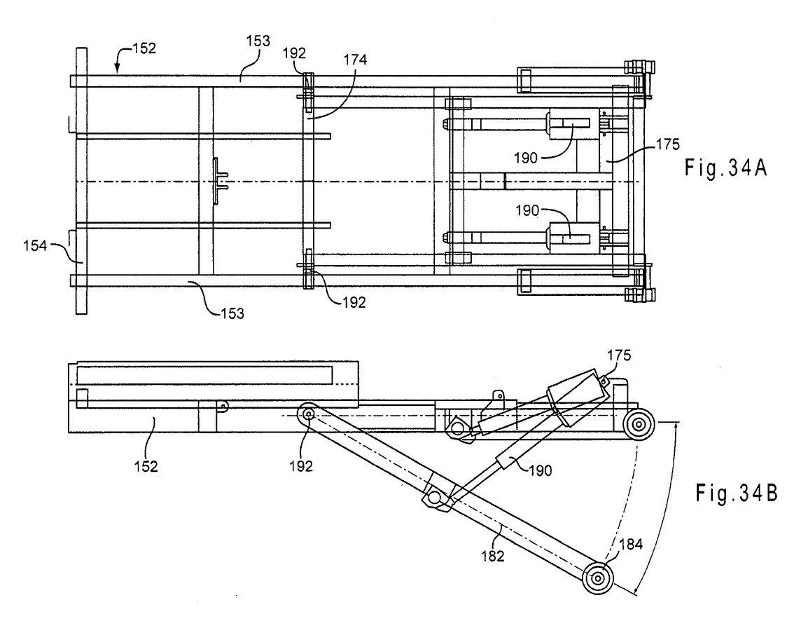

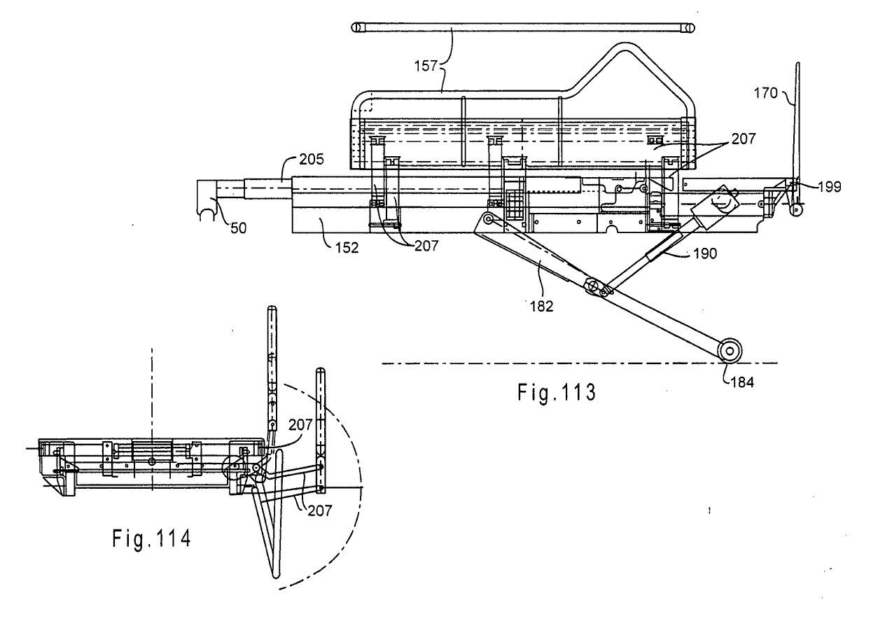

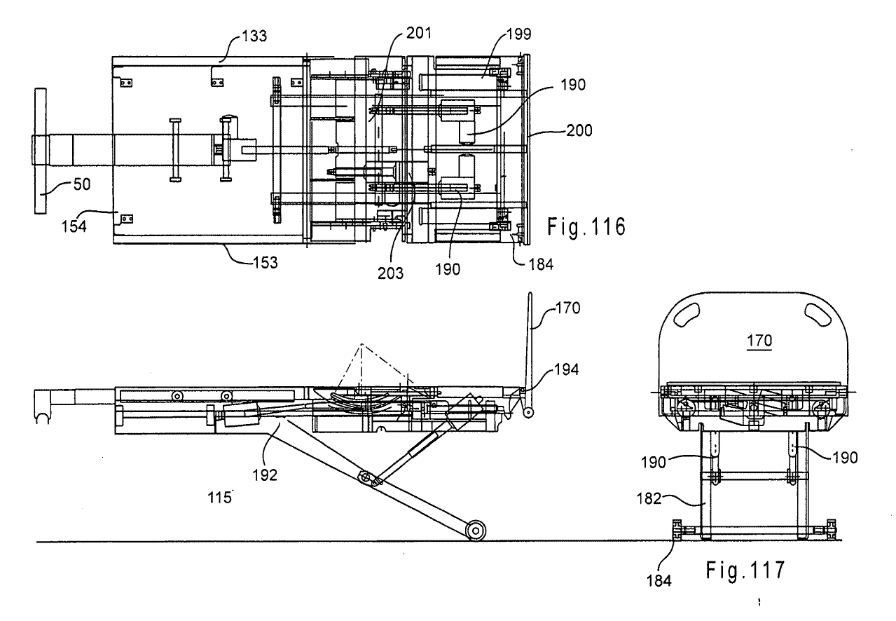

Referring now to FIGS. 31-37 and 113-117, in an alternative embodiment, bed assembly 150 includes a fixed exterior frame 152 having opposite end walls 154 and opposite side walls 153, as best seen in FIGS. 34A and 116. A first end wall 154 is coupled to cross-bar 50 or other device configured to be engaged by docking station 40, as explained above. In addition, a support assembly 182 having at least one wheel 184 is pivotally connected to frame 152 about a horizontal, laterally extending axis 174. A linear actuator 190 is pivotally connected to frame 152 at a second pivot axis 175, which is spaced from the first axis 174, as shown in FIGS. 34A-34B, 113, 115 and 117. The actuator 190 is extended or retracted so as to pivot support assembly 182 about pivot members 192 on the pivot axis 192, thereby moving support assembly 182 from a deployed position 188 to a retracted position 187, as shown in FIGS. 31 and 32. In retracted position 187, support assembly 182 is disposed within a recess defined by frame 152. In deployed position 188, wheels 184 of support assembly 182 engage the floor and support bed 150. In one embodiment, support assembly 182 has an angular range of motion of less than or equal to about 30 degrees, and in one embodiment a maximum angular position of about 27.340 degrees, as depicted in FIG. 34B.

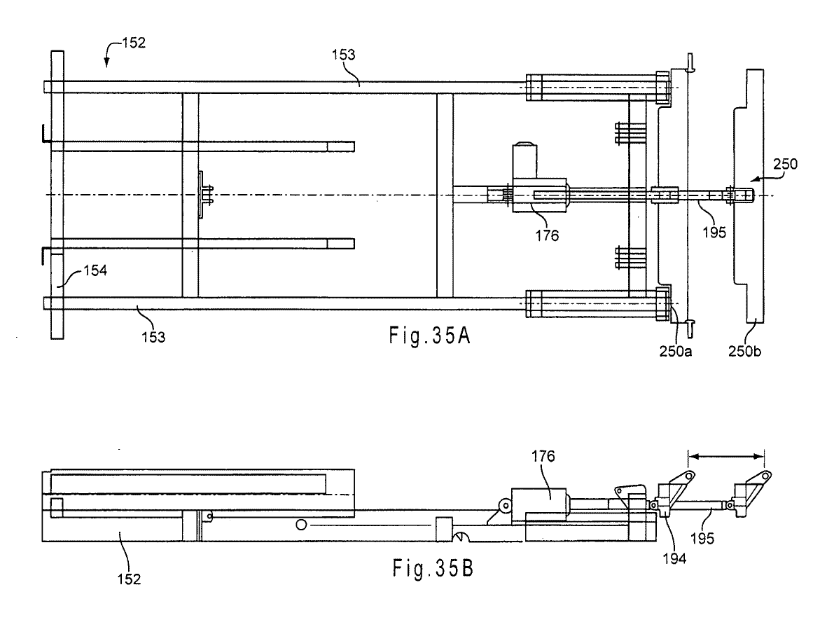

Referring now to FIGS. 35A-35B, 113 and 115, a foot support 170 is operably coupled to frame 152. Foot support 170 includes a platform that extends transversely relative to frame 152, and is longitudinally movable and rotatable with respect to frame 152. A linear actuator 176 that is coupled to frame 152, and extends substantially parallel to the frame, enables longitudinal movement of foot support 170 by way of telescoping member 195. When retracted or advanced, telescoping member 195 may move foot support 170 longitudinally between first and second positions 170a and 170b, as shown in FIG. 35A, thereby varying the longitudinal length of the bed for different users. Further, foot support is angularly rotatable with respect to frame 152 at pivot point 194, as best seen in FIGS. 31, 35B, 113 and 115. When rotated about pivot point 194, foot support 170 may move between a first position 171 and a second, rotated position 172, as depicted in FIG. 31, with the foot support 170 remaining at substantially a right angle to lower leg support 199.

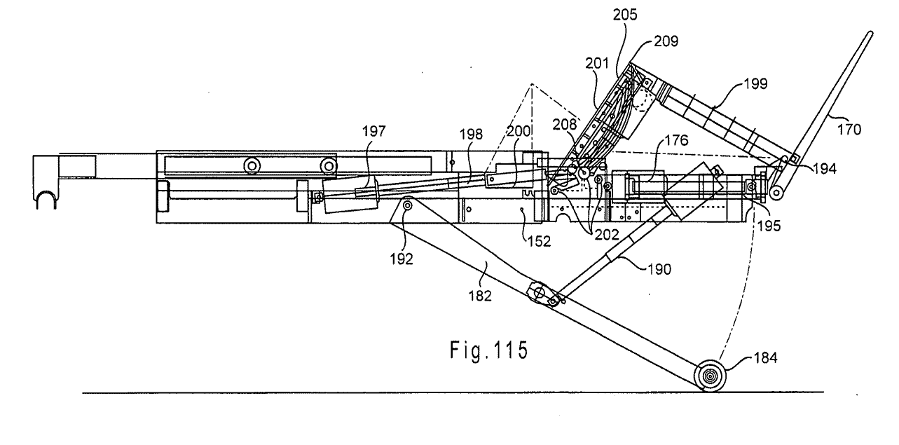

In one embodiment, shown in FIGS. 31, 35A-B, 115 and 116, a lower leg support 199 has a first end portion pivotally connected to an end of buttock support 201, with an opposite end portion connected to foot support 170. Foot support 170 is pivotally connected to frame 250, which is connected to linear actuator 176 at a pivot axis. Therefore, in operation, actuator 176 is extended and retracted so as to move frame 250 in-line with frame 152, and as foot support 170 and lower leg support 199 are rotated as depicted in FIGS. 31 and 115. In particular, support 201 is pivoted about a virtual hip pivot axis by actuator 197. Lower leg support 199 is hingedly connected to the support 201 at hinge joint 203. When support 201 pivots, the lower leg support 199 moves with it. The foot support 170 is attached perpendicular to the lower leg support 199. The support 199 includes a pair of overlapping members that slide over each other to compensate for the frame 250 moving from position 250a to 250b as shown in FIGS. 35 A and B.

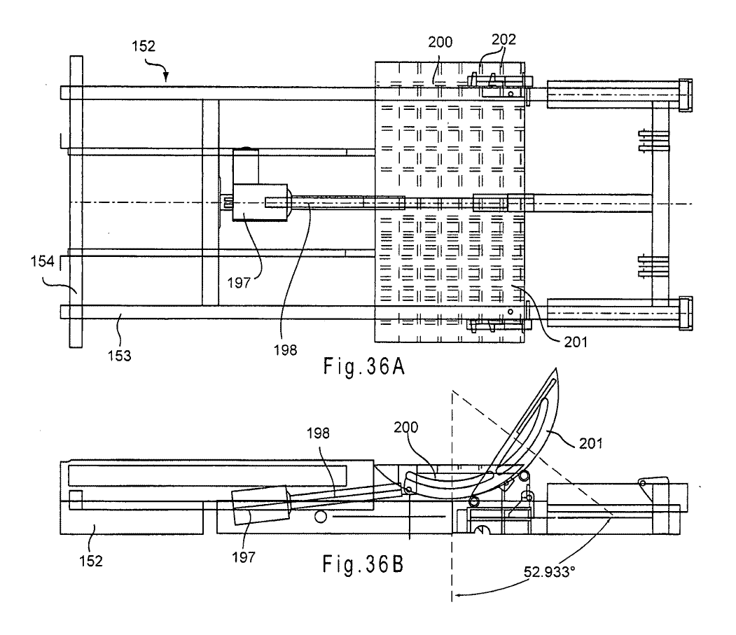

Referring now to FIGS. 36A-36B and 115, the upper leg and buttock support for use with bed assembly 150 is shown. The upper leg and buttock support 201 has a crescent shaped bottom curved surface is rotatably supported by frame 152. The support 201 is adapted to be disposed within recess 200 when bed 150 is in a supine position, such that an upper surface of buttock support 201 is substantially flush with an upper surface of frame 152. A plurality of rollers 202 support the buttock support 201 as it rotates relative to frame 152. A linear actuator 197 is secured between frame 152 and buttock support 201 and rotates the upper leg and buttock support about a virtual pivot axis proximate the hip joint of the user. Operation of upper leg and buttock support 201 may be similar to the operation used to effect rotation of first segment 37 relative to second segment 38, as described in FIGS. 24-25 above. Like third actuator 146 of FIGS. 24-25, linear actuator 197 is operably coupled to buttock support member 201 by way of a telescoping rod 198, as shown in FIG. 36B. As actuator 197 is linearly advanced or retracted, telescoping rod 198 is advanced or retracted, and the support 201 is advanced or retracted (rotated about the virtual pivot axis) accordingly. Since movement of the support 201 is guided by rollers 202, the rollers maintain alignment of buttock support 201 within recess 200, thereby allowing pivoting motion of buttock support 201 with respect to frame 152, as depicted in FIG. 36B.

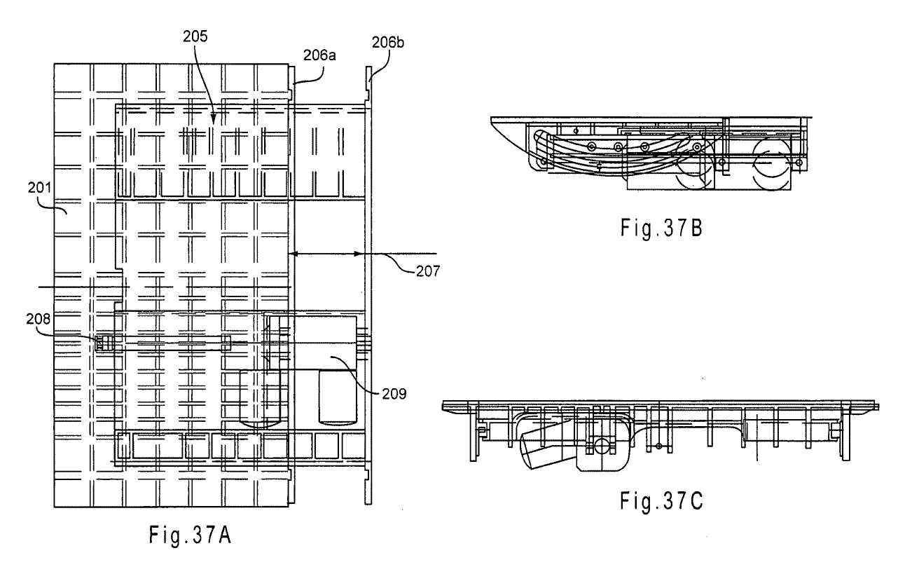

Referring now to FIGS. 37A-37C and 115, a seat extension member 205 for use with bed assembly 150 is shown. Seat extension member 205 is longitudinally movable with respect to the upper leg and buttock support 201 to thereby increase the effective longitudinal length of the upper leg support. In one embodiment, a linear actuator 209 effects movement of seat extension 205. Actuator 209 is rigidly affixed to buttock support 201 at joint 208, and comprises a telescoping member coupled to seat extension member 205 and configured to be advanced and retracted to move seat extension member 205 with respect to support 201. Seat extension member 205 may be moved between a first longitudinal position 206a and a second longitudinal position 206b, as indicated by arrow 207 in FIG. 37A. By using seat extension member 205, the effective longitudinal length of the upper leg support may be varied, thereby varying the length of support provided beneath a patient's knees. Specifically, in the first longitudinal position 206a, a user would receive minimal support beneath his or her knees, while in the second longitudinal position 206b, a user would receive an increased length of support beneath the knees, for example, to maintain flexion or to accommodate a user with longer legs. When frame 250 is extended and retracted, the seat extension 205 moves proportionally.

In the embodiment of bed assembly 150 of FIGS. 31-37 and 113-115, the operation is similar to the operation of bed assembly 20 described above. In particular, the support assembly 182 and docking station 40 are manipulated to control the height and angular position of the frame 152, and thereby the head or upper body portion of the bed. In one embodiment (not shown), an additional head segment can be made angularly adjustable relative to the frame 152. Moreover, a pair of arms is telescopically connected to the frame. The ends of the arms are connected to a cross-bar 50 engaged by the docking station. In another embodiment, the cross-bar 50 is connected to a centrally located support 205, forming a T-shaped support frame. In operation, the user can pull the frame 152 away from the docking station by way of the telescoping arms or central support 205. This can provide access to a caregiver or other persons (e.g. for maintenance or access to docking station), or room for equipment, etc. At the same time, the upper leg and buttock support 201 and lower leg support 199 can be controlled to provide a knee gatch and angular position of the foot support 170, as explained above.

Like bed assembly 20, alternative bed assembly 150 of FIGS. 31-37 and 113-117 may be placed in various positions. For example, such positions include upright seated, reclined seated, supine for examination, erect egress, Trendelenburg, and reverse Trendelenburg positions, as explained below with respect to FIGS. 30A-30F. Various other positions may be achieved. By way of example, in FIGS. 102-103 below, additional positions such as “Stow mode” and “Lateral Transfer mode” may be achieved by actuating the various components with respect to one another.

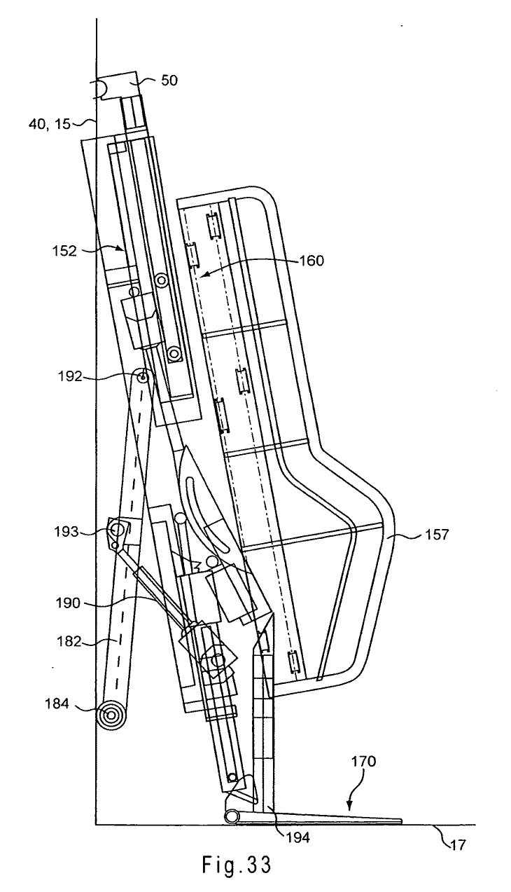

Further, bed assembly 150 may be placed in “Seated” and “Standing” positions, depicted in FIGS. 32-33, respectively. The “Standing” (otherwise referred to as erect egress) position of FIG. 33 may facilitate ingress and egress from bed assembly 150. More specifically, to facilitate ingress, a user may be positioned in a bent-knee or crouched position against support member 160, with his or her buttocks resting against support member 160. Referring to FIGS. 31-33, 113 and 114. A side rail 157 may be provided and grasped by the user for support. When the user is in the crouched position, it may be easier for the user to get into the bed, before the bed is rotated to a more horizontal position. Similarly, to facilitate egress of the patient out of the bed, the bed may be rotated from a more horizontal position to the “Standing” position of FIG. 33, and in the “Standing” position, the user may brace against and push off support member 160 and side rail 157 to walk away from the bed. In addition, the buttock shelf, or rear portion of the support member 160 keeps the patient from sliding down. The side rail 157 is connected to the frame 152 with a plurality (shown as three) parallelogram linkages 207, such that the rail can be rotated from an upright, patient securing position to stowage position, with the rail maintaining its vertical orientation throughout the transition as shown in FIG. 114. At least one of the linkages can be spring loaded, or provided with a lock or other actuator to secure the linkage in a desired position.

In one embodiment, the standing, or erect egress position, the upper body support surface forms an angle with the floor of between about 105° and 90°. In one embodiment, the lower body support, including the buttock support and upper and lower leg supports are substantially planar with the upper body support. In other embodiments, the knee gatch can be extended to provide a butt platform for supporting the user, with the lower leg support forming an angle with the floor of between about 75° and 105°. In the supine position, all of the support segments are substantially planar and horizontal, or forming an angle of about 180° relative to the floor.

### Additional Features

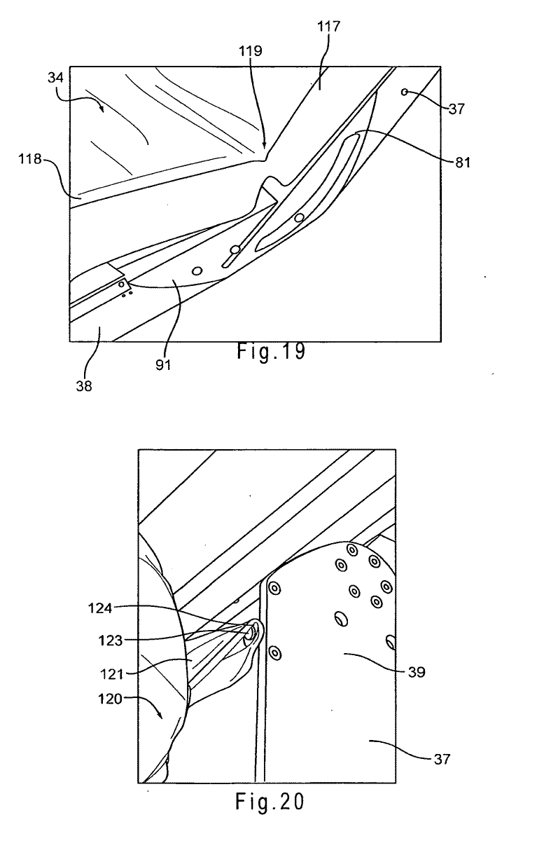

Referring now back to FIG. 19, various features of support member 34 are described. As noted above, support member 34 may be provided in the form of a resilient and flexible mattress that may articulate over the entire range of positions that bed 30 can assume. In one embodiment, support member 34 comprises a mattress having three layers. Preferably, the mattress comprises at least an upper, intermediate and lower layer. The upper layer is the most flexible layer to provide comfort for the patient, the lower layer is the least flexible layer to provide structural support for the mattress, and the intermediate layer comprises an intermediate resilience/flexibility. In one embodiment, a thin mattress, about six (6) inches in thickness is used. Despite its relative thinness, the mattress is soft to the touch. In one embodiment, a bottom layer is made of Ensolite® foam (closed cell), approximately one (1) inch thick. The foam is not very cushiony, but allows shear even when lightly loaded, such that the patient may move (e.g., wiggle or shift) without necessitating movement between the patient and mattress. A second, intermediate layer is made of high resiliency foam, approximately three (3) inches in thickness. An upper layer is made of viscoelastic polyurethane foam, 61b density and about two (2) inches thick. One suitable foam is a memory foam material. The layers are preferably bonded, for example with contact cement, so as to form a laminate structure. An outer cover, made of a stretchable fabric, is disposed over the mattress.

Support member 34 preferably further includes a first section 117 and a second section 118, which are separated at joint 119, as shown in FIG. 19. Joint 119 of support member 34 is disposed, for example, to underlie the virtual pivot joint between first segment 37 and second segment 38 of support structure 32. At joint 119, the intermediate and lower layers of support member 34 are separated, with only the upper layer of support member 34 extending through joint 119. This construction facilitates bending or flexion of the mattress in the vicinity of a patient's hip as the structural frame of bed 30 is rotated about the pivot point, which can help reduce tearing or bunching of the mattress.

Further, in the vicinity of a patient's knee, the intermediate and lower layers of support member 34 include layers of reduced thickness relative to the upper layer of the mattress. This enables the mattress to flex more readily as the knee gatch is raised and lowered, as described in FIGS. 17-18 above, and fit better under the knee of the user (e.g. patient) and the angled upper and lower legs. Further, support member 34 may be encased in a fitted sheet 120 (see FIG. 20) designed to extend inward in the vicinity of joint 119 to reduce the likelihood of the fitted sheet 120 tearing. It should be understood that the term “user” and “patient” refers to anyone using the bed, chair, room, etc., including a patient in a hospital room, as well as others who may use the bed, chair, room, etc. at long-term care facility, in the home, or wherever located. The term “caregiver” means any person attending to or accompanying the user, for example a nurse, doctor, family member, aide, administrator, transporter, medical worker, etc.

Referring now to FIG. 20, an upper region of fitted sheet 120 is shown disposed over the support member 34. The upper region of fitted sheet 120 includes two extending sheet portions 121, i.e., one extending sheet portion at the upper right portion of the fitted sheet, and one at the upper left portion. Each extending sheet portion 121 is detachably coupled to upper end 39 of the first segment 37. In one embodiment, extending sheet portions 121 have slits, whereby removable fasteners 123 are disposed through the slits and coupled to upper end 39 of first segment 37, thereby securing the upper regions of fitted sheet 120 to the first segment 37. Optionally, a washer 124 may be disposed between the head of fastener 123 and first segment 37 to reduce the likelihood of fitted sheet 120 slipping. The sheet may be alternatively secured with tabs, snaps, buttons, or other types of attachment devices. When extending sheet portions 121 are attached to first segment 37 in this manner, support member 34 will remain coupled to support structure 32 and will be less likely to fall forward during repositioning of bed assembly 30, or when the bed is moved to the vertical position. Preferably, fitted sheet 120 also is attached to second segment 38 of support structure 32 at one or more locations, thereby securing the lower end of fitted sheet 30 and support member 34 with respect to support structure 32.

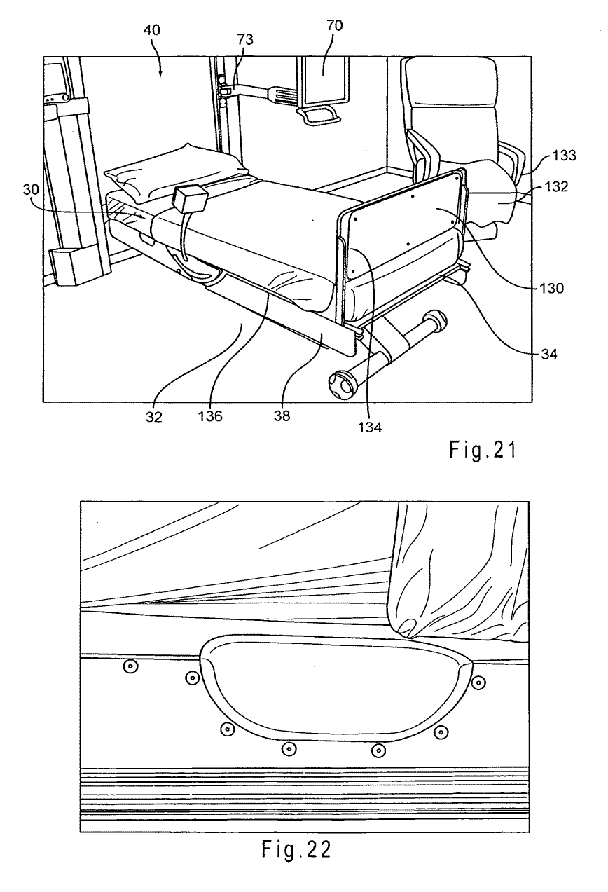

Referring now to FIG. 21, bed assembly 20 further includes adjustable footboard 130 coupled to the bed 30. Adjustable footboard 130 includes spaced apart, first and second support members 133 and 134. At least one support platform 132, including a cross-bar, is coupled between first and second support members 133 and 134 and extends transversely relative to support member 34, as shown in FIG. 21 (see also FIG. 8B, above). First and second support members 133 and 134 are coupled to longitudinally-extending tracks 136 formed in the second segment 38 of support structure 32, as shown in FIG. 8B and FIG. 21. In use, first and second vertical support members 133 and 134 are moved longitudinally within longitudinally-extending tracks 136, thereby adjusting the longitudinal position of footboard 130. The tracks can be configured as slides, e.g., with linear bearings. A detent, such as a spring loaded catch, can be configured to engage the slide to lock the foot board in a desired position. The foot board is preferably moved or adjusted manually, although an actuator could be provided to effect the longitudinal movement. The movement of footboard 130 over support member 34 adjusts the settings for a patient's height and/or preferred position. Engagement surface 132 also may provide a support surface upon which a reclined or seated patient may use his or her feet to restore or reset himself or herself by pushing to a more upright position if slipping down occurs. In addition, when the bed is an erect egress or buttock supported position, the platform provides a surface on which the patient can support his/her feet.

Referring now to FIG. 22, a side rail support suitable for use with bed 30 is described. Side rails are formed of plastic sheeting (not shown). The sheeting is recessed within the frame 152, such that the sheet can easily move between the frame and mattress even when the mattress is loaded. A hole is provided in the sheeting forms a grippable portion that is easily grasped due to the recess formed in the frame as shown in FIG. 22. To erect the side rails, the sheeting is grasped at the opening and pulled outward, with protrusions along the inner edge of the sheet engaging holes in the frame to secure the side rail in an upright position.

Docking station 40 preferably incorporates various other features and functionality. For example, in one embodiment, first and second vertical elements 42 and 44 include an exterior metal cladding that provides a space through which cables, gas lines and/or other utilities may be routed from wall 15 to various medical devices or outlets within the docking station, while providing for a cleaner aesthetic appearance. Further, one or more lighting fixtures may be recessed within docking station 40 to create a diffuse glow around the perimeter of the station. Additionally, at least one medical supply, including for example and without limitation a medical gas dispenser, IV rack, or other piece of equipment, may be coupled to the docking station and disposed in proximity to the user. For example, the medical supply or device may be coupled to docking station 40, for example, via an attachment mechanism coupled to first vertical element 42 and/or second vertical element 44.

Still further, in one embodiment, a video projection system is located in an interior space within the cross member 43 of docking station 40 and projected through an aperture 68 in the upper element 43. The video projection system displays projected images on a wall or other structure opposing docking station 40. Optionally, stereo-surround speakers may be incorporated within docking station 40, i.e., a left speaker may be disposed within second vertical element 44 while a right speaker may be disposed within first vertical element 42.

Referring now to FIG. 9, docking station 40 further preferably includes at least one slot shaped to receive a clamping member adapted for vertical movement within the slot. For example, in one embodiment, first and second vertical elements 42 and 44 include frontal surfaces 46 and 47, respectively, which are adapted to receive one or more rigid or slidable components, as shown in FIG. 2 above. For example, frontal surface 46 of first vertical element 42 comprises one or more vertical slots 66, within which clamp member 62 is slidably engaged. Clamp member 62 may be coupled to any piece of equipment, such as computer 60, monitor or graphical user interface, pump, diagnostic equipment, support shelf and so forth, for example, via one or more linkages 64 and a plurality of articulation points 63 and 65. The positioning of clamp member 62 with respect to first vertical element 42 may be vertically adjusted, and therefore, the height of the equipment module with respect to a patient may be adjusted. An actuator may be coupled to clamp member 62, such that the actuator provides a braking mechanism to selectively engage frontal surface 46 to permit and inhibit vertical movement of clamp member 62. In one embodiment, a lever, button or knob can be operated by hand, or manual adjustment, so as to tighten the clamp, e.g. with a camming action. In other embodiments, the clamp includes a set screw or fastener. For example, in one embodiment, a track with a T-shaped cross-section includes a nut slideably disposed therein, with the nut riding in the upper portion of the T-shape and having a width greater than the mount of the T-shape. A bolt passes through the mouth and threadably engages the nut, with a tightening of the bolt clamping the nut against the vertical element.

Alternatively, in addition to or in lieu of slidable clamp member 62, one or more fixed brackets may be affixed to the vertical element 42, e.g., using one or more fasteners. The fixed brackets may engage and support other devices to be attached to docking station 40, particularly heavier objects that may be too heavy to be slidably disposed within vertical slots 66 of frontal surface 46.

Still further, frontal surface 47 of second vertical element 44 may comprise one or more vertical slots, within which clamp member 72 is slidably engaged (see, e.g., FIG. 2). Clamp member 72 may be coupled to a touch screen monitor 70. As described in FIGS. 60-107 below, touch screen monitor 70 may be a graphical user interface portion of a communication portal through which a user may perform various room communication and entertainment functions.

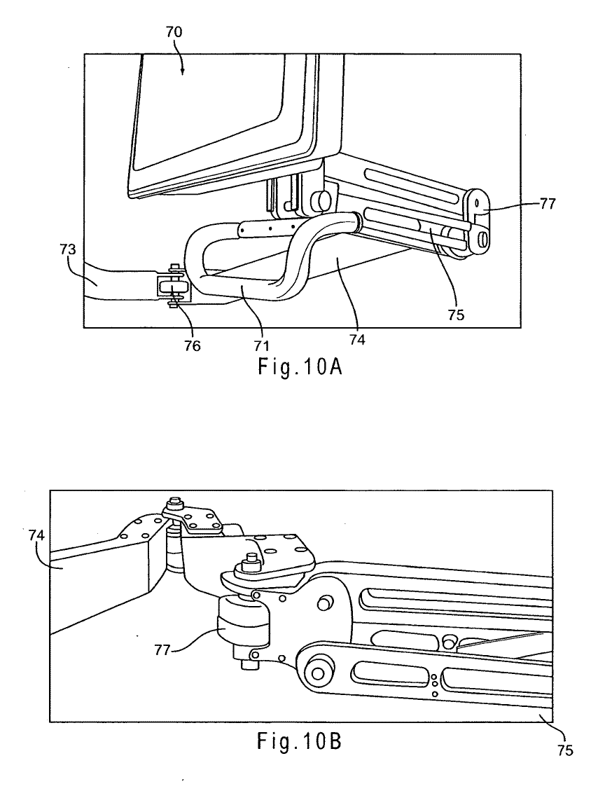

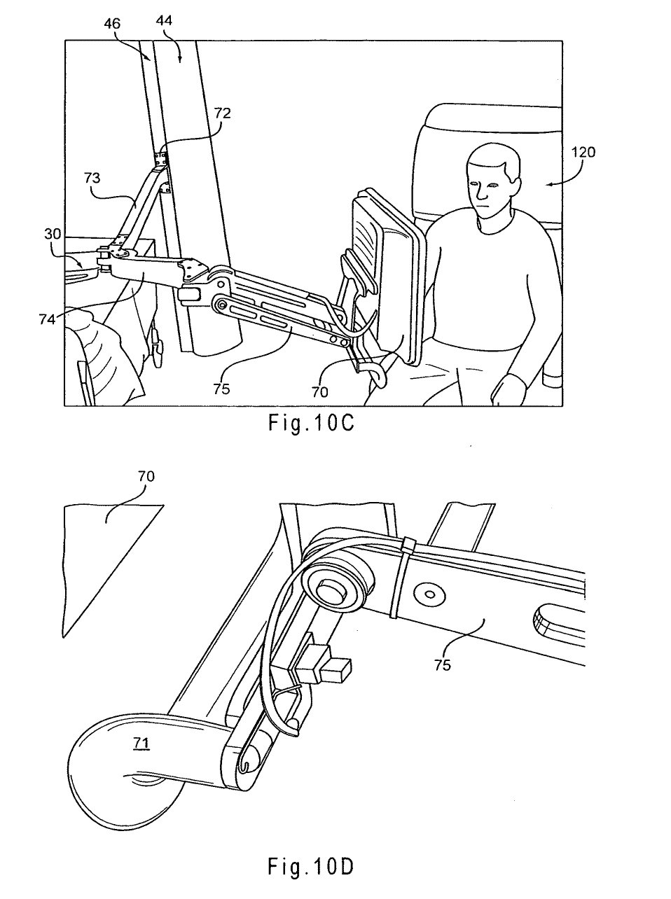

One or more linkages may be used to couple touch screen monitor 70 to clamp member 72, so that the positioning of touch screen monitor 70 may be adjusted vertically and angularly with respect to docking station 40. In one embodiment, touch screen monitor 70 is coupled to at least one arm having at least first and second segments and at least one braking mechanism coupled at a joint between the first and second segments to selectively permit adjustment of the first and second segments with respect to one another. For example, as shown in FIG. 10A, first segment 73, second segment 74, and third segment 75 may be provided. First, second and third segments 73-75 each comprise proximal and distal ends. The proximal end of first segment 73 is coupled to a fixed object, such as second vertical element 44 of docking station 40 (see FIG. 2 above). The proximal end of second segment 74 is coupled to the distal end of first segment 73 at articulation joint 76, as shown in FIG. 10A. The proximal end of the third segment 75 is coupled to the distal end of second segment 74 at articulation joint 77, as shown in FIGS. 10A-10B. Finally, the distal end of third segment 75 is coupled to touch screen monitor 70, as shown in FIG. 10A. The first and second segments are made, for example and without limitation, from rigid tubing. The third segment is formed as a parallelogram linkage. The first segment includes a downward bend from the proximal to the distal end (with the proximal end positioned higher than the distal end), with the second segment having an upward bend from the proximal to the distal end (with the distal end positioned higher than the proximal end). This lowers the middle portion of the overall linkage, thereby providing increased openness to the patient and reducing the sense of confinement.

In accordance with one aspect, first segment 73 is movable with respect to the fixed object and further movable with respect to second segment 74, while second segment 74 is movable with respect to the third segment 75, and the third segment 75 is movable with respect to touch screen monitor 70. Preferably, the segments are pivotable relative to each other about substantially vertical axes defined by the articulation joints. The articulation joints allow the linage to be articulated or moved in a horizontal plane. The parallelogram linkage of the third segment includes four pivots, and provides for vertical adjustment of the monitor, as well as tilt adjustment. The joint can also be provided with yaw and roll adjustment capability.

A grippable positioning handle 71 is coupled to third segment 75, as shown in FIG. 10A. A proximity sensor is configured to determine when a user engages positioning handle 71. One suitable sensor is a Qprox™ sensor, or capacitive touch sensor. Other suitable types of sensors are electrical field detection, force detection and/or thermal detection sensors. A relay is coupled to the sensor and cuts or provides power to a clutching or braking mechanism. An override switch is also provided to provide separate, alternative input in parallel with the sensor/relay. The sensor and relay are triggered when positioning handle 71 is engaged or gripped by the user. Power is supplied by a low voltage cable. At least one clutching or braking mechanism is coupled to the relay and further coupled to at least one of the segments 73-75 at the articulation joints. The mechanism is a solenoid brake configured with a friction pad and a clutch. A spring locks the joint, and when energized by the relay, a magnet retracts the spring to free the joint. In an alternative embodiment, the joints are free when the magnets are not energized, with the braking requiring energization. Actuation of the override switch also is configured to disengage the braking mechanism to enable movement of at least one of the segments 73-75 with respect to each other. For example, in one embodiment, a first clutch may be disposed between first segment 73 and the fixed object, a second clutch may be disposed between first segment 73 and second segment 74, and a third clutch may be disposed between second segment 74 and third segment 75 at the articulation joints, respectively. A fourth clutch can also be provided at one of the horizontal pivots of the parallelogram linkage of the third segment. Engagement of positioning handle 71 by a user disengages the braking mechanism to permit adjustment of the first and second arm segments 73 and 74 with respect to one another. Subsequently, disengagement of positioning handle 71 by the user causes the braking mechanisms to engage, thereby inhibiting further adjustment of first and second arm segments 73 and 74 with respect to one another. As will be apparent, activation also permits temporary movement of first segment 73 with respect to the fixed object, second segment 74 with respect to third segment 75, and/or movement of third segment 75 with respect to touch screen monitor 70 itself. Advantageously, this feature inhibits incidental movement of touch screen monitor 70 because it is necessary to engage positioning handle 71 in order to alter positioning of the monitor.

In accordance with another aspect, the ability to move touch screen monitor 70 using multiple adjustable segments 73-75 allows an increased range of motion, such that touch screen monitor 70 may be configured to cover a substantial range of motion throughout integrated patient room 10. For example, as shown in FIG. 3B, touch screen monitor 70 may be disposed in proximity to bed 30 to allow a patient on the bed access to the monitor. Subsequently, touch screen monitor 70 may be repositioned, for example, so that it is accessible to a user in chair 120, as shown in FIG. 10C. In a preferred embodiment, the monitor is accessible substantially to all parts of the patient room. For example, the monitor can be moved to a patient sitting in a chair located in each of the four corners of the room. In one embodiment, the monitor is accessible within an extended reach radius, for example 12 feet or less. The various functions that may be achieved through a communication portal, such as touch screen monitor 70, are described in further detail below with respect to FIGS. 60-107.

### Chair Features

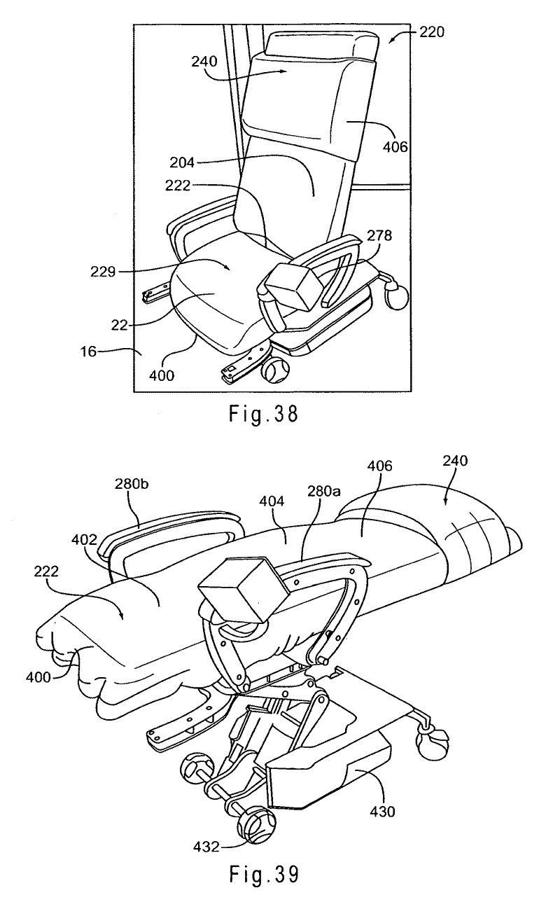

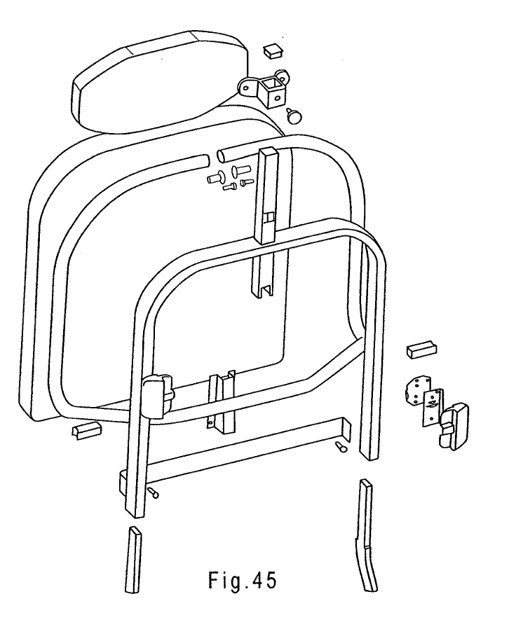

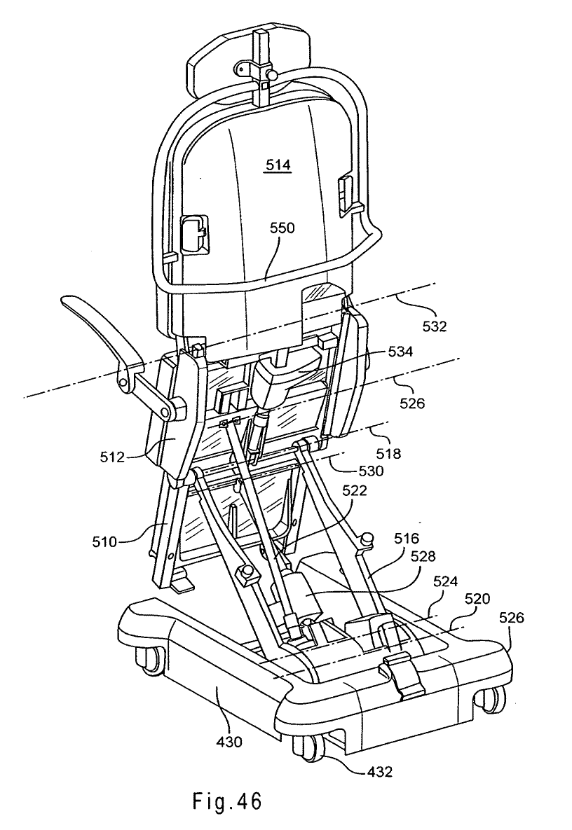

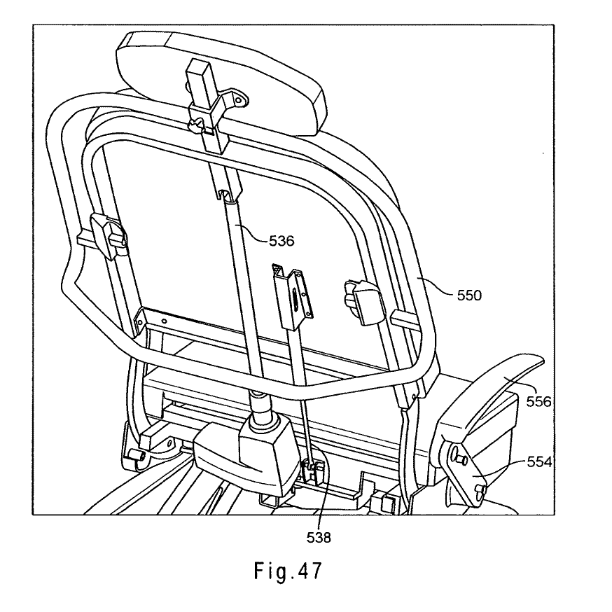

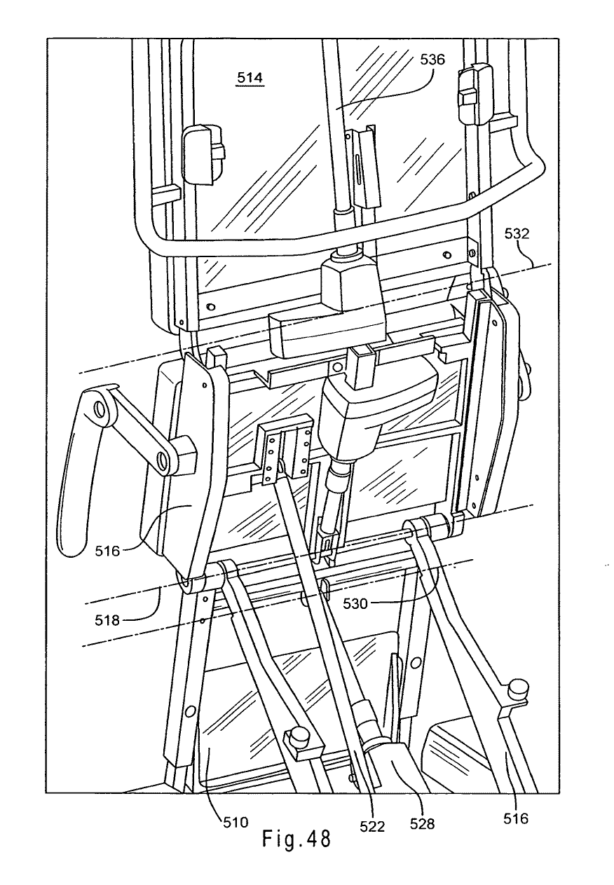

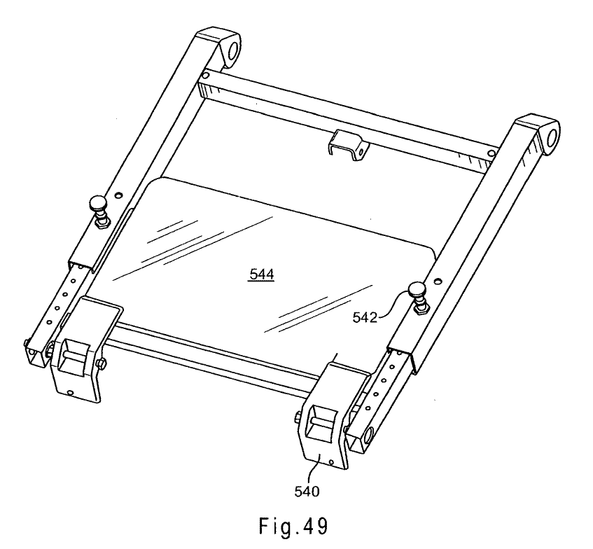

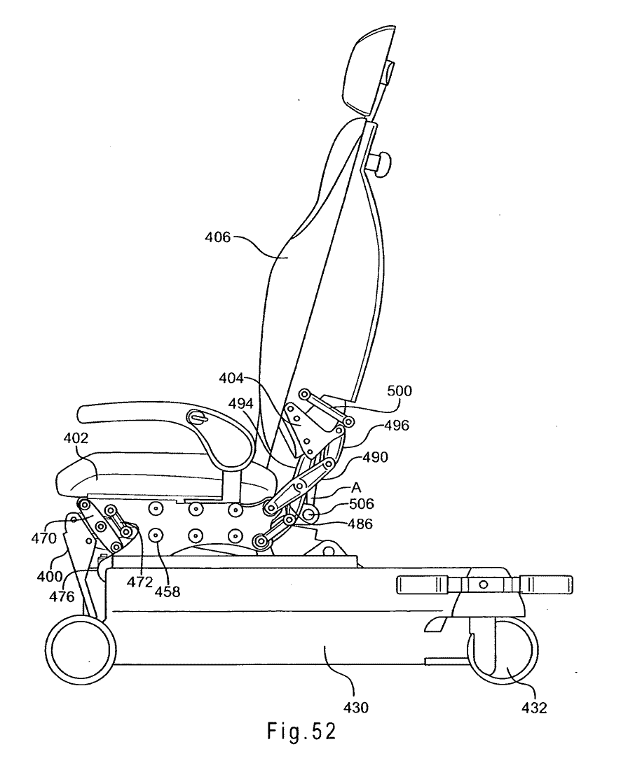

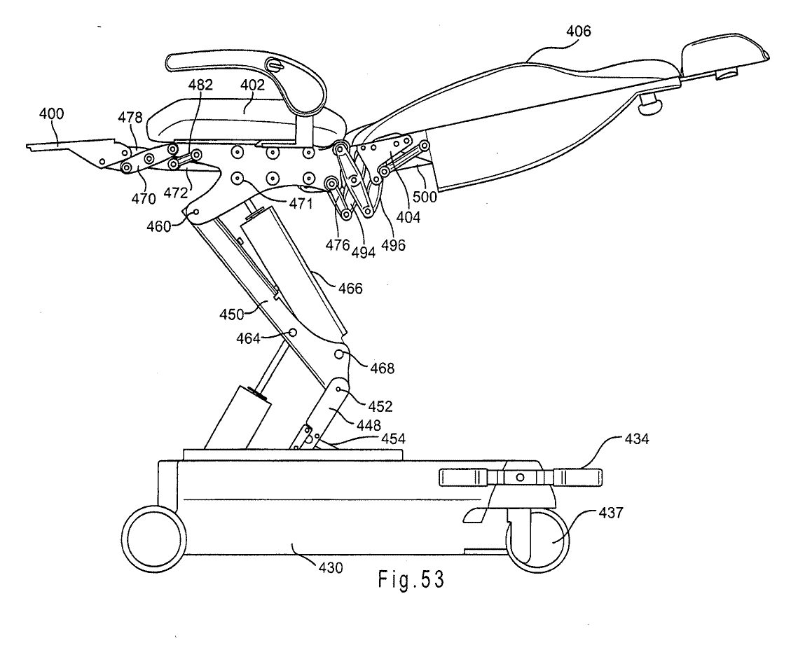

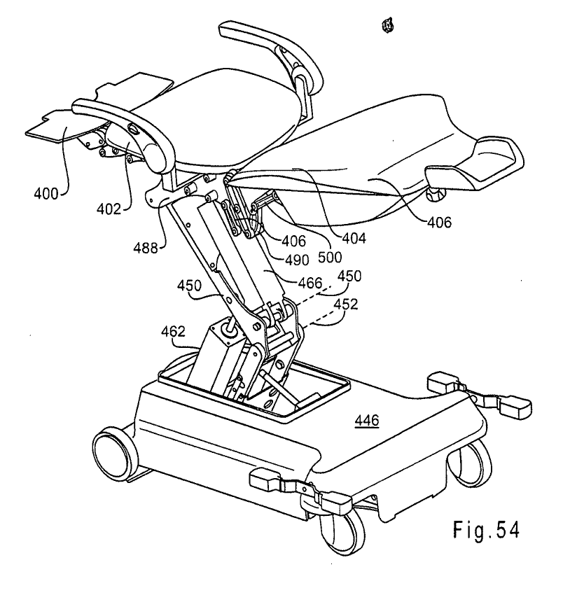

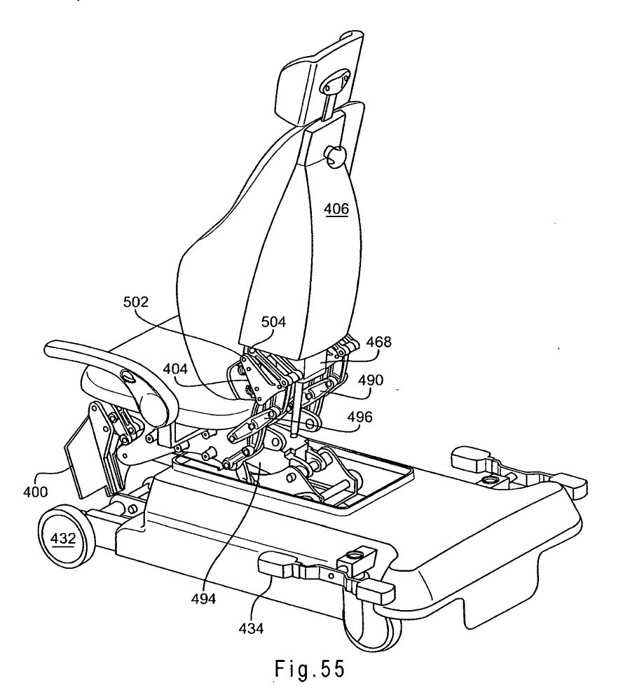

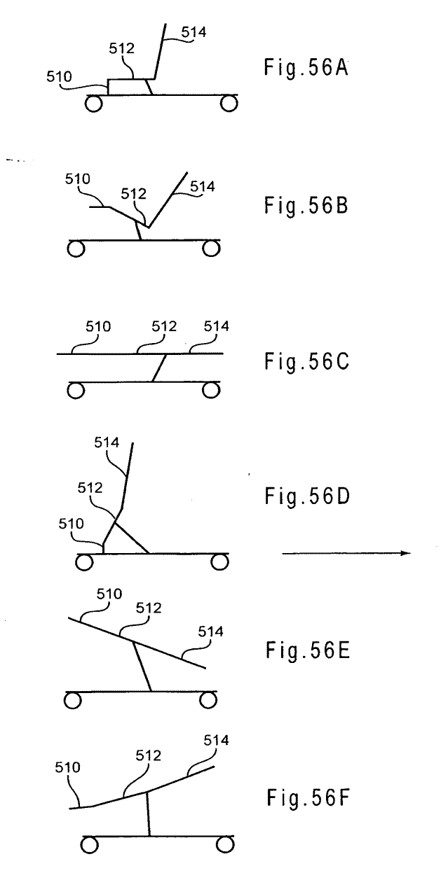

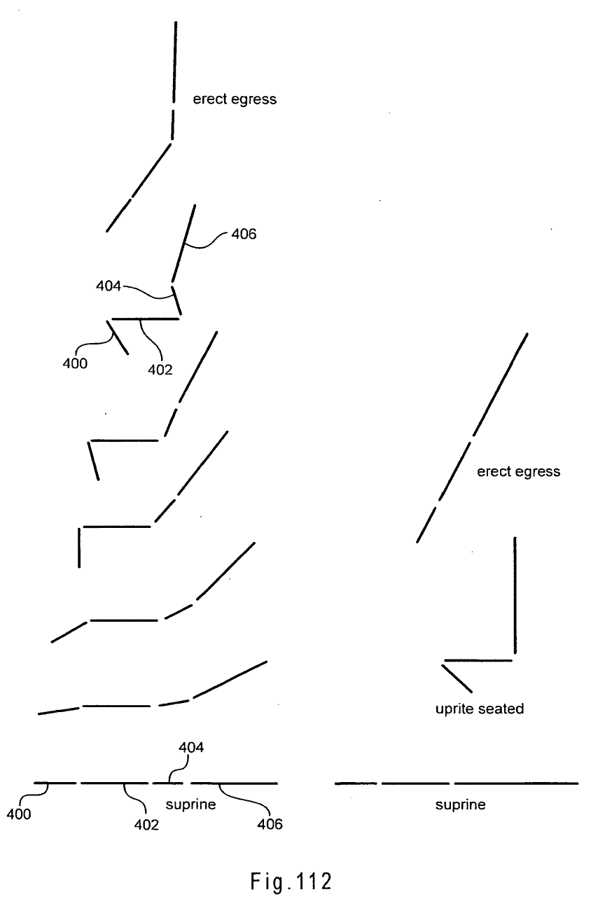

Referring now to FIGS. 38-58, chair 220 having a body member with support surface 222 for use in integrated patient room 10 includes at least one adjustable feature. For example, support member with support surface 222 is adjustable between a plurality of configurations including a sitting position, depicted in FIG. 38, a supine position, depicted in FIG. 39, a fully upright erect egress position, and other in-between positions as shown for example in FIGS. 56A-56F. Likewise, FIG. 112 shows the movements of the segments relative to each other as chair is moved from an erect egress position to a supine position. Chair 220 may be pre-programmed into any of these positions, e.g., by entering instructions into computer 278 or another suitable interface. In accordance with another aspect, as described further below, chair 220 may be adjustable in each of the supine, sitting and erect egress positions based on information associated with an individual using the chair.

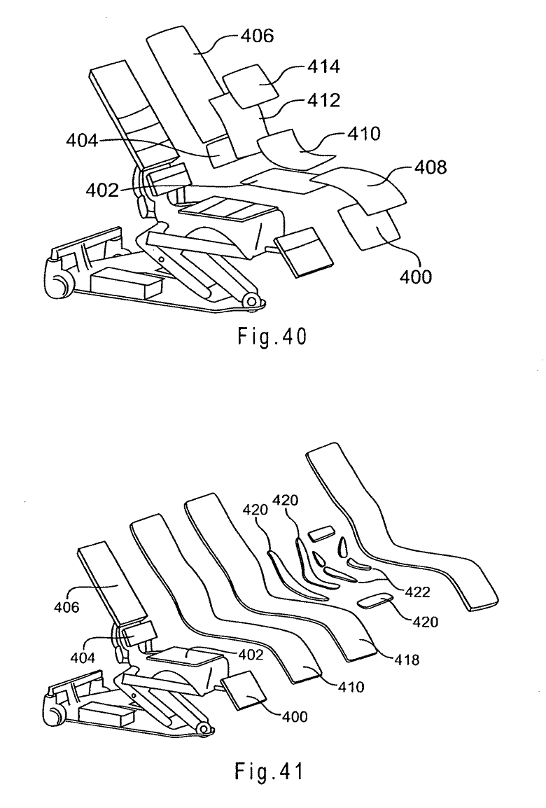

In one embodiment, as shown in FIGS. 40-41, support surface 222 of chair 220 further comprises multiple layers of material. The multiple layers are movable with respect to one another, for example, one layer may slide with respect to an adjacent layer, to provide continuous support to the patient through the range of motion of chair 220. In particular, in one embodiment, the chair includes a four support segments 400, 402, 404, 406 corresponding to the leg, seat, lower back and upper back portions of the user. These segments are connected to a linkage assembly that controls the relative movement therebetween and to a base. Each of the segments includes a platform, made for example of wood or plastic, which are further supported by a frame, as shown in FIG. 40. Four overlapping sheets 408, 410, 412 and 414, preferably polycarbonate, are positioned over the joints between the segment platforms. As the segments move relative to each other, the overlapping sheets 408, 410, 412, 414 slide relative to each other such that no gaps are formed between the platforms. Referring to FIG. 41, a first layer 416, for example and without limitation ½ inch Ensolite® foam, is disposed over the segment platforms and overlapping sheets. A second layer 418 of foam, for example ¾ inch HR (high resiliency) foam, is disposed over the first layer. Third and fourth layers 420, 422 of discrete pieces of foam, for example ¾ inch HR foam, are positioned on top of the second layer. The discrete pieces form various recesses shaped to receive the body of the user and increase the comfort of the seating surface. A lumbar support 424, for example 1 inch viscoelastic foam, is also positioned on top of the second layer. Finally, a fifth layer 426 of foam, for example 2 inch viscoelastic foam, is positioned over the lumbar support and third and fourth layers to complete the layered structure. The overlapping sheets 408, 410, 412, 414 prevent the foam layers from being caught in the gaps between the platforms. In addition, the overall layered structure provides continuous support for the user over a wide range of positions without overstretching the material of any one layer.

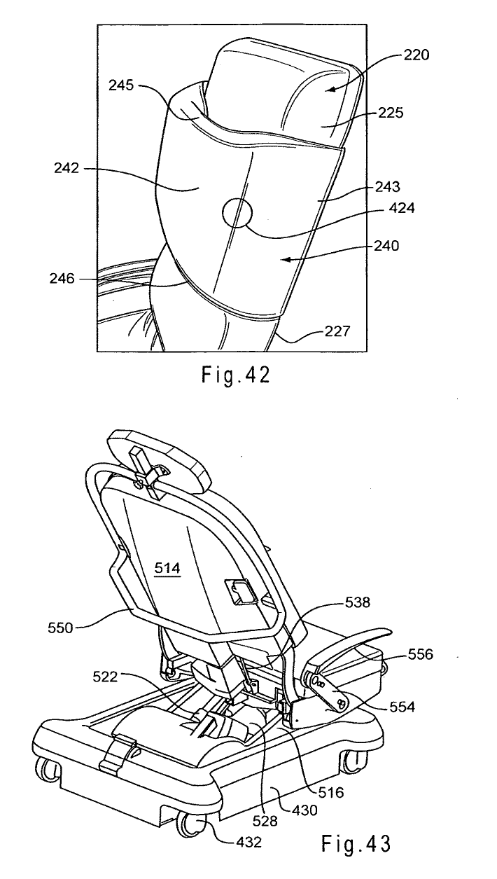

Referring now to FIG. 42, a cervical support and headrest 240, for use in conjunction with chair 220, is described. Cervical support and headrest 240 comprises a front portion 242, rear portion 243, and further comprises upper and lower surfaces 245 and 246, respectively. Front portion 242 transitions into rear portion 243, which extends around rear surface 227 of chair 220.

Cervical support and headrest 240 is configured to be disposed about an upper surface 225 of chair 220 and is adapted for adjustability with respect to upper surface 225 of chair 220 when the chair is in any of the plurality of configurations, e.g., supine, seated, and so forth. Cervical support and headrest 240 is held in place by the tension of the front and rear portions 242 and 243 pressing against upper surface 225 of chair 220, as depicted in FIG. 42. Further, the positioning of cervical support and headrest 240 may be adjusted vertically with respect to upper surface 225 of chair 220 by manually pulling or pushing the headrest to the preferred height.

In one embodiment, front portion 242 is configured with two layers, preferably foam. The front layer of front portion 242 comprises a three-dimensional contoured shape including a centralized recess shaped to receive a patient's head, which nests within the front layer, while also providing proper cervical support through the entire range of reclining motion. The rear layer of front portion 242 may comprise a rectangular section having flat sides providing separation from chair 220.

Further, focused speakers 424 may be integrated into a portion of cervical support and headrest 240. Such speakers may direct sound to the patient's ears, but may remain substantially inaudible to others. The speakers may transmit entertainment such as music, provide sound-related therapeutic benefits such as relaxation recordings, and transmit sounds for other purposes.

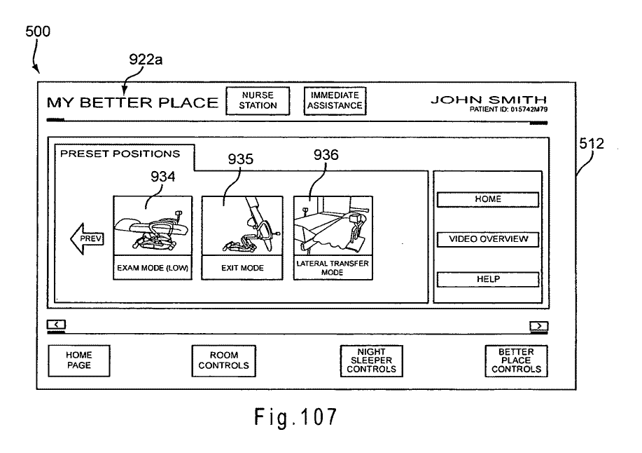

In use, chair 220 may be moved into various pre-set positions, for example, through the use of a touch-screen interface 278 or a remote user interface. Chair 220 may be preprogrammed based on information pertaining to a patient, caregiver, or other user. Without limitation, the programmable positions may include upright seated (high and low), reclined seated, supine for examination (high or low), erect egress, Trendelenburg, and reverse Trendelenburg as shown in FIGS. 56A-56F. Various other positions may be achieved. By way of example, in FIGS. 106-107 below, additional positions such as “Reclined mode” and “Lateral Transfer mode” may be achieved by actuating the various components with respect to one another. In the erect egress position, the back segment forms an angle of between about 90° and 60° (more preferably between about 90° and 70°) relative to the horizontal plane (assuming the X-axis is 0°), and the seat segment forms an angle of between about 90° and 45° (more preferably between about 90° and 60°) relative to the horizontal plane. In one embodiment, the back preferably forms an angle relative to the horizontal plane greater than or equal to the angle formed by the seat relative to the horizontal plane, such that the angle between the support surfaces of the back and seat is less than 180°. In the supine position, the back segment is preferably parallel to, or forms an angle of 180° relative to, the horizontal plane.

Chair 220 also may comprise multiple modes of operation, for example, the chair may include swivel and rocking functionality. The rocking is achieved by actuation of all actuators, with the possible exception of the leg extension. The actuators beneath the seat work in a coordinated manner, but preferably with the head position substantially fixed so as to minimize nausea. The specific rocking motion is part of the general customized motion/positioning behavior of the chair. A lookup table indexed by the user's height and weight is referenced. The table proscribes motion parameters, e.g. rocking frequency, amplitude, etc. The swivel feature can be configured as a fifth wheel or point on which the support structure pivots, or by driving the wheels to rotate the chair about a vertical axis.

In accordance with one aspect, chair 220 is further adjustable in each of the aforementioned positions based on information associated with an individual using the chair. Therefore, if a first patient using the chair is 6-feet tall, then information associated with that user, such as height, weight, and other variables, may be programmed into a memory coupled to computer 278 or a remote computer. In one embodiment, chair 220 may obtain the information associated with a first patient using a radio frequency identification tag coupled to the user, by extracting the data from patient records stored in a database coupled to chair 220 or remotely thereto, by manual input into computer 278, or using other data gathering techniques,

Therefore, when chair 220 is moved into a preprogrammed position, such as the seated position shown in FIG. 38, the chair further may be adjustable in that position based on a parameter such as the height of the patient. By way of example, if the first patient using the chair is 6-feet tall and the seated position is requested, then the height of seated portion 229 from floor 16 (see FIG. 38) may be selected to provide a comfortable sitting position for a 6-foot tall user. If computer 278 obtains information that the user is only 5-feet tall, then the height of seated portion 229 from floor 16 may be lower.

Still further, when chair 220 is moved into a preprogrammed position based upon at least one piece of information associated with the first patient, the patient and/or caregiver may further fine-tune the positioning of the chair. For example, using the graphical user interface of computer 278, a user may fine-tune the seat height of the chair, desired recline, and so forth, even when the chair has already been put into a desired position based upon the user's information. The fine-tuned positional preference then may be saved for future reference, such that the fine-tuned position may be achieved simply by pressing a single button.

In a further embodiment, the pre-set positioning may be calibrated for both patients and/or caregivers. A calibration table in the firmware may be provided to select the appropriate pre-set position, based on input to the system. For example, in the supine-for-examination position, the appropriate height of the chair with respect to the floor may be selected based on the height of the caregiver, e.g., using radio frequency identification tags, bar codes, manual input, and so forth. The appropriately calibrated pre-set height of the chair may be any height below the high and low extremes of chair 220.

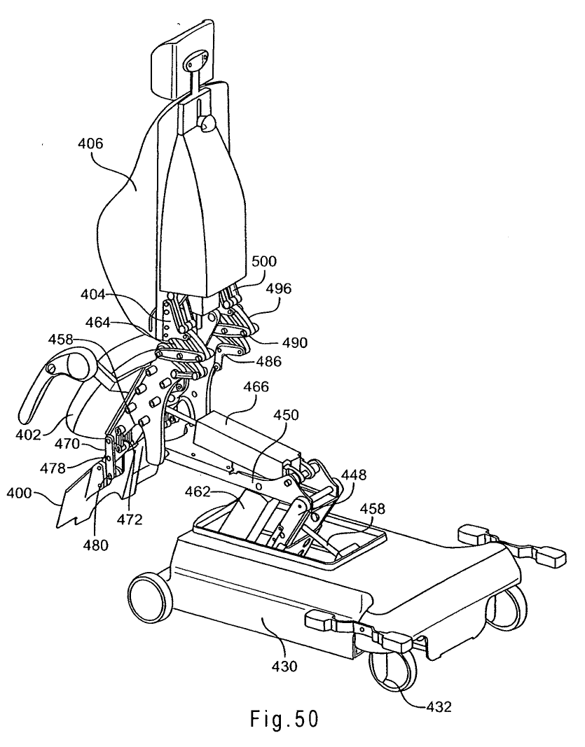

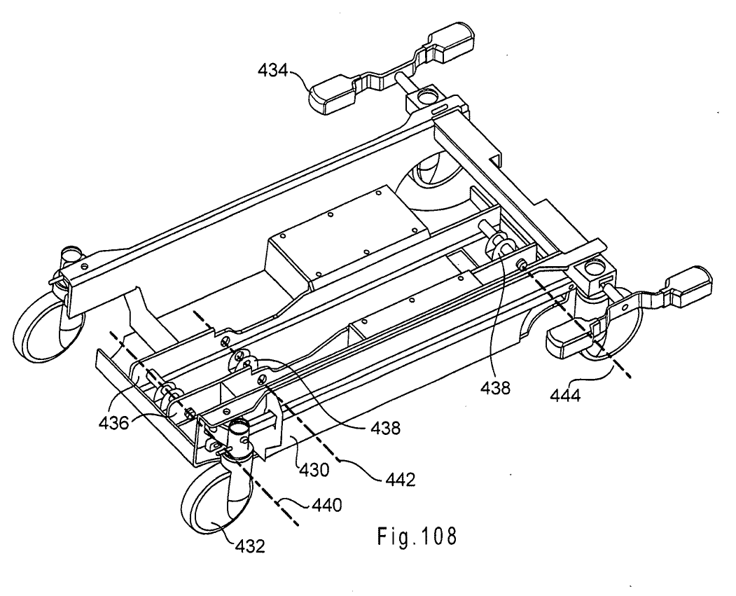

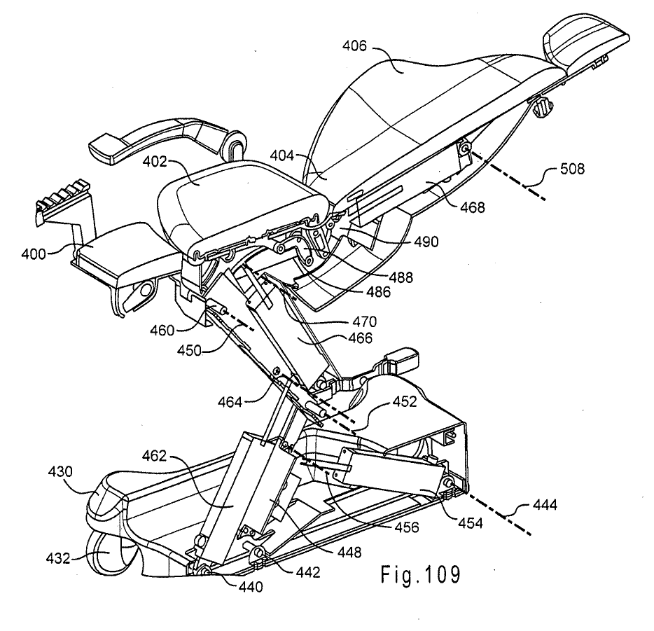

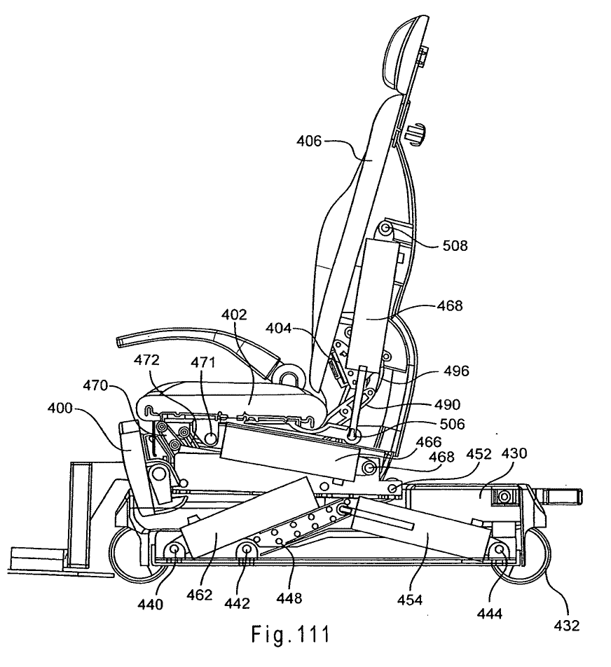

Referring now to FIGS. 50-55 and 108-112, various seat segments of a chair, as well as actuation mechanisms for effecting movement of the seat segments to achieve a wide range of positions of the chair, are described. Referring to FIG. 108, a base 430 includes a frame supported by a plurality of wheels, preferably each having a vertical and horizontal axis of rotation. A brake or locking mechanism 434 can be provided for at least one of the wheels, and preferably for at least two wheels and in one embodiment all four wheels. The frame includes lugs 438 or walls 436 defining three horizontal and laterally extending pivot axes 440, 442, 444 spaced apart along the longitudinal direction. Batteries, computers, electronic control elements, weights, and other utilities can be affixed to or stored in the base 430. As shown in FIG. 50, a cover 446 can be secured over the base, while providing an opening through which the linkage mechanism/assembly can extend. The actuators also can be configured to be powered from an AC electrical source by way of a converter. The batteries allow the chair to be portable while permitting powered adjustability.

The linkage mechanism/assembly includes a first link 448 having a first end pivotally coupled to the base 430 at pivot axis 442. A second link 450 has as first end pivotally connected to a second end of the first link 448 at a laterally extending horizontal axis 452. A first actuator 454 has a first end pivotally connected to the base at pivot axis 444, with a second telescoping end pivotally connected to the first link 448 at a pivot axis 456 positioned between the pivot axes 452, 442. It should be understood that the actuators, as referred to herein, are preferably programmable, linear servo actuators, e.g., electromechanical actuators, although pneumatic and hydraulic linear actuators can also be employed. Alternatively, rotary actuators can be employed at each pivot joint between connected links, or such movement can be obtained by the selective inflation/deflation by on-board blowers or a series of stacked bladders that drive the shape, position and articulation of the device, and in some embodiments in conjunction with an internal and/or external rigid structure.

The second link 450 has a second end pivotally connected to a Y-shaped frame 458 portion of the seat segment 402 about a pivot axis 460. A second actuator 462, preferably a linear servo actuator, has a first end pivotally connected to the base at pivot axis 440, and a second end pivotally connected to the second link 450 at a pivot axis 464 between the pivot axes. A third actuator 466, preferably a linear servo actuator, has a first end pivotally connected to the second link at a pivot axis 468, and a second end pivotally connected to the seat segment at a pivot axis 471. In operation, the first, second and third actuators 454, 462 and 466, through extension and retraction, control the position of the seat segment 402, both in terms of height and angle, by rotating the first link 448, second link 450 and seat frame 458 relative to each other.

The movement of the remaining leg, lower back and upper back segments 400, 404, 406 are controlled by a fourth actuator 468, through extension and retraction, together with the linkage mechanism. It should be understood that the reference herein to various links can refer to a single link positioned for example along the centerline of the chair, or to links positioned on one side of the chair or otherwise offset from the centerline of the chair, with identical links provided on the opposite side thereof or matched therewith in pairs to increase the stability of the assembly.

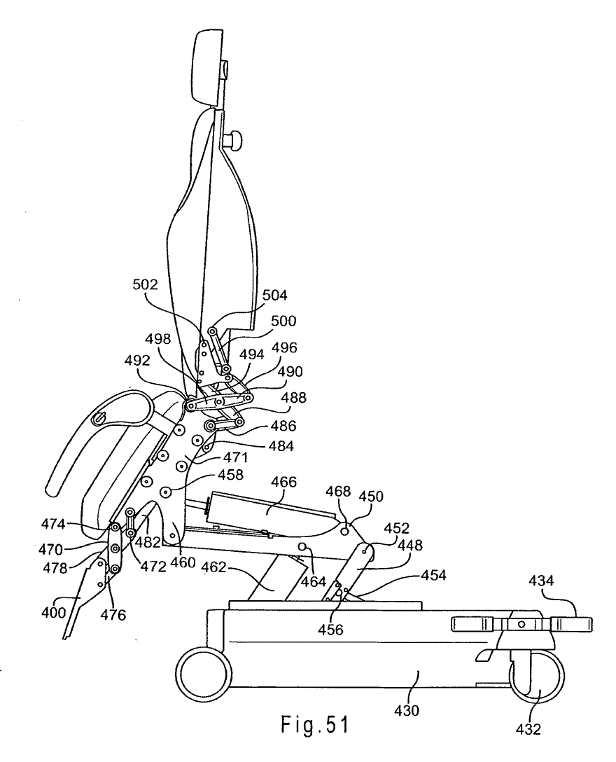

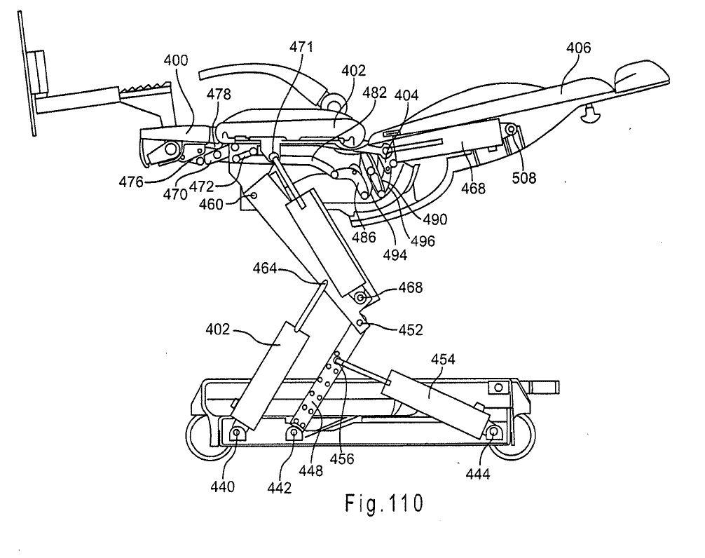

With reference to FIG. 51 and FIG. 110, a pair of links 470, 472 defining a parallelogram, are pivotally connected to a front end portion of the seat segment, and in particular to an upper arm 474 of the Y-shaped frame 458. A second pair of links 476, 478 defining a second parallelogram are connected to opposite ends of the first pair of links 470, 472. The opposite ends of the second pair of links 476, 478 are pivotally connected to the leg segment 400, and in particular a frame portion thereof. In addition, the longer link 470 is rotatably connected to the longer link 478 of the second pair about horizontal pivot axis 480. A fifth link 482 has a first end pivotally connected to the 472, and a second end pivotally connected to a first arm 484 of an L or Y-shaped link 486. The link 486 is connected to the seat segment frame, with a second arm 488 thereof extending rearwardly/downwardly. The second arm 488 forms a parallelogram with a link 490 pivotally connected to the seat frame at a spaced apart, horizontal pivot axis 492. A pair of links 494, 496, forming a parallelogram, are pivotally connected to the lower back segment 404, or a frame portion thereof, with the longer links 490, 494 of each parallelogram being rotatably connected at a pivot axis 498. The upper back segment 406, or frame thereof, is pivotally connected to the lower back segment 404 and to a link 500 about spaced apart pivot axes 502, 504. The fourth linear actuator 468 has a first end pivotally connected to the seat segment frame 458 at pivot axis 506 and an opposite second end pivotally connected to the upper back 406 at pivot axis 508. An adjustable headrest is secured to an upper portion of the upper back segment 406.

In operation, the fourth linear actuator 468 and linkage mechanism controls the position of the upper back 406, lower back 404 and leg 400 segments. In particular, as the upper back 406 is moved relative to the base from a supine position to an upright position, the linkage mechanism automatically moves the leg segment 400 from a substantially parallel position relative to the seat segment 402 to an oblique position relative to the seat segment 402 as shown in FIG. 112. At the same time, the lower back 404 is automatically moved from a substantially parallel position relative to the upper back 406 in the supine position to a concave oblique angular position to another parallel position and finally to a convex oblique angular position relative to the upper back 406 in the upright seated position. In this way, the lower back 404 initially lags the upper back 406 but then surpasses the angular position thereof relative to the seat 402 during this transition.

As can be appreciated, the relative positions of the upper back, lower back, seat and leg segments as shown in the various positions of FIG. 112 can also be raised and lowered, or rotated by way of actuation of the three actuators 454, 462 and 466. For example, as shown in FIG. 51, the actuators and linage mechanism/assembly can be maintained in the supine position, or two positions up therefrom as shown in FIG. 112, with the seat segment then being rotated so as to achieve an erect egress position. The seat segment 402 can be maintained obliquely to a vertical plane so as to provide a shelf or support for the user's buttock as they exit the chair, or if they need to rest or fall back on the chair while exiting. In addition, the linkage assembly provides for the seat 402 and lower back 404 segments to move relative to each other about a virtual hip pivot axis, which minimizes shear during the movement of the chair. In operation, and relative to the ground (i.e., a supine position is at 0 degrees), the four segments can be adjusted between 80 and 110 degrees, with the upper segments generally greater than 90 degrees and the lower segments generally less than 90 degrees. The angle between adjacent segments is between 165 and 180 degrees, with the angle between the upper and lower back segments being substantially 180 degrees in the supine position.

The linkage mechanism is preferably configured so as to maintain the user's center of gravity between the front and rear wheels, although counterbalance weights can also be provided in the base to prevent tipping when the chair is an erect egress position. In addition, the linkages can be configured to prevent the top of the upper back from moving beyond a predetermined position relative to an adjacent end of the base, such that the upper back does not bump into an adjacent wall or other object as it reclines, providing a “wall saver” feature. It should be appreciated that all such movements and articulations can alternatively be achieved by employing a system of stacked and/or parallel bladders that are selectively inflated/deflated by an on-board blower.

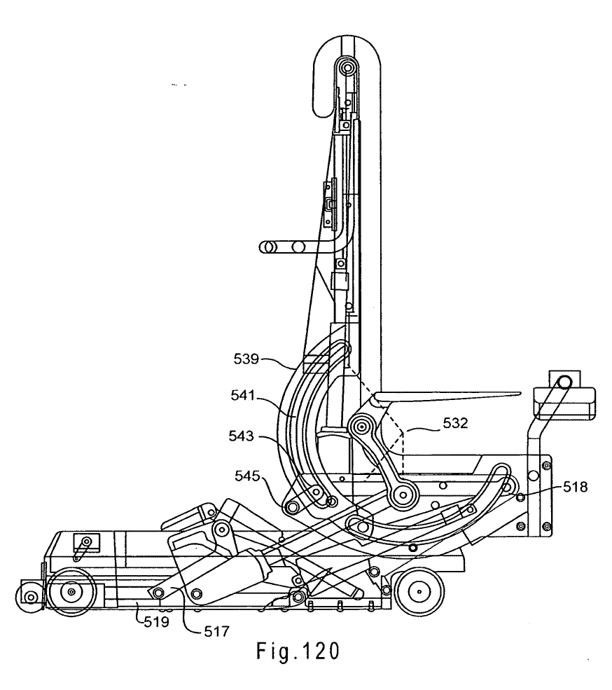

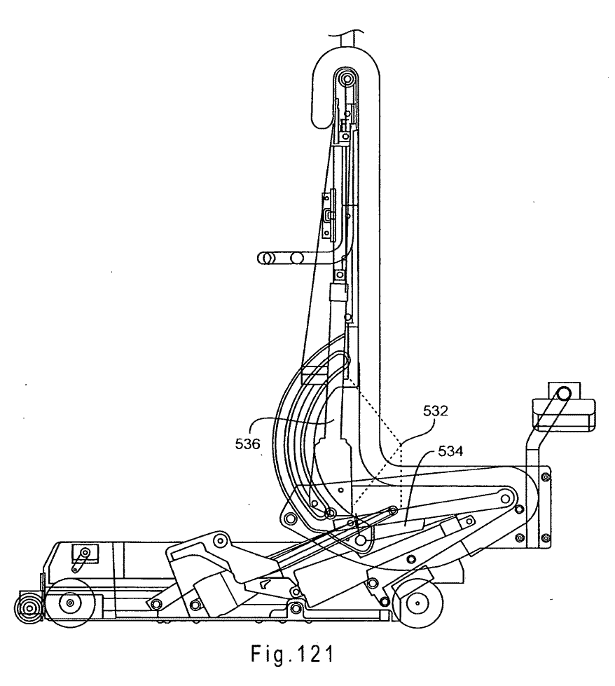

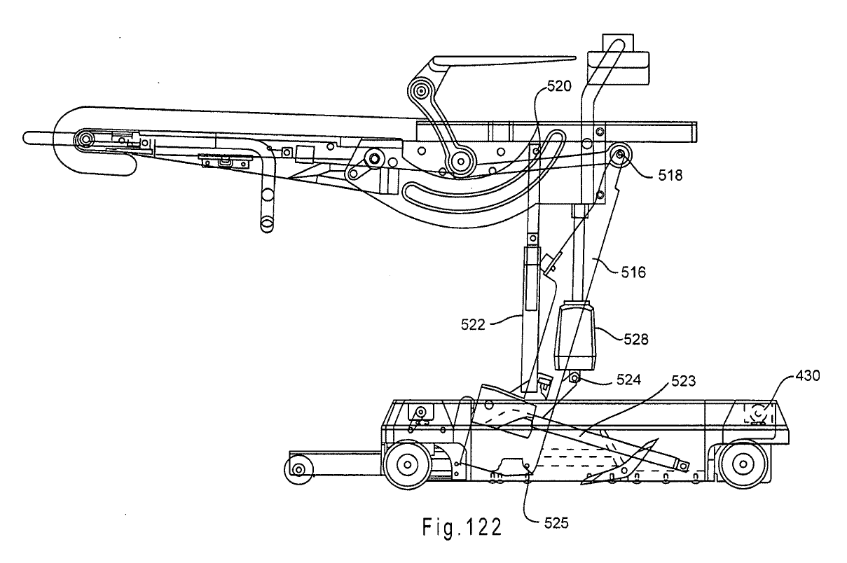

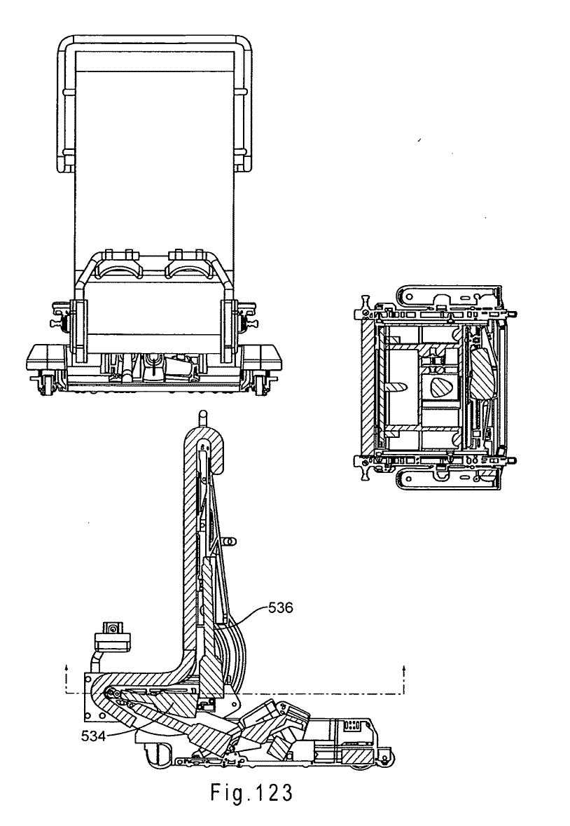

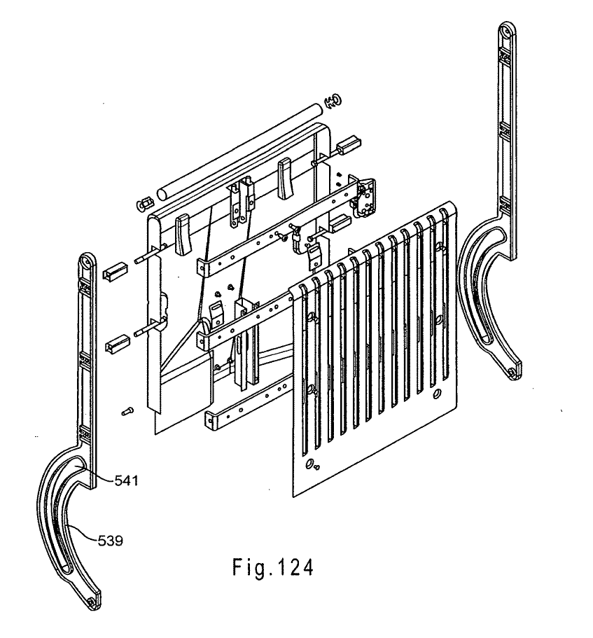

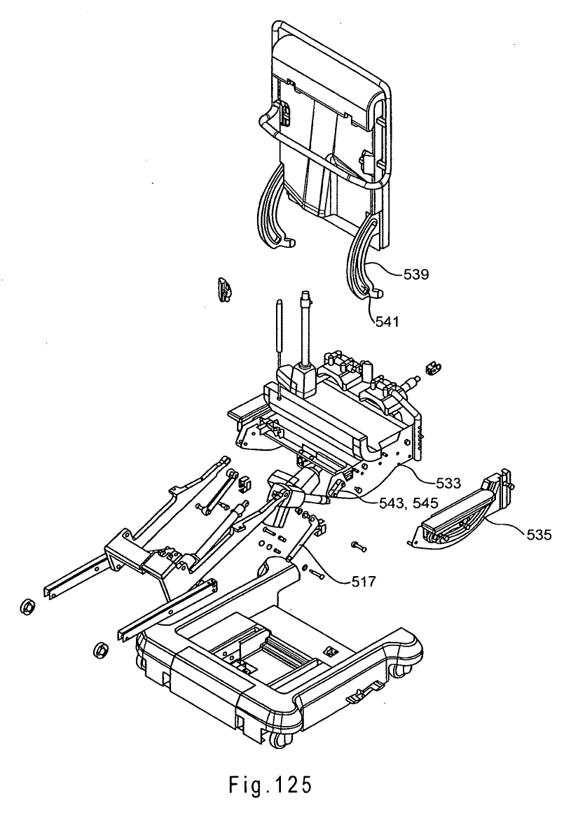

Referring now to FIGS. 43-49 and 118-126, another embodiment of the chair is shown, as well as actuation mechanisms for effecting movement of the seat segments to achieve a wide range of positions of chair 220 as shown in FIGS. 56A-56F, are described. In this embodiment, the chair includes a leg segment 510, a seat segment 512 and a back segment 514. Each of a pair of first links 516 is pivotally connected to a base 430 at horizontal pivot axis 520 and pivotally connected to the seat segment 512 about pivot axis 518. An L-shaped link 517 pivotally connects each of the first links 516 and the base 430, with a lower end of the link 517 sliding along a horizontal track 519 formed in the base. A first actuator 528 has a first end pivotally connected to the link 516 or the base at pivot axis 524 and a second end pivotally connected to the leg segment 510 at a pivot axis 530 offset from the pivot axis 518. As such, extension and retraction of the actuator 528 causes the leg segment 510 to rotate relative to the seat segment 512.

A second actuator 523 is pivotally connected to the base and the links 516. Extension and retraction of the actuator 523 causes the links 516 to rotate about the axis 520.

A third actuator 522 is pivotally connected to the base at pivot axis 525 and to the seat at pivot axis 526. Extension and retraction of the actuator 522 causes the seat 512 to rotate about axis 518 relative to the base 430.

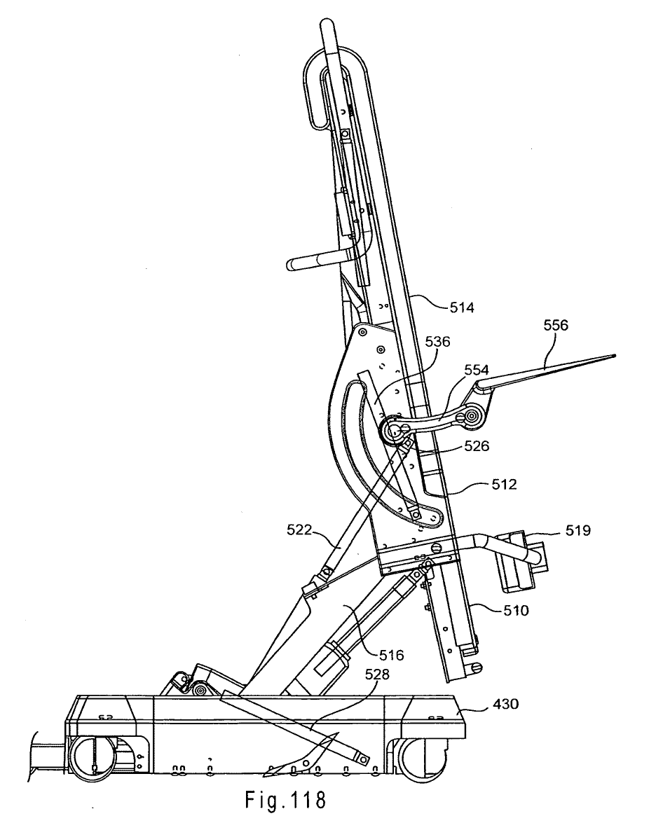

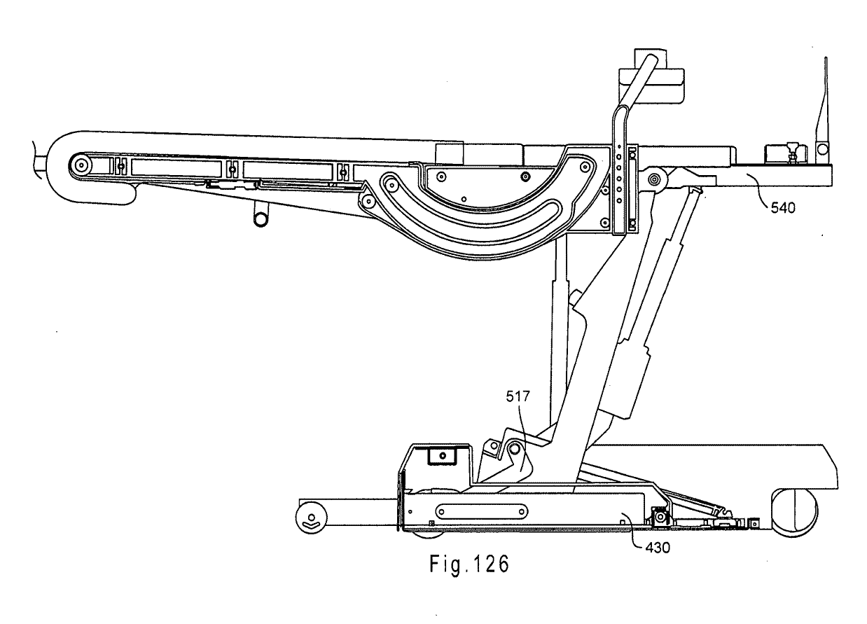

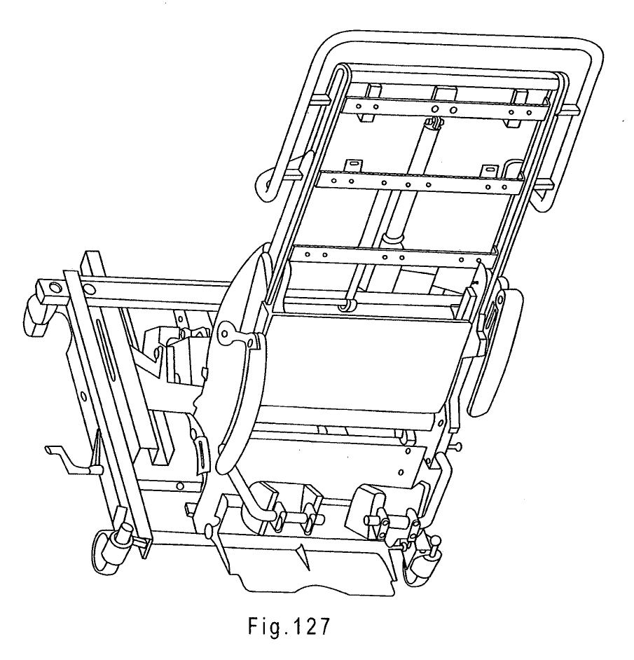

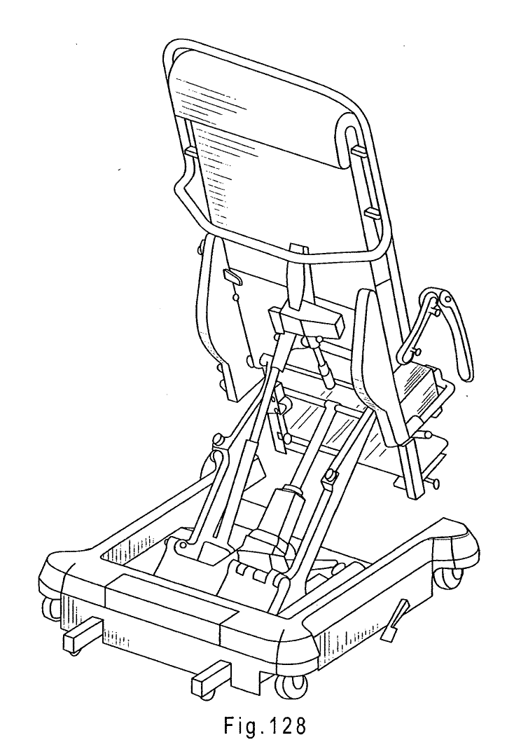

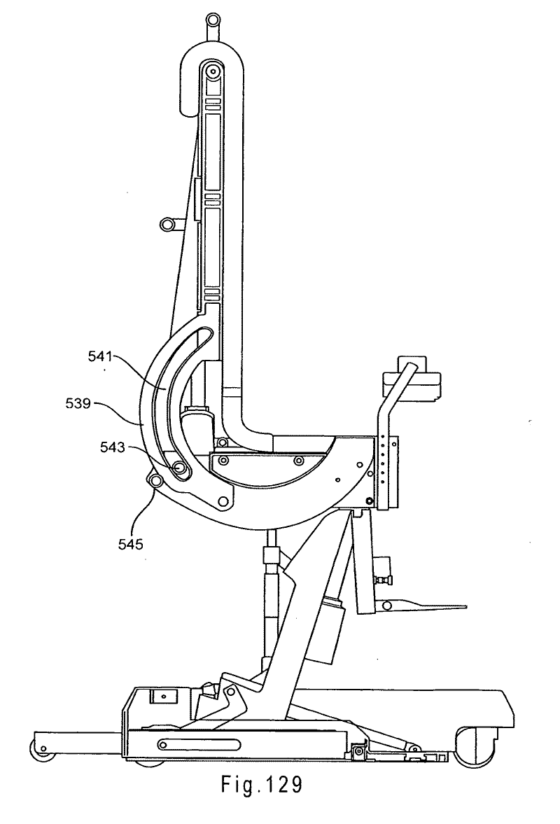

The back segment 514 is pivotally connected to the seat segment 512 about horizontal, virtual pivot axis 532. The pivoting action is provided by a circular track joint similar to that of the bed described above. The pivot axis 532 is positioned above the seat and in front of the back proximate the hip joint of the user. As shown in FIGS. 118 and 124-126, a seat base 533 has a pair of side supports 535 secured thereto. Each side support 535 has a recess with a curved track formed therein. The back segment includes a curved arm portions 539 with a corresponding curvature, with the arm portion having a curved slot 541 formed therein and an distal end. A roller 543 is received in the slot with another roller 545 supporting a bottom curved surface of the arm. As shown in FIGS. 126 and 129, the arms of the back segment rotate relative to the side supports 535, for example as the back segment rotates relative to the seat segment.

A fourth actuator 534 lengthens the seat for larger or smaller patients. Actuator 536 is pivotally connected to the back, causing the back 514 to rotate relative to the seat 512. A damper 538 is connected between the back and seat to resist rotation of the back, for example to cushion any sudden (e.g., backward) motions resulting from the release of the quick release actuator 536, which allows for rapid supine positioning in case of cardiac arrest etc. A pair of armrests 552 include a first and second arm portion 554, 556, both of which are rotatable relative to each other and to the seat 512. The armrest is rotatable downward to provide access for examination in the chair (e.g., supine examination in an exam-table mode), or for bed-to-chair/chair-to-bed transfers in the supine position, and upwardly to a handrail position to provide support for the patient during egress (standing position).

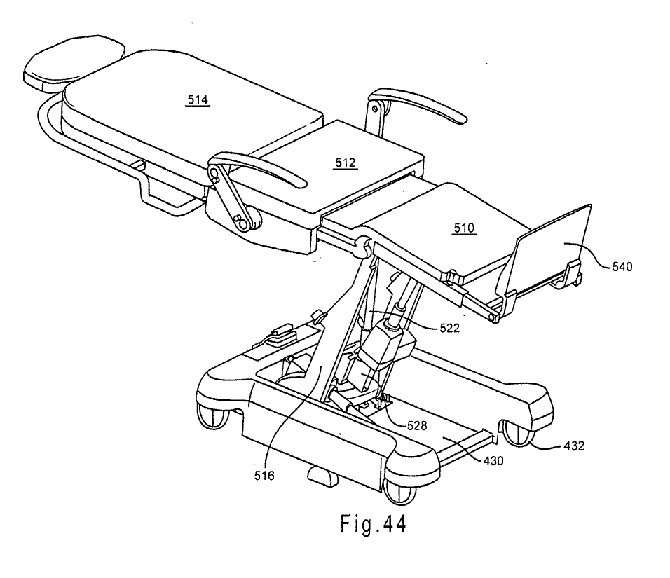

Referring to FIGS. 44, 49, 126 and 129, a foot rest 540 is removably secured to the leg segment 510. The foot rest is adjustably connected to the frame of the leg segment with a pair of locking pins 542, such that the longitudinal depth of the foot support can adjusted to a plurality of positions defined by openings in the foot support frame. The adjustable foot rest includes a platform, configured with a cushion, to support the lower legs of the user.

A pair of leg braces 549 are height-adjustable secured to the seat segment, and can be adjusted to provide different depths for receiving the patient's legs and holding them in the chair.

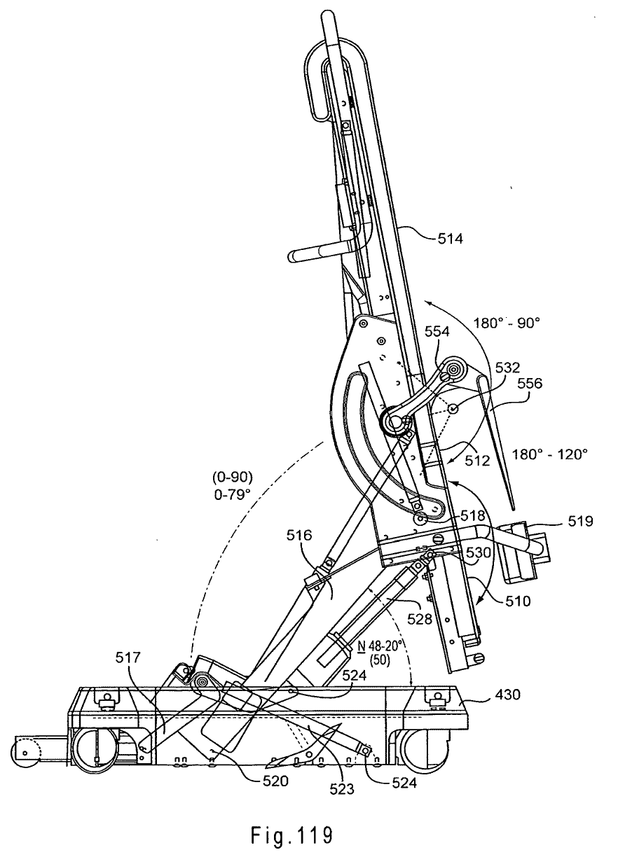

Referring to FIG. 119, the actuators can be moved such that the back segment 514 is rotated between about 90° (upright seated position) and 180° (supine and erect, egress positions). The leg segment 510 is movable relative to the seat segment between about 300° (upright seated) and 180° (supine and erect egress position). The seat segment 512 is movable relative to the horizontal plane (e.g., floor) between about 0° degrees (supine) and 79° (erect egress), although the segment can be moved to about 90° relative to the floor in some embodiments. The chair can also be raised or lowered when in the upright seated position or supine positions to different vertical heights. In addition, the arms can be manipulated between stored and upright positions as desired by the patient or caregiver.

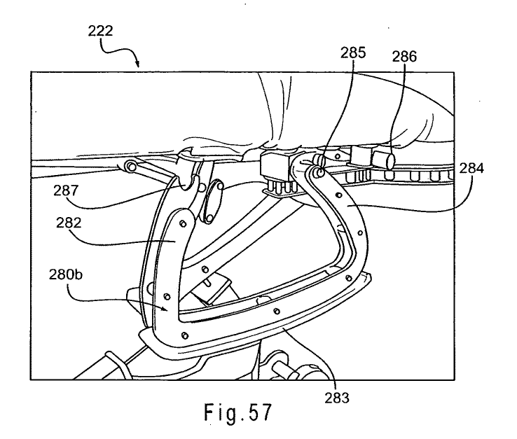

Referring now to FIG. 57, at least one adjustable armrest is moveably connected to chair 220. In one embodiment, chair 220 includes first and second armrests 280a and 280b (see FIG. 39 above). Armrests 280a and 280b are configured to inhibit lateral movement of the patient over a side of the chair in a first position and to provide a resting platform for the user's arms. At the same time, the adjustable armrests 280a and/or 280b can be moved, for example by pivoting, to a second position when side access to the patient is needed.

Armrests 280a and 280b each include first arm portion 282 shaped as an arc, a second arm portion 284 shaped as an arc and a middle portion defining an upper support surface 283 disposed therebetween, as shown in FIG. 57. Armrests 280a and 280b further may be coupled to chair 220 using at least one fixed bolt 285 and at least one releasable pin 286. In the first position, upper surface 283 of armrests 280a and 280b is disposed at least partially above an upper surface of support surface 222 of chair 220, as shown in FIG. 39. Further, in the first position, detachable hook portion 287 of first end 282 is engaged with releasable pin 286. If it is desired to access the patient from the side or facilitate egress of the patient or transport the patient, then armrests 280a and/or 280b may be moved from the first position to the second position, as shown in FIG. 57. In the second position, upper surface 283 of armrests 280a and 280b may be disposed entirely or substantially entirely below the upper surface of support surface 222 of chair 220.

In order to switch between the first and second positions, a knob coupled to releasable pin 286 is engaged to release detachable hook portion 287 of armrests 280a and 280b. Then, armrests 280a and 280b are pivoted around their respective pivot axes 285, thereby circumferentially rotating detachable hook portions 287 about 180 degrees around fixed bolts 285 and moving upper surfaces 283 between the upraised first position and the downward-facing second position, as shown in FIG. 57.

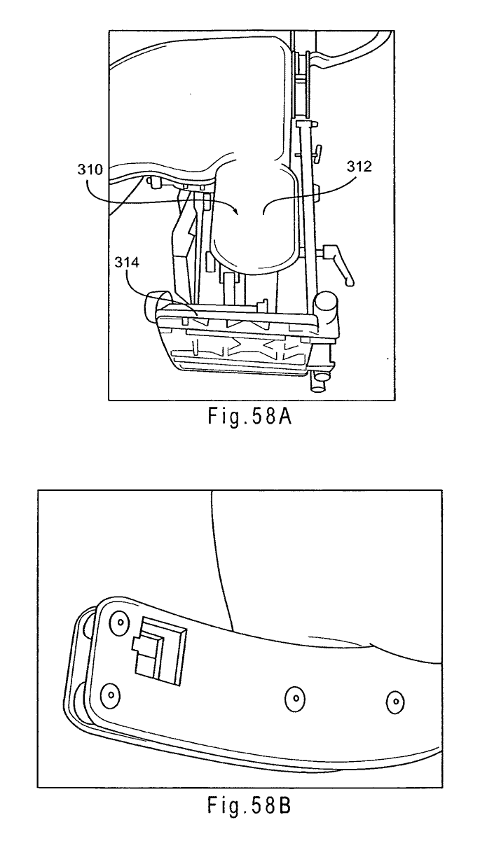

Referring now to FIG. 58A-58B and 110, a lower leg and foot support is shown. The foot support is connected to the leg segment. In one embodiment, the foot support can be adjusted longitudinally with respect to the leg segment to accommodate users of different leg heights. In one embodiment, the footrest is a conventional footrest used with a wheelchair. The footrest slides into square holes defined by a receptacle shown in FIG. 58B.

### Synchronization Between Bed, Chair or Other Components

In accordance with one aspect, a system for transferring a patient is provided. The to system may comprise bed 30 and a second support structure, such as chair 220. Both bed 30 and chair 220 are adjustable between a plurality of configurations and are configured to be pre-programmed into at least one of the plurality of configurations, for example, using communication portal 500 described below. A programmable operating system, explained with respect to computer system 502 below, is configured to synchronize a first configuration of bed 30 with a first configuration of chair 220 to facilitate transfer of a patient between bed 30 and chair 220. As will be apparent, any two pieces of furniture within patient room 10 may be synchronized, in lieu of bed 30 and/or chair 220.

In one embodiment, computer system 502 may be provided with instructions to synchronize bed 30 with chair 220, such that both the bed and the chair are placed in supine positions at the same height with respect to the floor. Such supine bed and chair positions are depicted in FIG. 30C and FIG. 56C, respectively. In this embodiment, instructions may be stored in computer system 502 that cause bed 30 and chair 220 to both simultaneously and automatically achieve the synchronized supine positions, for example, when a button on graphical user interface 512 is pushed.

In an alternative embodiment, computer system 502 may be provided with instructions to synchronize bed 30 with chair 220, such that bed 30 is provided in an erect egress position, depicted in FIG. 30D and explained in FIG. 33 above, and chair 220 is provided in an upright seated position depicted in FIG. 56A, or egress position shown in FIG. 56 D. When the bed is in a erect egress position, a user may be crouched or standing, and may be readily transferred into the synchronized chair. Such a transfer is similar to, but much easier than, transferring a user from a bed into a wheelchair. In this embodiment, instructions are stored in computer system 502 that cause bed 30 and chair 220 to both simultaneously and automatically achieve their synchronized positions.

In a further alternative embodiment, computer system 502 may be provided with instructions to synchronize bed 30 with chair 220, such that bed 30 is provided in a seated position, depicted in FIG. 30A, and chair 220 is provided in a seated position, with the various corresponding segments of the bed and chair, or planes defined thereby, being at the same angular inclination. For example, both the bed and chair can be automatically moved by the computer to “upright” seated positions or “reclined” seated positions. When both the bed and the chair are in synchronized seated positions, e.g., at the same height/angular inclinations and an appropriate distance apart, it will facilitate transfer of a patient. As above, instructions are stored in computer system 502 that cause bed 30 and chair 220 to both simultaneously and automatically achieve their synchronized positions depending on the input from the user.

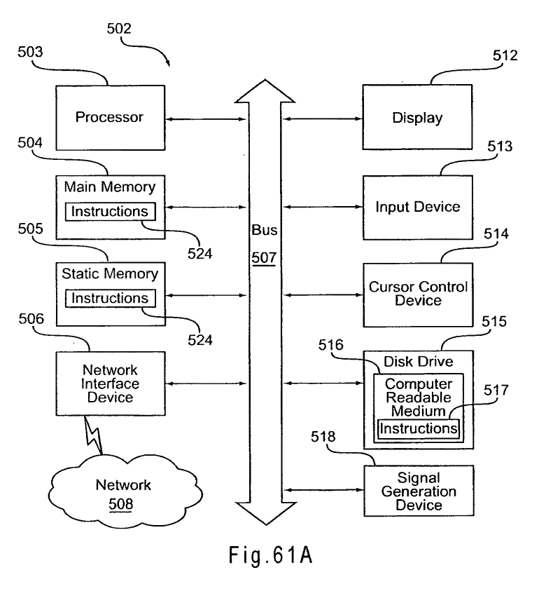

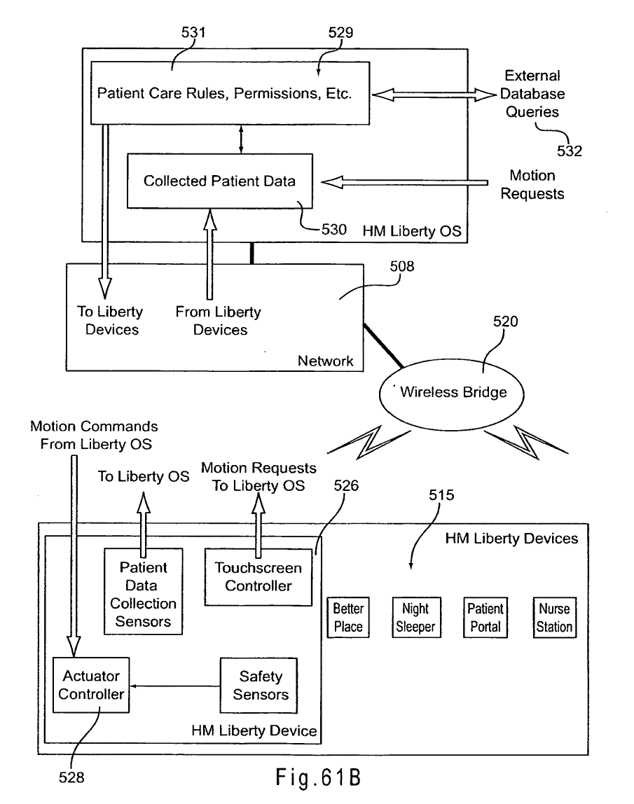

The above combinations are a few examples of automatically synchronized positions achievable between bed 30 and chair 220. Various other synchronized positions are possible that facilitate a transfer of the patient between the bed and the chair, or vice versa. Further, as noted above, a patient may be transferred by synchronizing the bed and/or chair with one or more other components in patient room 10. The automatic synchronization may be initiated using an input device 513 coupled to communication portal 500, as explained in FIGS. 60-61 below, thereby providing instructions to the various actuators to achieve the preprogrammed positions noted above. The chair and bed also can be individually moved/controlled, for example to permit erect egress, stowage etc. For example, the patient/caregiver can manipulate the chair to provide rocking, erect egress (e.g., when using the lavatory), supine (sleep or examination mode), upright or reclined sitting, etc.

### Overhead Utility Center

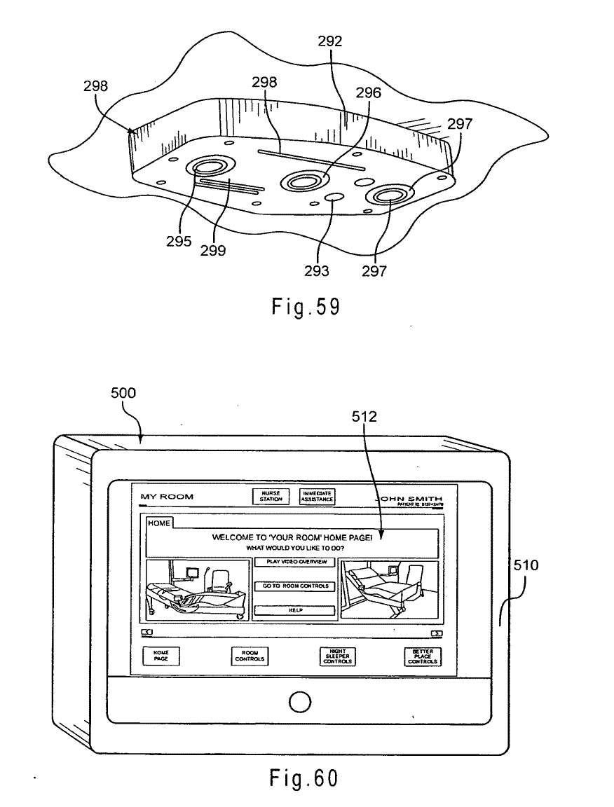

Referring now to FIG. 59, a wireless control system for use with one more components in patient room 10 is described. Wireless control system 290 comprises ceiling-mounted utility center 292, which may comprise at least one surveillance camera 293, at least one halogen lighting element 295-297, at least one ambient lighting element 298-299, and one or more data transmitting ports.

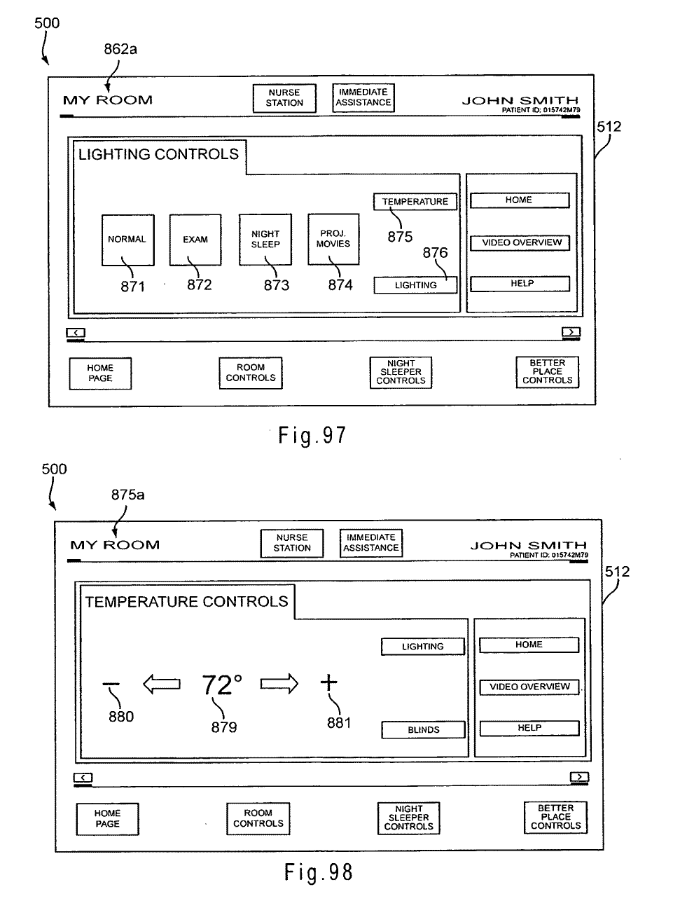

Halogen lighting elements 295-297 may be turned on and off, and the intensity of the lighting may be varied, through instructions programmed into a communication portal, such as touch screen monitor 70 or another suitable interface, as explained in FIG. 97 below. Halogen lighting elements 295-297 may be controlled by a physician to obtain a lighting level needed to conduct an examination of a patient residing on bed 20. Further, halogen lighting elements 295-297 may be controlled by a patient to support desired activities, such as reading, watching television, and so forth.

Similarly, ambient lighting elements 298-299 are provided, and may comprise independent strips of light emitting diodes (LEDs) that provide sufficient room illumination for entry by a physician or caregiver while a patient is sleeping. While blue LEDs are preferred, any color may be employed.

In use, a nurse or other authorized person may remotely monitor a patient through surveillance camera 293, and if desired, may send a series of instructions to the communication portal, as explained below with respect to FIGS. 61A-61B. For example, a radiofrequency or infrared signal may be remotely provided to cause computer system 502 to move chair 220 into the requested position, as explained below, particularly with respect to FIGS. 61A-61B. This enables chair 220 to be repositioned remotely and without the need to run a wire or cable to the source of the instruction signals. Such remote and/or wireless positioning of chair 220 also may be used in coordinating the synchronization of chair 220 with another piece of furniture in patient room 10, such as bed 20, to facilitate transfer of a patient, as explained in further detail above.

### Operating System

As noted above, it may be desirable for a patient and/or caregiver to actuate various room functions from one or more convenient portals within patient room 10. Preferably, patient room 10 employs a user-friendly approach that allows a patient and/or caregiver to control most room and device functions. For example, a touch screen monitor 70 (as shown in FIG. 4) with an intuitive graphical user interface may be employed as a communication portal. Similar portals can be associated with or coupled to chair 220, for example, computer 278, as shown in FIG. 38. Still additional portals may be provided, for example, a handheld portable device or portals mounted on one or more walls. The various room devices, such as bed assembly 20 and chair 220, as well as room controls such as lighting, and communications mediums such as e-mail, preferably are accessed and/or controlled through the communication portal, as explained in further detail below.

Referring now to FIGS. 60-107, an example of such a communication portal is described. In FIG. 60, communication portal 500 comprises a monitor 510 having a graphical user interface 512 that is configured to display information, as explain further below. Monitor 510 may be the same as touch screen monitor 70, which is described in FIG. 4 above, or may be a different device disposed in another region of patient room 10.

Communication portal 500 is the connecting point between the patient, the devices within patient room 10, such as bed assembly 20 and chair 220, and external information sources. Through the graphical user interface 512, a patient or caregiver may control devices within the patient room, such as the position of bed assembly 20, or the light levels within the room. Further, communication portal 500 is a conduit whereby a variety of clinical information may be accessed or added to by a care provider, patient alerts may be initiated, entertainment may be selected by the patient, and so forth. Of course, the portal also provides access for the patient to input various information, and to communicate with others, including hospital administration, family members and caregivers.

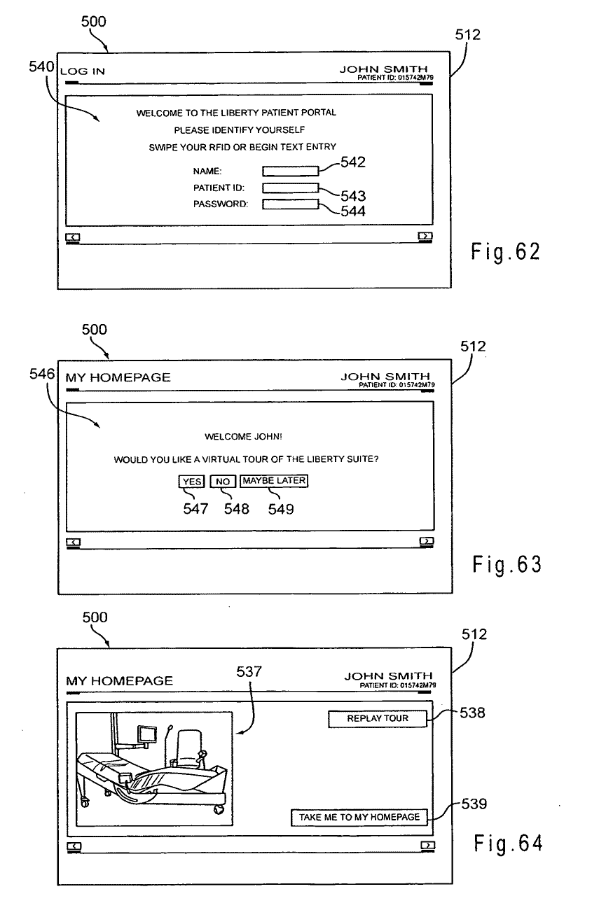

Referring now to FIGS. 61A-61B, an illustrative embodiment of a general computer system 502 that may be used for one or more of the steps described below with respect to FIGS. 62-107 is shown. The computer system 502 can include a set of instructions that can be executed to cause the computer system 502 to perform any one or more of the methods or computer based functions disclosed herein. The computer system 502 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 502 can also be implemented as or incorporated into various devices, such as a personal computer (PC), a tablet PC, a set-top box (STB), a personal digital assistant (PDA), a mobile device, a palmtop computer, a laptop computer, a desktop computer, a network router, switch or bridge, or any other machine capable of executing a set of instructions (sequential or otherwise) that specify actions to be taken by that machine. In a particular embodiment, the computer system 502 can be implemented using electronic devices that provide voice, video or data communication. Further, while a single computer system 502 is illustrated, the term “system” shall also be taken to include any collection of systems or sub-systems that individually or jointly execute a set, or multiple sets, of instructions to perform one or more computer functions.

As illustrated in FIG. 61A, the computer system 502 may include a processor 503, e.g., a central processing unit (CPU), a graphics processing unit (GPU), or both. Moreover, the computer system 502 can include a main memory 504 and a static memory 505 that can communicate with each other via a bus 507. As shown, the computer system 502 may further include a video display unit 512, such as a liquid crystal display (LCD), an organic light emitting diode (OLED), a flat panel display, a solid state display, or a cathode ray tube (CRT). Additionally, the computer system 502 may include an input device 513, such as a touch screen, keyboard, and a cursor control device 514, such as a mouse. The computer system 502 can also include a disk drive unit 515 and a network interface device 506.

In a particular embodiment, as depicted in FIG. 61A, the disk drive unit 515 may include a computer-readable medium 516 in which one or more sets of instructions 517, e.g. software, can be embedded. Further, the instructions 517 may embody one or more of the methods or logic as described herein. In a particular embodiment, the instructions 517 may reside completely, or at least partially, within the main memory 504, the static memory 505, and/or within the processor 503 during execution by the computer system 502. The main memory 504 and the processor 503 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal, so that a device connected to a network 508 can communicate voice, video or data over the network 508. Further, the instructions 524 may be transmitted or received over the network 508 via the network interface device 506.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols commonly used on hospital computer systems, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

In one embodiment, shown in FIG. 61A, a wireless bridge 520 is used to communicate data between various devices of the patient room, generally grouped at block 515, and the operating system of computer system 502, generally grouped at block 529. Wireless bridge 520 may be in communication with network 508 of FIG. 61A. In effect, data is sent over the network between the operating system and the devices in room 10. Data may travel in both directions over network 508 and wireless bridge 520, i.e., from the operating system to the various devices and vice versa. As one example, the operating system may collect and store patient data 530 and patient rules 531, and such stored data may be factored into account when actuating the various devices 515, such as bed 30 and chair 220.

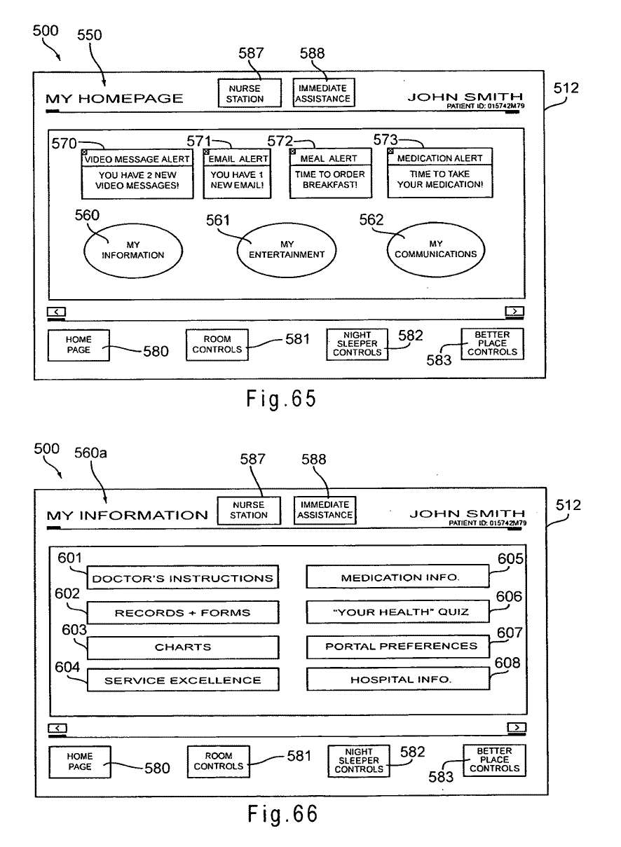

Referring now to FIGS. 62-107, exemplary applications of communication portal 500 are described. In FIG. 62, the graphical user interface 512 of communication portal 500 is configured to display a log in page 540, which prompts a user to enter information to be taken to their homepage 650, as shown in FIG. 65 below. Various types of information may be required in order to log into the system. For example, log in page 540 may request that a user enter a name, patient ID, and/or password into boxes 542-544, respectively, as shown in FIG. 62. Various input devices 513 (see FIG. 61A) may be employed to enable the provision of information, for example, a keyboard in communication with communication portal 500, an interactive keypad displayed on graphical user interface 512, and the like. Alternatively, information required for log in may be obtained by reading the patient's radiofrequency identification (RFID) information, which may be anywhere on the patient's person.

Once the patient has successfully logged in, the operating system may display a welcome screen 546 on graphical user interface 512, as shown in FIG. 63. If desired, welcome screen 546 may ask the user whether he or she would like to take a virtual tour providing instructions for using communication portal 500. The virtual tour also may describe one or more features of the devices in integrated patient room 10, such as features or use of bed assembly 20 and/or chair 220. Since the operating system in communication with communication portal 500 is responsive to commands entered into touch-screen monitor 510 of graphical user interface 512, the user may select yes, no, or maybe later by manually pressing one of buttons 547-549, respectively, as depicted in FIG. 63. If a tour is selected, then one or more animations 537 are played on graphical user interface 512, as depicted in FIG. 64. A user may replay the tour by pressing button 538, or may be taken to their homepage by pressing button 539.

Referring now to FIG. 65, homepage 550 provides a user-specific interface through which multiple types of communications may be initiated. Homepage 550 comprises a plurality of main selections, such as “My Information,” “My Entertainment,” and “My Communication,” each of which comprise an associated button 560-562, respectively. As noted above, the buttons may be actuated when the user touches graphical user interface 512. The functions associated with each button 560-562 are described in further detail below.

Homepage 550 further comprises a plurality of alerts, such as “Video Message Alert,” “Email Alert,” “Meal Alert,” and “Medication Alert,” each of which comprise an associated button 570-573, respectively. Additionally, a plurality of permanent navigation buttons 580-583 preferably are employed, such that even if the user navigates away from homepage 550, buttons 580-583 remain in the same place on each page displayed. Further, a permanently displayed nurse station button 587 and immediate assistance button 588 are provided, as shown in FIG. 65. In one embodiment, feedback is provided the user as soon as any touchscreen command is issued, with the feedback including for example and without limitation audible or visual cues, or combinations thereof.

Homepage 550 is designed for easy navigation and accommodates patients who may be medicated or otherwise somewhat disoriented. For example, immediate assistance button 588 may be colored red, and may always be displayed on each screen, thereby helping a user find the button quickly. Further, as explained below, operating system rules ensure that certain commands are not available for patient access and control, for example, restricted doctor-only diagnosis materials that may be accessed by qualified personnel through communication portal 500. Such operating system rules may be programmed into computer system 502, as explained with respect to FIG. 61A above.

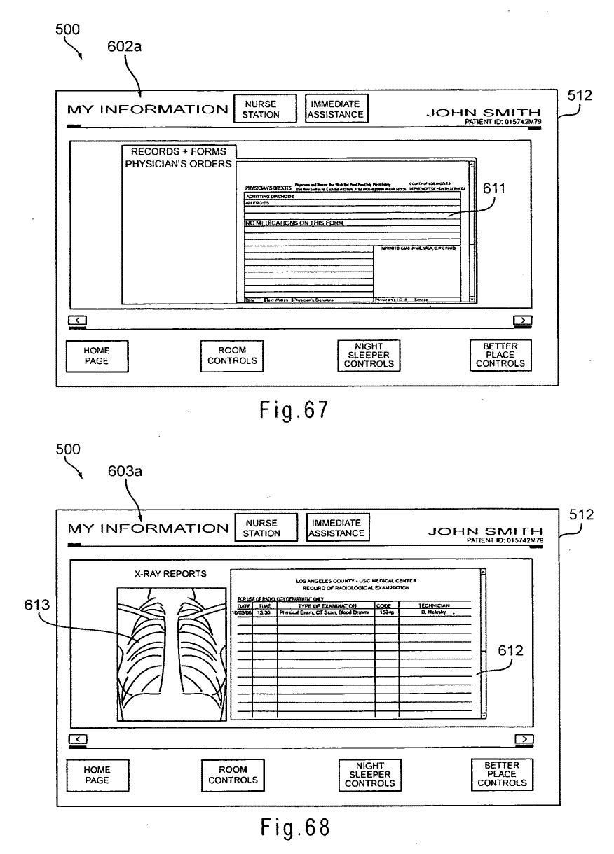

Referring now to FIG. 66, if a user selects “My Information” button 560, the user is directed to page 560a, which displays a series of options associated with patient information. Information options 601-608 may comprise information pertaining to doctor's instructions, records, forms, charts, medication information, portal preferences, hospital information, and other information. Such patient information may be stored in, or accessed by, computer system 502, as explained with respect to FIG. 61A. For example, if a user wishes to access a physician order form, then the user may click the “records and forms” button 602 on page 560a, and be directed to a corresponding information page 602a, as shown in FIG. 67. In this manner, a patient or caregiver may conveniently review a physician's order form 611, without having to find a paper copy or request the information from the physician.

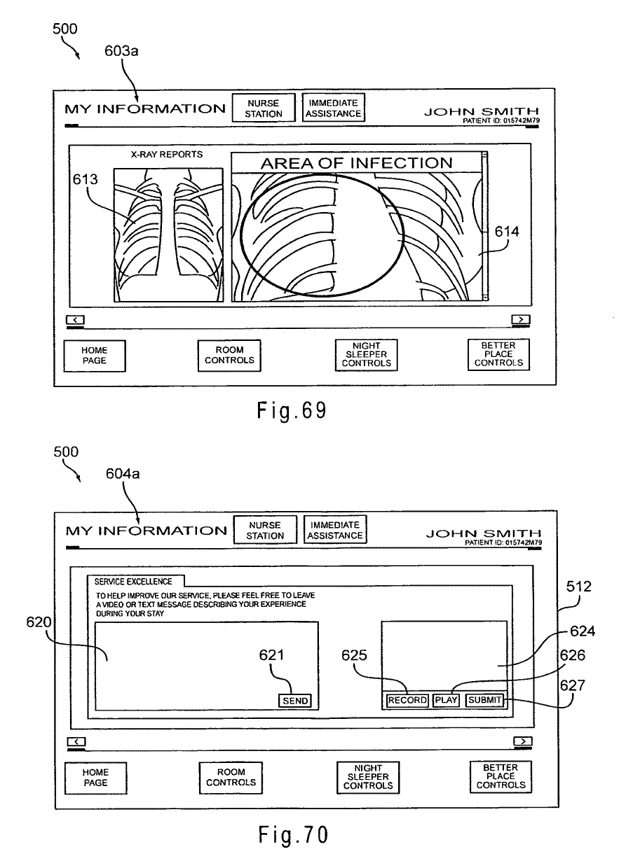

Referring to FIG. 68, the information accessible via the “My Information” button 560 may also comprise X-Rays or charts. Specifically, by actuating the “Charts” button 603 of FIG. 66, corresponding information may be displayed on page 603a. For example, an x-ray 613 and associated information, such as a radiological report 612, may be accessible via communications portal 500 and displayed on graphical user interface 512, as shown in FIGS. 68-69. If desired, a user may obtain an enlarged medical image 614 of the x-ray 613, thereby allowing the patient or caregiver convenient bedside access to their medical information, without having to find a paper copy or request the information from the physician.

Referring to FIG. 70, the information accessible via the “My Information” button 560 may also comprise a hospital or physician survey. Specifically, by actuating the “Service Excellence” button 604 of FIG. 66, a corresponding survey, text box, or other information, such as multiple choice questions, may be displayed on page 604a. For example, a text box 620 may be provided, and a user may enter text using the input device of FIG. 61A. The user then may touch “Send” button 621 in order to submit the information. Additionally, or alternatively, an audio or video message may be sent using interface 624. Interface 624 may comprise a “Record” button 625, which captures audio and/or video feedback from a user. A user may touch “Play” button 626 to review the feedback and subsequently hit “Submit” button 627 to submit the recording. This feature allows a patient or caregiver the opportunity to provide fast, convenient, and optionally anonymous bedside feedback to the hospital, without having to directly discuss the feedback with nurses or doctors.

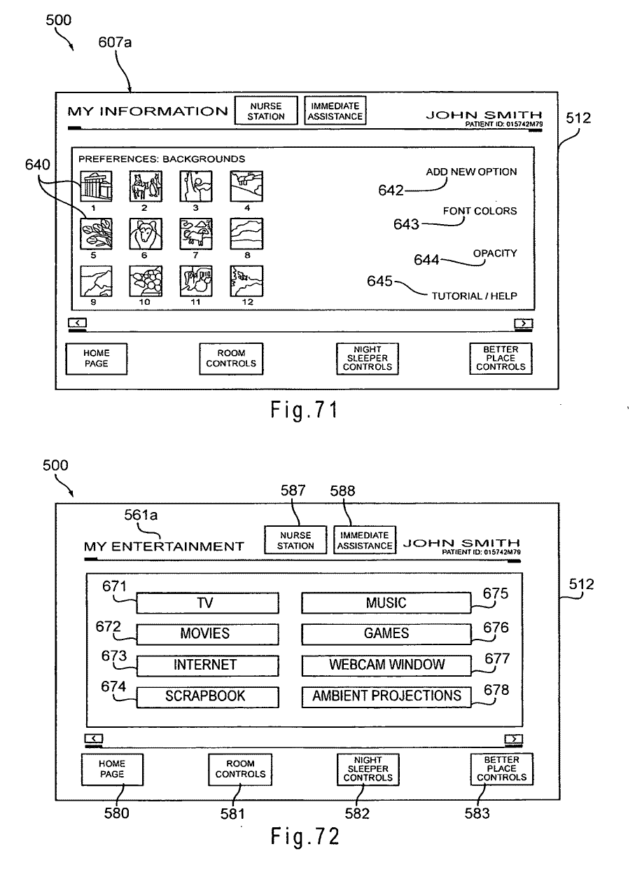

Referring to FIG. 71, the information accessible via the “My Information” button 560 may also comprise setting information associated with communication portal 500. Specifically, by actuating the “Portal Preferences” button 607 of FIG. 66, a corresponding options page may be displayed on page 607a. For example, a user may select from multiple portal backgrounds 640. Such background images may be programmed into computer system 502, or uploaded into the system by a user, as explained with respect to FIG. 61A above. When selected, the desired background is displayed in the background of graphical user interface 512. Further, additional controls 642-645 may be provided, thereby allowing the user to vary other settings associated with communications portal 500 based on individual preferences.

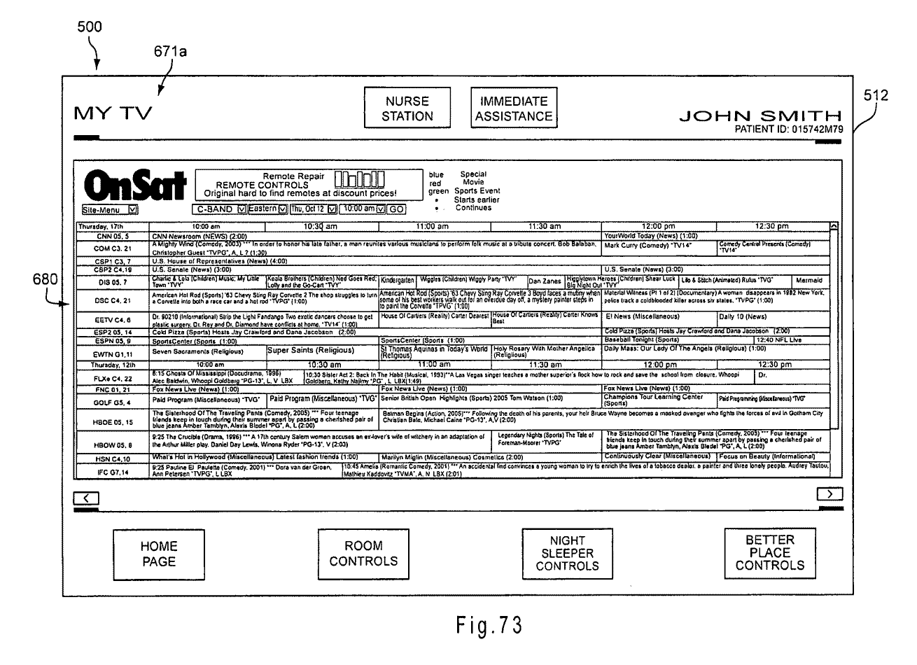

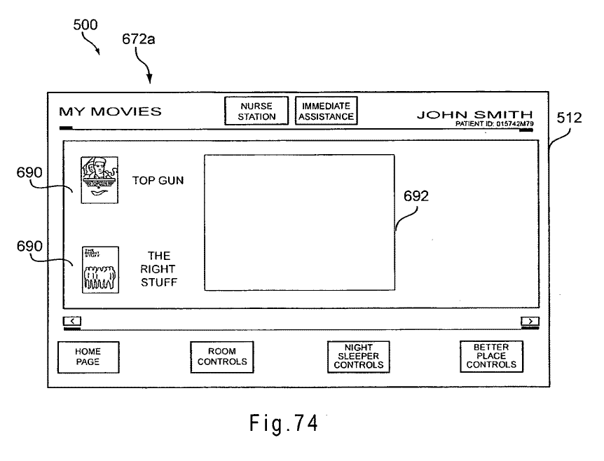

Referring now to FIG. 72, if a user selects “My Entertainment” button 561 on homepage 550, then a user is directed to sub-menu entertainment page 561a, which displays a series of options associated with various entertainment media. Entertainment options 671-678 may comprise forms of entertainment ranging from television, radio, movies, music, games, and so forth. For example, if a user wishes to access television controls, then the user may click the “Television” button 671 on page 561a, and be directed to a corresponding television page 602a, as shown in FIG. 73. Various television information 680 may be displayed, such as programs, channels and times. The information may be access over the network 508 that is coupled to computer system 502, as explained with respect to FIGS. 61A-61B above. In this manner, a patient or caregiver may conveniently access information pertaining to a television employed in patient room 10, without the need to use a separate television remote.

Referring to FIG. 74, the entertainment accessible via the “My Entertainment” button 561 may also comprise media such as movies. Specifically, by actuating the “Movies” button 672 of FIG. 72, corresponding information may be displayed on page 672a. A selection of movies 690 may be digitally stored in a hard drive operatively coupled to computer system 502. The movies may be electronically stored in any suitable format, such as MPEG. A media player 692 may be downloaded onto the hard drive to allow a user to play a movie directly on graphical user interface 512. A user may adjust the communication portal 500 to any desired viewing position, for example, as explained above with respect to FIGS. 10A-10C. Further, as noted above, speakers may be integrated inside vertical elements 42 and 44 of docking station 40, thereby providing audio to a patient resting on bed 30.

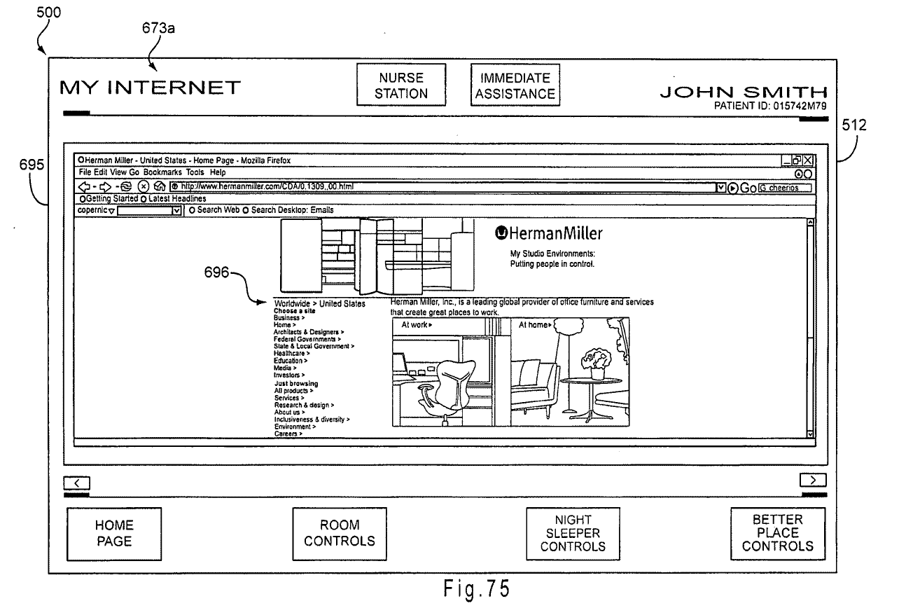

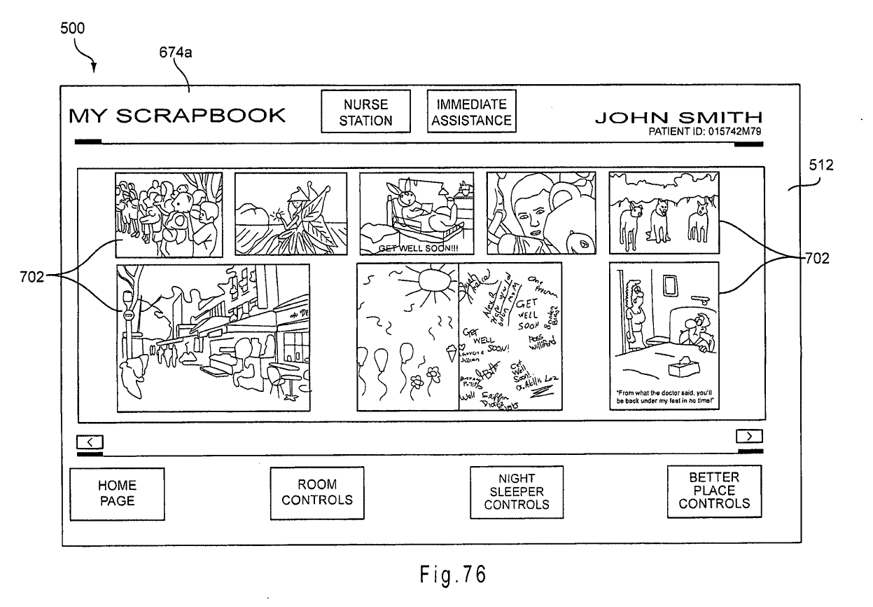

In FIGS. 75-79, the entertainment accessible via the “My Entertainment” button 561 may also comprise entertainment media such as the internet, scrapbooks, music, games and webcams. By actuating the “Internet” button 673 of FIG. 72, an internet page 673a including a web browser 696 having associated controls 695 is displayed on graphical user interface 512, as shown in FIG. 75. A user may touch the screen of monitor 510 in order to actuate web controls, for example, to select links, navigate pages forward and rearward, and so forth. Similarly, by actuating the “Scrapbook” button 674 of FIG. 72, a scrapbook page 674a is displayed on graphical user interface 512, as shown in FIG. 76. Various media 702, such as scanned get-well cards, digital photos, and the like, may be accessible through scrapbook page 674 by clicking on the desired media.

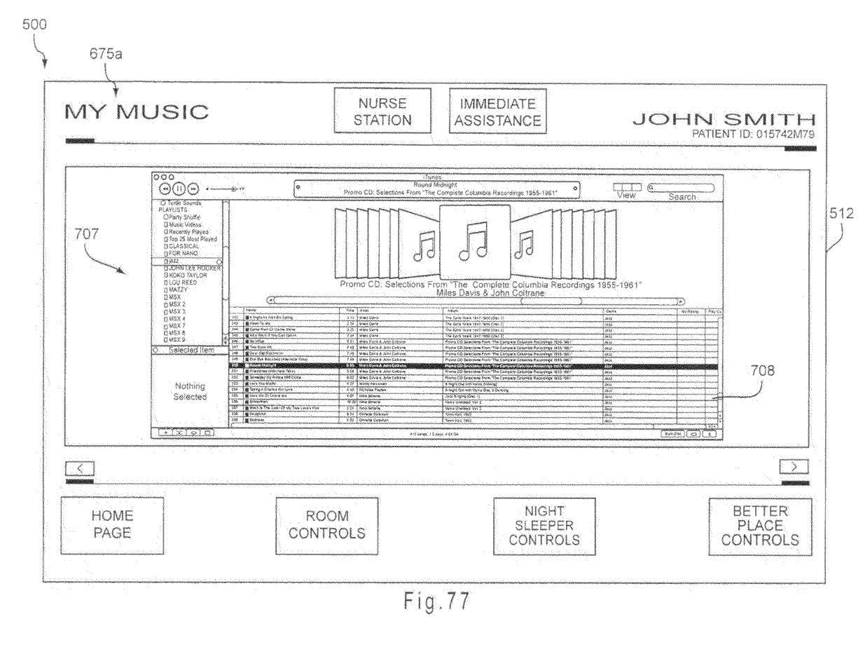

In FIG. 77, by actuating the “Music” button 675 of FIG. 72, a music page 675a is displayed on graphical user interface 512. A variety of music, songs, lectures or other audio clips 708 are digitally stored in the hard drive operatively coupled to communication portal 500. The music may be electronically stored in any suitable format, such as MP3 format. A music media player 707, such as iTunes®, may be downloaded onto the hard drive to allow a user to play a movie directly on graphical user interface 512. Further, as noted above, speakers may be integrated inside vertical elements 42 and 44 of docking station 40, or the headrest or other component of the chair, thereby providing audio to a patient resting on bed 30 or chair 220. In one embodiment, with the speakers embedded in the chair headrest, the sound is audible only to the chair occupant.

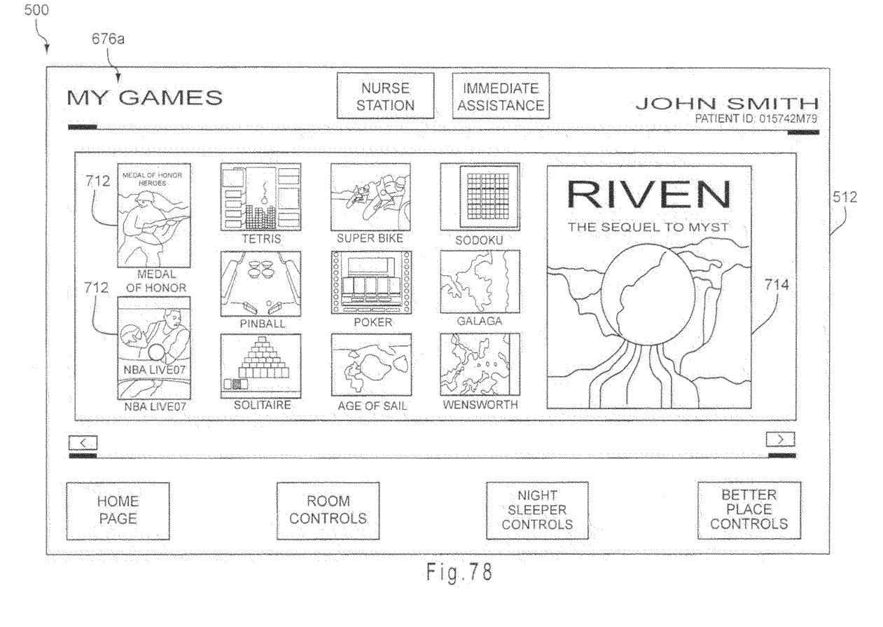

In FIG. 78, by actuating the “Games” button 676 of FIG. 72, a games page 676a is displayed on graphical user interface 512. A variety of games may be digitally stored in a hard drive operatively coupled to communication portal 500. The games may be electronically stored in any suitable format. A media player configured to play the games may be downloaded onto the hard drive to allow a user to play a game directly on graphical user interface 512. Further, as noted above, speakers may be integrated inside vertical elements 42 and 44 of docking station 40 or the headrest of the chair, thereby providing audio to a patient resting on bed 30 or chair 220 and playing the games via the graphical user interface 512. Optionally, one or more game controllers may be operatively coupled to computer system 502, thereby providing tactile feedback to enhance playing of the games.

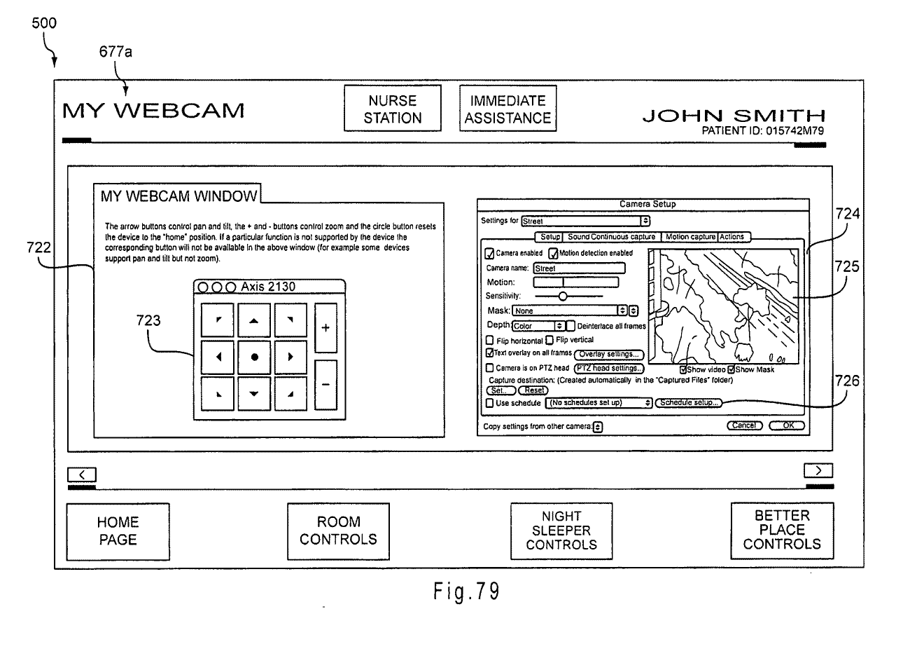

Referring to FIG. 79, by actuating the “Webcam Window” button 677 of FIG. 72, a webcam page 677a is displayed on graphical user interface 512. The webcam page may comprise a first window 722 having a plurality of control buttons 723, while a second window 724 displays a video feed 725 and also may comprise adjustable control settings 726, as shown in FIG. 79. A webcam to view the patient or caregiver in room 10 may be disposed on or adjacent to monitor 510 and coupled to computer system 502, thereby allowing a remote individual to view the occupants of room 10. Further, a microphone associated with the communication portal 500, for example as embedded in the headrest of the chair or bed or docking station, may be used to send voice messages or carry on 2-way telephony or otherwise input information into the communication portal.

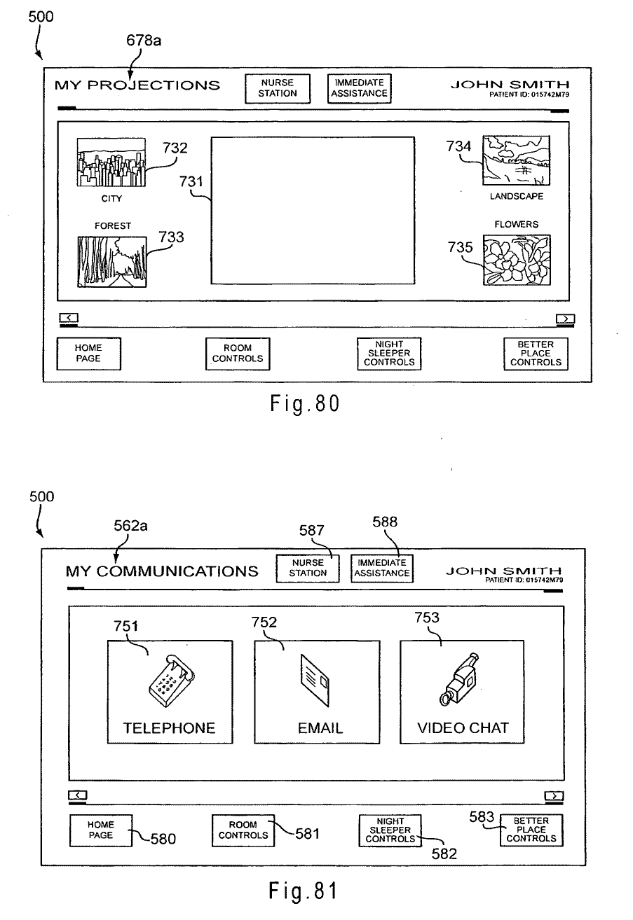

In FIG. 80, by actuating the “Ambient Projections” button 678 of FIG. 72, a projections sub-page 678a is displayed on graphical user interface 512. A variety of images 732-735 may be projected on a wall of the patient room 10. For example, as noted above, a video projection system may be located in an interior space within upper element 43 of docking station 40, and the image may be projected through an aperture 68 in the upper element 43. The video projection system may display the selected image 731 on a wall or other structure opposing docking station 40.

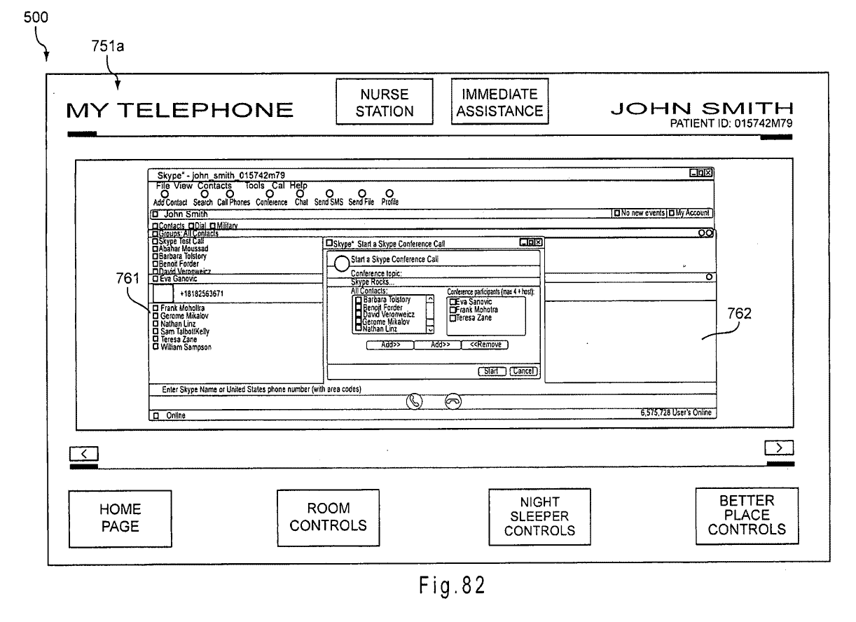

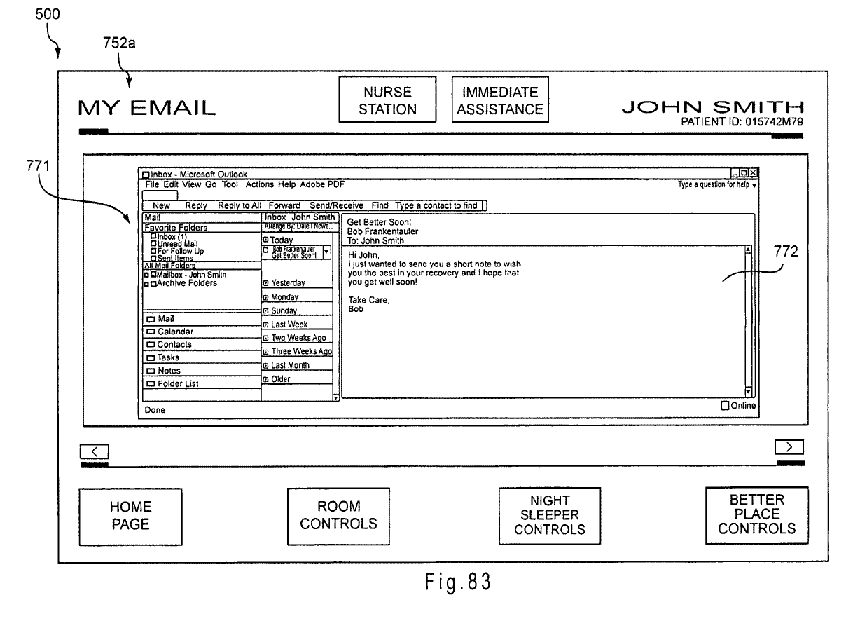

Referring now to FIG. 81, if a user selects “My Communications” button 562 on homepage 550, then a user is directed to sub-menu communication page 562a, which displays a series of options associated with various communication mediums. Communication options 751-753 may include various forms of communication technologies, including without limitation telephone, e-mail and video chat. For example, if a user wishes to access telephone controls, then the user may select the “Telephone” button 751 on page 562a, and be directed to a corresponding telephone page 751a, as shown in FIG. 82. Various telephonic contact information 761 may be displayed. As mentioned above, integrated speakers and microphones will facilitate 2-way communications. Additional features also may be employed, for example, a telephone call or conference call 762 may be placed through graphical user interface 512 using VOIP technology.

In FIG. 83, by actuating the “Email” button 752 of FIG. 81, an email page 752a is displayed on graphical user interface 512. An email program 771, such as Microsoft Outlook®, may be downloaded onto computer system 502 to allow a user to access and send email 772 directly through graphical user interface 512. As noted above, input devices 513, such as a keyboard, digital buttons and keypad may be displayed on graphical user interface 512, or a keyboard or other input device may be coupled to communication portal 500 to facilitate entry of text and the initiation of necessary commands.

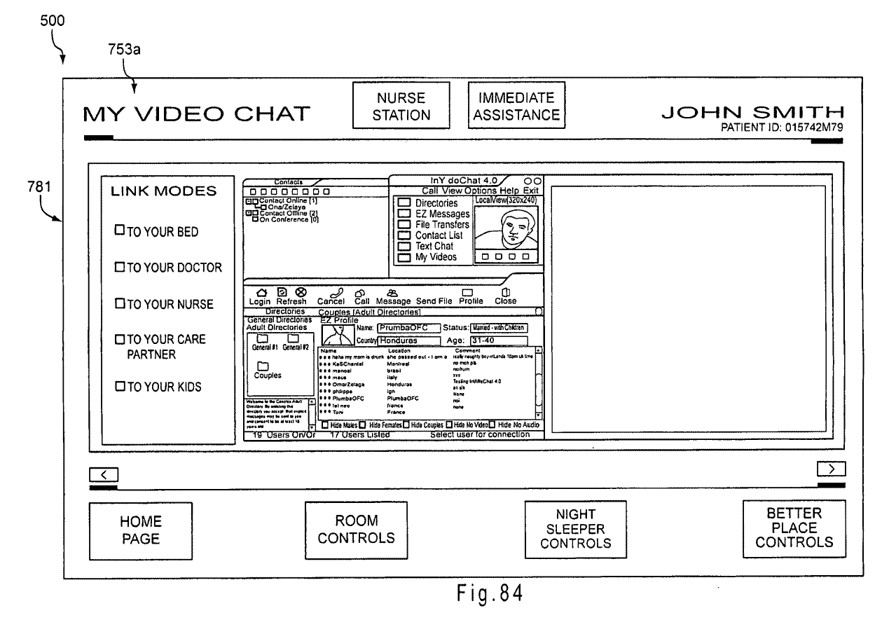

In FIG. 84, by actuating the “Video Chat” button 753 of FIG. 81, a video chat page 753a is displayed on graphical user interface 512. A video chat program 781 may be in communication with computer system 502, thereby providing access to stored or real time video messages sent by friends or other parties. As noted above, speakers may be integrated inside vertical elements 42 and 44 of docking station 40, or at another suitable location, thereby providing audio to a patient resting on bed 30, or into the headrest of the chair or other suitable location, thereby providing audio to a patient supported by/in the chair.

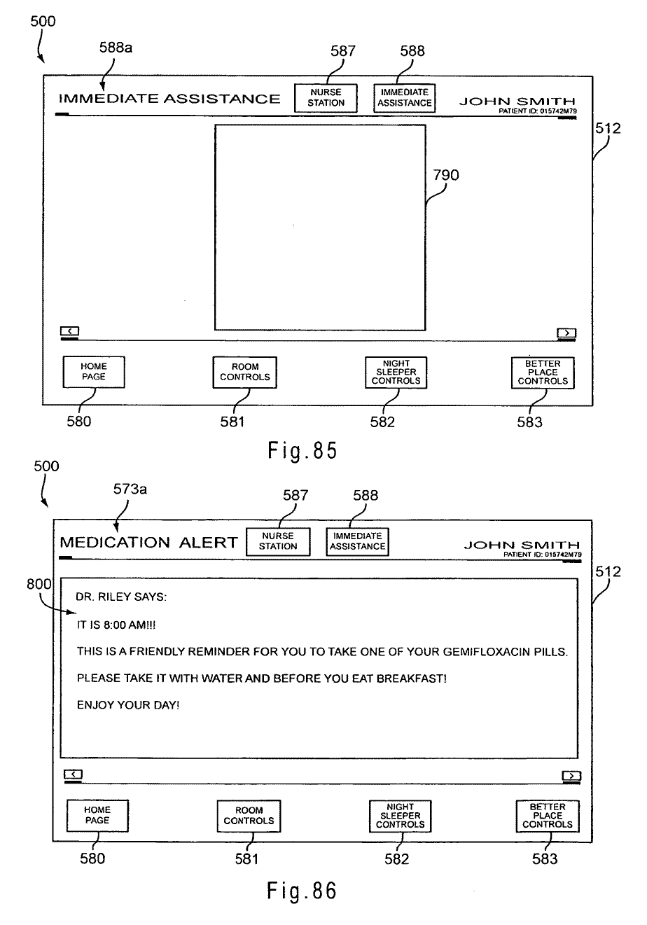

As noted above, an “Immediate Assistance” button 588 is provided on homepage 550, as shown in FIGS. 65 and 85. When actuated by a user, “Immediate Assistance” button 588 may be programmed to automatically contact a nurse or doctor. Alternatively, “Immediate Assistance” button 588 may take a user to assistance page 588a, as shown in FIG. 85. A prompt 790 may be displayed on page 588a, for example, asking the user to confirm if there is an emergency, asking the nature of the emergency, and so forth. Additionally, or alternatively, a video or audio feed may be provided to a nurse or doctor upon actuation of button 588.

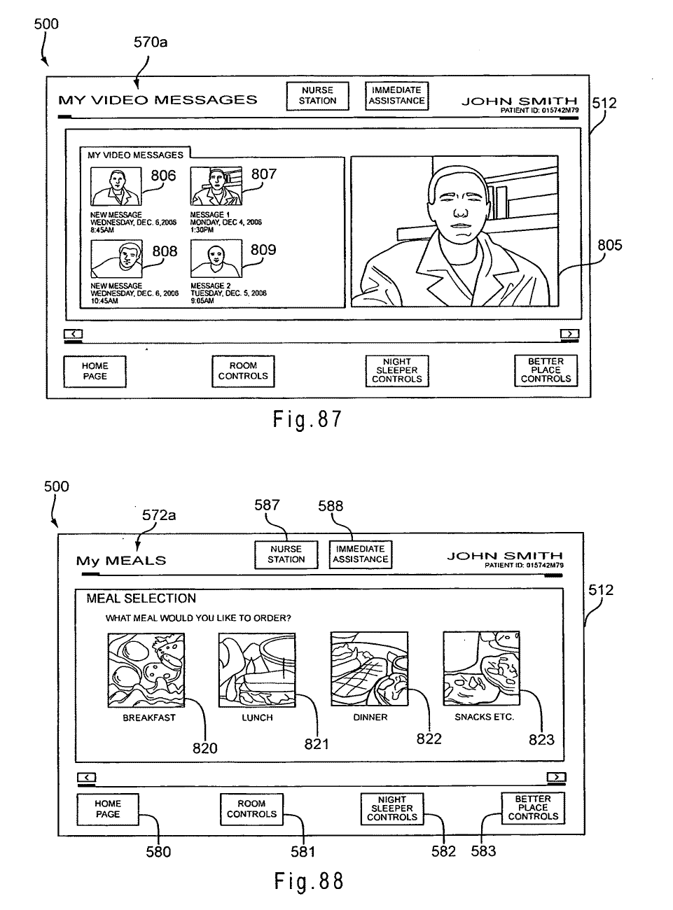

Referring now to FIGS. 86-87, communication portal 500 is also configured to receive various patient alerts, which may be displayed on graphical user interface 512. For example, in FIG. 86, medication alert 800 is displayed at a predetermined time on medication alert page 573a of graphical user interface 512. An alert icon 573 may be displayed on homepage 550, as shown in FIG. 65, and when actuated directs the user to medication alert page 573a. Medication alert 800 may include textual and/or audio playback reminding a patient to take a certain medication, providing instructions for taking the medication, the proper dosage, and so forth.

In another example, shown in FIG. 87, video message alert 805 is displayed at a predetermined time on video alert page 570a of graphical user interface 512. An alert icon 570 may be displayed on homepage 550, as shown in FIG. 65, and when actuated directs the user to video alert page 570a. Alternatively, when the video alert arrives, a user may automatically be directed to video alert page 570a. Video alert message alert 805 may include video of a doctor, an automated message, or other graphical representation may be displayed on graphical user interface 512. Multiple video message alerts 806-809 may be archived so that a patient may subsequently access a particular alert.

Several other alerts also may be displayed on graphical user interface 512. For example, referring back to homepage 550 of FIG. 65, an email alert 571 may be displayed when an email arrives. Upon clicking button 571, a user is directed to email page 752a of FIG. 83 above. Further, a meal alert 572 may be displayed when it is time for the patient to order a meal or eat an existing meal. Upon clicking button 572, a user is directed to a meal selection page, as explained in FIGS. 88-95 below.

Referring now to FIGS. 88-95, features of a meal selection page 572a are described. As noted above, a meal alert 572 may be displayed on homepage 550 at a predetermined time, and when actuated, directs the user to meal selection page 572a. Alternatively, when the meal alert arrives, a user may automatically be directed to meal selection page 572a. Actuation buttons 820-823 may be displayed for breakfast, lunch, dinner and snacks, respectively. Alternatively, if it is within a time frame for a certain meal, e.g., around noon for lunchtime, then only lunch button 821 may be visible to the user.

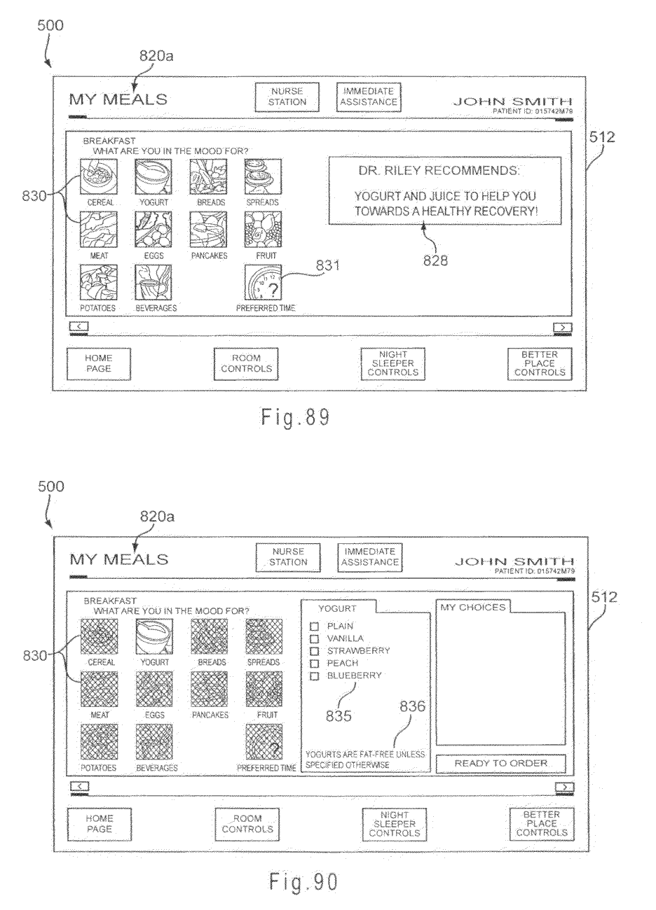

In FIG. 89, a user has selected breakfast option 820 and has been directed to breakfast order page 820a. A doctor recommendation message 828 may appear on the screen, wherein the recommendation may be preprogrammed based on specific individual requirements of a particular patient. Such specific, food-related patient information and rules may be programmed into computer system 502, as explained with respect to FIG. 61A above. Various acceptable breakfast icons 830 are displayed, as well as a preferred time icon 831. Breakfast icons 830 preferably are limited to meal options suitable for a specific patient. For example, if a patient cannot eat meat, then the meat icon would not be displayed on breakfast order page 820a.

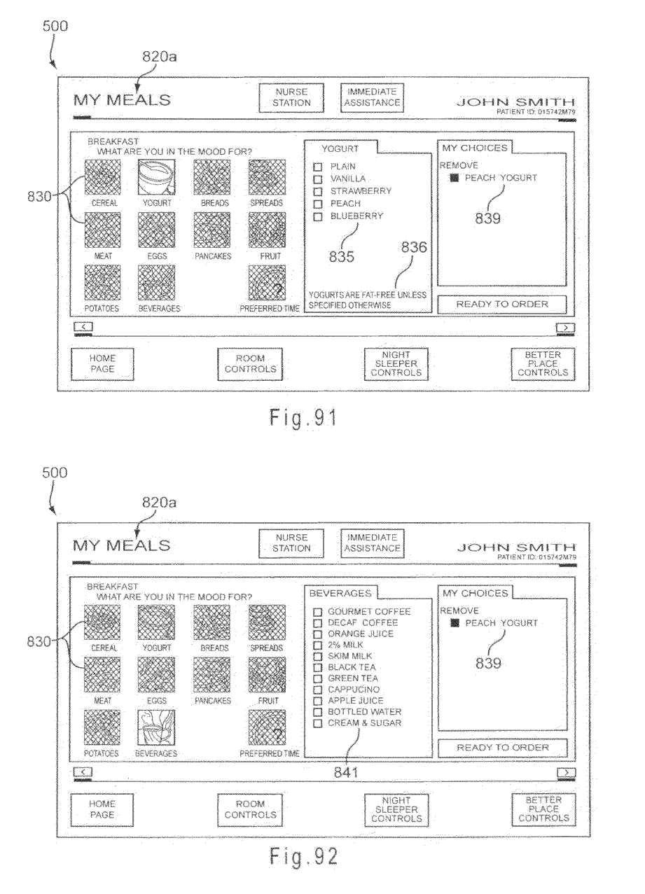

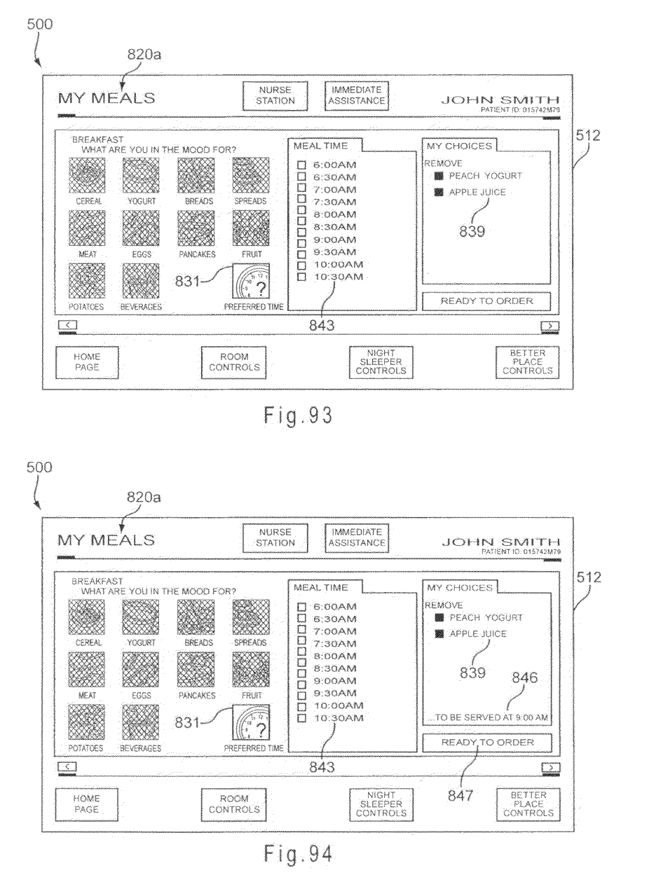

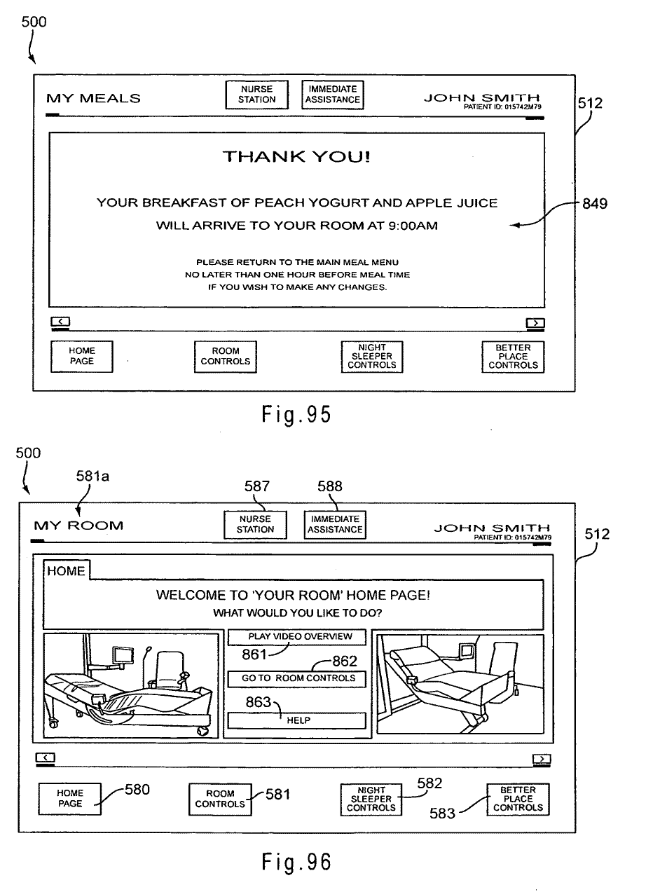

In FIG. 90, a user has selected the yogurt option on breakfast order page 820a. A yogurt sub-menu 835 then is displayed on graphical user interface 512, providing various options, such as flavors. Other information, such as nutritional information 836, may be displayed on graphical user interface 512. Upon selecting a desired option from sub-menu 835, the item is added to the selected items listing 839 displayed under the “My Choices” section of the page, as shown in FIG. 91. It is possible to remove an item, or add additional items, at any time before submitting an order. In FIG. 92, the user subsequently clicks the beverages icon and beverage sub-menu 841 then is displayed on graphical user interface 512, providing various options, such as drink types, flavors, and so forth. Upon selecting a desired drink option from sub-menu 841, the item is added to the selected items listing 839 displayed under the “My Choices” section of the page, as shown in FIG. 93. A user then may click on preferred time icon 931 to view time sub-menu 843. After selecting the desired time 846, which is displayed under the “My Choices” section of the page, as shown in FIG. 94, a user may click “Ready to Order” button 847 to submit an order. A confirmation message 849 then is displayed on graphical user interface 512 to confirm the contents of the order and the time of delivery, as shown in FIG. 95. Other information may be displayed in confirmation message 849, for example, informing the user of delays or deviations in the preferred or selected delivery time.

Referring now to FIGS. 96-100, various room control features that may be actuated through communication portal 500 are described. If a user selects the “Room Controls” button 581 on any page displayed on graphical user interface 500, the user may be directed to lighting control page 862a. Additional room control icons, such as temperature icon 875 and window blinds icon 876, may be displayed on lighting control page 862a, as shown in FIG. 97. Lighting control page 862a comprises multiple buttons 871-874 that may adjust the lighting in patient room 10 for a predetermined circumstance, such as examination, sleep, or the projection of movies. In addition to preset lighting based on circumstances, the light level also may be incrementally adjusted through communication portal 500.

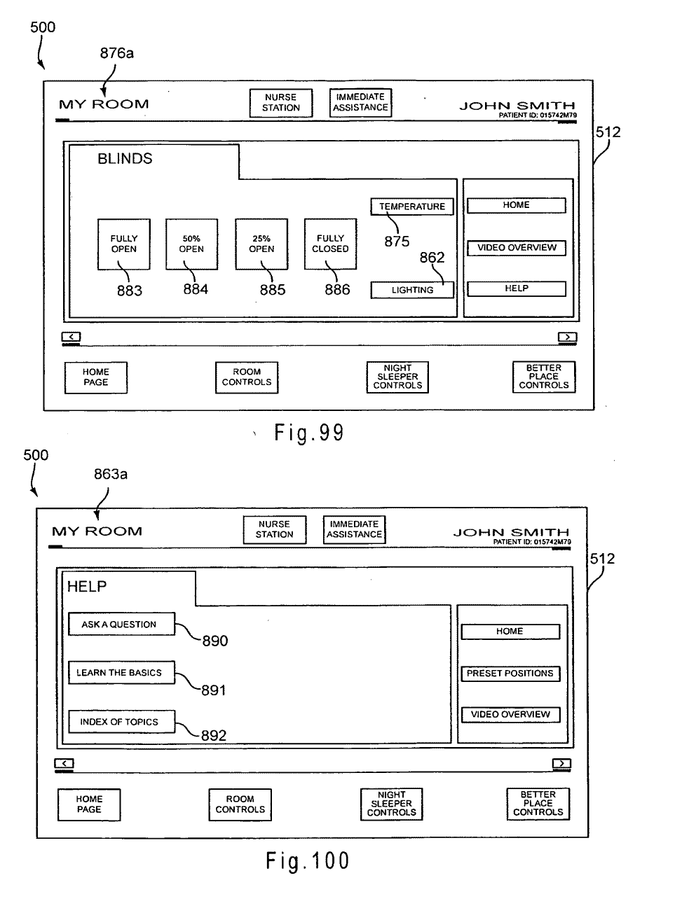

In FIG. 98, a user selecting temperature icon 875 is directed to temperature control page 875a. The temperature 879 may be displayed digitally on graphical user interface 512. Further, various adjustable icons, such as minus and plus signs 880 and 881, respectively, may be provided to enable incremental temperature adjustments. Similarly, in FIG. 99, a user selecting blinds icon 876 is directed to window blinds control page 876a. Window blinds control page 876a comprises multiple buttons 883-886 which may automatically adjust the position of the window blinds in patient room 10 a predetermined amount between fully open and closed positions. Finally, if a user selects help icon 863 on room control page 581a, the user is directed to help page 876a, which may comprise multiple buttons 890-892 that allow the user to ask questions or learn about topics or basic features associated with patient room 10.

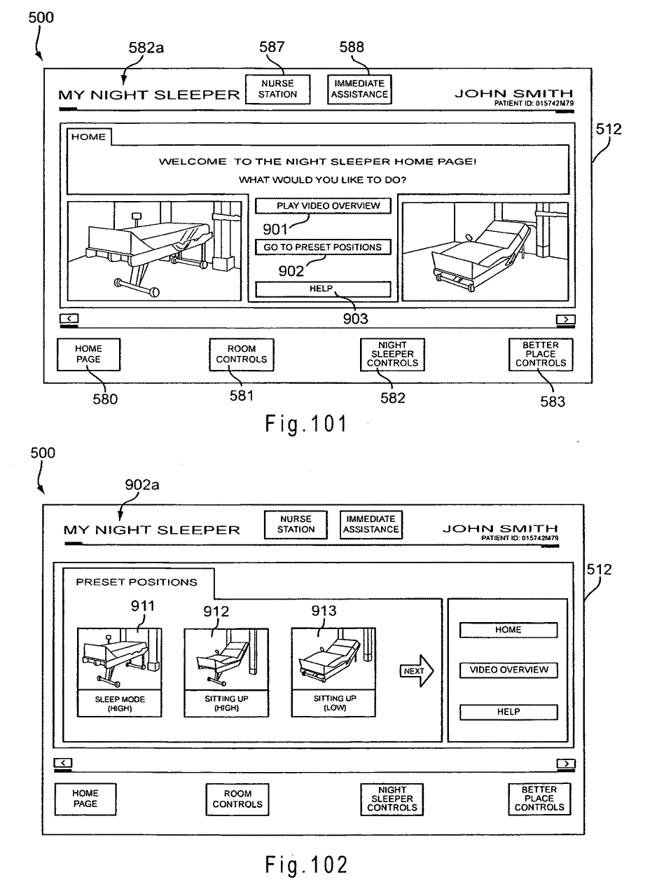

Referring now to FIGS. 101-104, various bed control features that may be actuated through communication portal 500 are described. If a user selects the “Night Sleeper Controls” button 582 on any page displayed on graphical user interface 512, the user may be directed to bed control page 582a. As shown in FIG. 101, bed control page 582a lists icons 901-903, which allow a user to play a video overview, review or change preset positions, and be directed to help, respectively. If a user selects “Go to Preset Positions” button 902 on page 582a, the user is directed to preset positions page 902a. As shown in FIGS. 102-104, preset positions page 902a shows multiple preset positions 911-917 that bed 30 may obtain. Preset positions 911-917 are identified using a digital photo, image, or other static or dynamic graphic, and/or a textual description of the position. For example, if a user wishes to transform the bed into a stow mode, the user may press button 916, as shown in FIG. 103. By actuating button 916, signals are relayed between the central operating system and one or more actuators coupled to bed 30 and/or docking station 40, as explained in FIGS. 61A-61B above, to stow bed 30 within docking station 40. For example, instructions may be provided to the cross-bar 50 to be raised vertically within docking station 40, thereby facilitating stowage of bed 30.

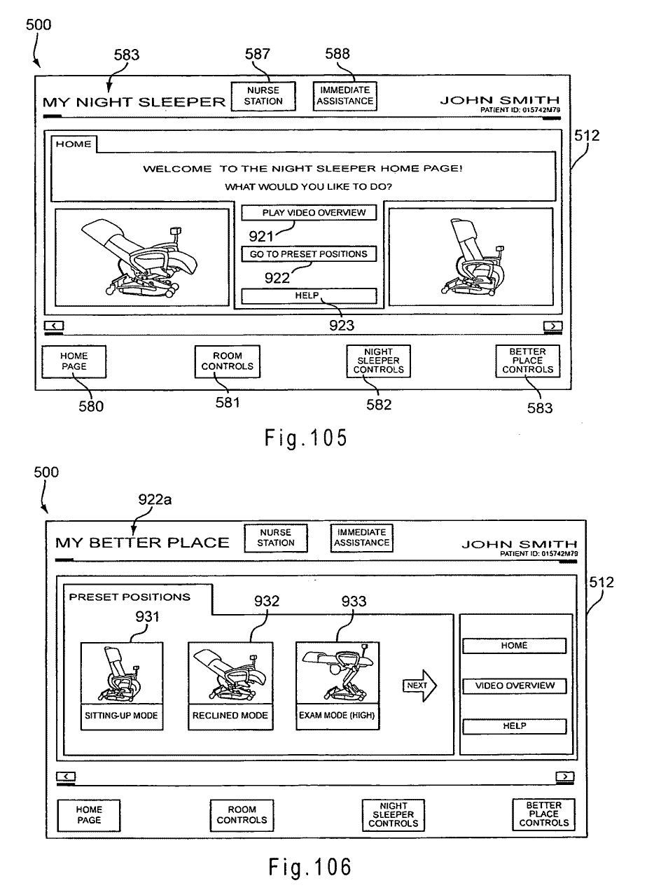

Referring now to FIGS. 105-107, various chair control features that may be actuated through communication portal 500 are described. If a user clicks the “Better Place Controls” button 583 on any page displayed on graphical user interface 500, the user may be directed to chair control page 583a. As shown in FIG. 105, chair control page 583a lists icons 921-923, which allow a user to play a video overview, review or change preset positions, and be directed to help, respectively. If a user selects “Go to Preset Positions” button 922 on page 583a, the user is directed to preset positions page 922a. As shown in FIGS. 106-107, preset positions page 922a shows multiple preset positions 931-936 that chair 220 may obtain. Preset positions 931-936 are identified both using a digital photo, image, or other static or dynamic graphic, and/or a textual description of the position. For example, if a user wishes to transform chair 220 into a reclined mode, the user may press button 932, as shown in FIG. 106. By actuating button 932, signals are relayed between the central operating system and one or more actuators coupled to chair 220, as explained in FIGS. 61A-61B above, to effect actuation of chair 220.

As explained above, a user also may incrementally adjust the preset positioning of bed 30 and/or chair 220 based on individual specific requirements. For example, the user first may select the “Exam Mode (High)” button 933 of FIG. 106 to place chair 220 into a supine position. A user subsequently may incrementally vary the height of chair 220 with respect to the floor of patient room 10, e.g., based on a patient's individual characteristics. The newly adjusted position then may be saved for later use, such that subsequently pressing button 933 will place chair 220 in the newly-desired height with respect to the floor.

Finally, as noted above, in accordance with one aspect, patient room 10 provides a system for transferring a patient, and communication portal 500 may be used as an interface to electronically facilitate synchronization between multiple components in patient room 10. For example, if it becomes desirable to laterally transfer a patient between bed 30 and chair 220, a user may place bed 30 in “Lateral Transfer Mode” by pressing button 917 using communication portal 500, as shown in FIG. 104. The user subsequently may place chair 220 in “Lateral Transfer Mode” by pressing button 936 using communication portal 500, as shown in FIG. 107. At this time, bed 30 and chair 220 are synchronized, e.g., at the same height, to facilitate patient transfer. Alternatively, chair 220 may automatically become transferred into the proper synchronization configuration simply by pressing “Lateral Transfer Mode” button 917 to actuate bed 30. Additional icons or buttons may be provided on graphical user interface to simplify the transfer of a patient. For example, an icon called or dynamically illustrating “Laterally Transfer Patient Between Bed and Chair” may be provided, such that upon one click of the button or other user interface selection, bed 30 and chair 220 are automatically, electronically synchronized with one another. In this case, actuating the icon “Laterally Transfer Patient Between Bed and Chair” sends instructions to the programmable operating system to move the actuators associated with bed 30 and chair 220 into the proper position to facilitate transfer of the patient.

The portal can also be used to provide patient and family education about a particular ailment or injury process, or various treatments therefore. In addition, the portal can provide two-way communication about and facilitating discharge planning, implementation and follow-up, including family caregiver training. The portal also can be used to complete a detailed intake interview, for example to supplement the initial intake process, thereby allowing more time to recall and communicate about various symptoms, allergies, etc.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

1-84. (canceled)

85. A chair having at least one adjustable feature, the chair comprising:
a support surface adapted to receive a user, wherein the support surface is adjustable between a plurality of configurations including supine, sitting and erect egress positions, and
wherein the chair is further adjustable in at least each of the supine and sitting positions based on information associated with an individual using the chair.

86. The chair of claim 85 wherein the chair obtains the information associated with the individual using a radio frequency identification tag.

87. The chair of claim 85 wherein the support surface further comprises multiple layers, wherein the multiple layers are movable with respect to one another.

88. The chair of claim 85 wherein the chair is adapted to be automatically synchronized with at least one other piece of furniture in the room.

89. The chair of claim 85 further comprising a monitor having a graphical user interface coupled to the chair.

90. The chair of claim 89 wherein the graphical user interface enables preprogrammed positioning of the chair in positions including reclined seated, supine, upright seated and erect egress positions.

91. The chair of claim 85 wherein positioning of the chair may be preprogrammed based on individual specific requirements.

92. The chair of claim 91 wherein the positioning of the chair may be preprogrammed based on information pertaining to both a patient and a caregiver.

93. The chair of claim 85 further comprising a cervical support and headrest disposed about an upper surface of the chair, wherein the cervical support and headrest are adapted for vertical adjustability with respect to the upper surface of the chair.

94. The chair of claim 85 wherein the chair further comprises at least one adjustable armrest having at least first and second positions, wherein in the first position, the armrest is disposed above an upper surface of the chair to prohibit lateral movement of the patient over a side of the chair, and in the second position, the armrest is disposed below the upper surface of the chair to allow transfer of the patient off the chair.

95. (canceled)

96. A method for adjusting the position of a chair, the method comprising:
providing a chair having a support member having a support surface adapted to receive a user in a plurality of first configurations including supine, sitting and erect egress positions;
moving the chair to one of the plurality of first configurations;
programming specific information associated with an individual using the chair into an operating system coupled to the chair; and
adjusting the chair to a second configuration based on the specific information associated with the individual.

97. The method of claim 96 further comprising obtaining the specific information associated with the individual using a radio frequency identification tag.

98. (canceled)

99. The method of claim 96 further comprising synchronizing the chair with at least one other piece of furniture in the room using the operating system.

100. The method of claim 96 further comprising:
providing a monitor having a graphical user interface coupled to the chair; and
adjusting the positioning of the chair to a programmed position using the graphical user interface.

101-129. (canceled)

130. A system for positioning and transferring a patient, the system comprising:
a chair having a first support surface adapted to receive a user, wherein the chair is adjustable between a first plurality of configurations and is configured to be pre-programmed into at least one of the first plurality of configurations;
a support structure having a second support surface adapted to receive a user, wherein the support structure is adjustable between a second plurality of configurations and is configured to be pre-programmed into at least one of the second plurality of configurations; and
a programmable operating system configured to synchronize at least one of the first plurality of configurations of the chair with at least one of the second plurality of configurations of the support structure and thereby selectively align the first and second support surfaces to facilitate transfer of a patient between the chair and the support structure.

131. The system of claim 130 wherein the first plurality of configurations comprises a supine position.

132. The system of claim 130 wherein the support structure comprises a bed.

133. The system of claim 130 wherein the first plurality of configurations includes supine, seated and erect egress positions, and wherein the chair is further adjustable in each of at least the supine and seated positions based on information associated with an individual using the chair.

134. The system of claim 133 wherein the chair obtains the information associated with the individual using a radio frequency identification tag.

135. The system of claim 130 wherein the chair further comprises a monitor having a graphical user interface coupled to the chair, wherein the graphical user interface enables preprogrammed positioning of the chair.

136. The system of claim 130 wherein the chair further comprises at least one adjustable armrest having at least first and second positions, wherein in the first position the armrest is disposed above an upper surface of the chair to prohibit lateral movement of the patient over a side of the chair and in the second position the armrest is disposed below the upper surface of the chair to allow transfer of the patient off the chair.

137. A method for transferring a patient, the method comprising:
providing a chair having a first support surface adapted to receive a user, wherein the chair is adjustable between a first plurality of configurations and is configured to be programmed into at least one of the first plurality of configurations;
providing a support structure having a second support surface adapted to receive a user, wherein the support structure is adjustable between a second plurality of configurations and is configured to be programmed into at least one of the plurality of second configurations;
automatically synchronizing at least one of the first configurations of the chair with at least one of the second configurations of the support structure to selectively align the first support surface of the chair with the second support surface of the support structure; and
transferring a patient between the chair and the second support structure.

138. The method of claim 137 wherein the support structure comprises a bed, the method further comprising adjusting the bed between the second plurality of configurations.

139. The method of claim 137 further comprising adjusting the chair between the first plurality of configurations including supine, seated and erect egress positions.

140. The method of claim 139 further comprising obtaining information associated with an individual and adjusting the chair based on the information.

141. The method of claim 137 further comprising:
providing a monitor having a graphical user interface coupled to the chair; and
using the graphical user interface to program the positioning of the chair in the plurality of first configurations including reclined seated, supine, upright seated and erect egress positions.

142. The method of claim 137 further comprising:
providing at least one adjustable armrest having at least first and second positions;
positioning the armrest in a first position, wherein the armrest is disposed above an upper surface of the chair to prohibit lateral movement of the patient over a side of the chair; and
positioning the armrest in a second position, wherein the armrest is disposed below the upper surface of the chair to allow lateral transfer of the patient off the chair.
